(19) United States
(12) Patent Application Publication
(10) Pub. No.: US 2003/0204421 A1
(43) Pub. Date: Oct. 30, 2003

(54) Integrated system and method for insurance products

(75) Inventors: Patrick J. Houle, Sudbury, MA (US); E. Paul Tinsley, Worcester, MA (US); Daniel Griffin, Harrisville, RI (US); Shawn Salm, Worcester, MA (US)

Correspondence Address: BOWDITCH & DEWEY, LLP, 161 WORCESTER ROAD, P.O. BOX 9320, FRAMINGHAM, MA, 01701-9320, US

(73) Assignee: Value Benefits Insurance Agency, Inc., Worcester, MA (US)

(21) Appl. No.: 10/135,191

(22) Filed: Apr. 29, 2002

(51) Int. Cl. G06F 17/00; G06F 17/60

(52) U.S. Cl. 705/4; 707/104.1

(57) ABSTRACT

The system and method of the present invention includes an integrated insurance system for automating information processing and computerizes different combinations of the quoting, enrollment, billing, monitoring and maintenance functions of the process.

In a preferred embodiment, a system for creating and administering insurance contracts, includes a front-end subsystem in communication with a client, a database subsystem accessing a plurality of stored databases, and a back-end subsystem in communication with a plurality of subsystems to source information and monitor the creation, and administration of an insurance contract. The front-end subsystem communicates via a network such as, for example, the Internet, and is further operative with a set of executable instructions to collect contract information, from and deliver contract information to a plurality of clients. The front-end subsystem includes at least one of a set of executable instructions for quoting a plurality of terms of the contract, an enrollment process, a billing process and contract maintenance. The back-end subsystem communicates with a network and accesses the databases. The back-end subsystem includes a system application having a quoting subsystem, an enrollment subsystem, a billing subsystem, and a resource management subsystem, and communicates with the front-end subsystem which in turn communicates with the client and an insurance carrier or vendor to communicate the creation, execution and management of the insurance contract to the client. In preferred embodiments, the back-end subsystem further comprises an underwriting and eligibility subsystem, a reporting subsystem, an archiving subsystem, and an electronic data interchange subsystem. The front-end subsystem communicates with an insurance vendor.

### BACKGROUND OF THE INVENTION

The typical insurance system includes a quotation phase for insurance coverage, followed by preparing and writing insurance contracts requested by clients. Insurance quotation, and creation of contracts has traditionally been paper based.

The insurance process is further burdened with an underwriting function also conducted by manually reviewing and evaluating voluminous and redundant client information and application forms. Forms for insurance products are normally supplied by individual insurance providers or agents and must be revised periodically in response to changes in the client's information or legislative enactments in the state in which the insured risk resides. Typically each insurance transaction, application or request for information requires a separate document to be filled out by the client or agent. Due to the general nature of creating, and maintaining redundant information in the forms a tremendous volume of paper needs to be managed. The paper based systems and processes for insurance contracts are inefficient and time consuming for all involved, the client, the insurance agent, the provider and the insurance agent.

The manual review and voluminous evaluations are being replaced by computerized systems that address different phases of the insurance process. In particular computerized systems exist for some portions of the quotation request phase and some portions of the enrollment phase of the insurance process.

However, there still remains a need to improve the systems and methods for providing insurance products.

### SUMMARY OF THE INVENTION

The system and method of the present invention includes an integrated insurance system for automating information processing and computerizes the quoting, enrollment, billing, monitoring and maintenance functions of the process.

In a preferred embodiment, the system of the present invention includes a quoting subsystem, an enrollment subsystem and customer resource management subsystem. The quoting subsystem provides product choices, confirms demographic information, customizes a quote, accounts for employer contribution and provides a quote or a plurality of quotes. In a particular embodiment, an underwriting and eligibility subsystem is in communication with the quoting subsystem. The enrollment subsystem includes for selected product choices selecting available plans, accounting for employer contribution, confirming information using underwriting and eligibility subsystems and submitting information to a vendor subsystem. The contact resource management subsystem includes monitoring and tracking sales activity, customer service activity and finance activity.

In another preferred embodiment, the system of the present invention includes automating the enrollment, billing and customer resource management subsystems. The billing subsystem includes at least one of a client billing subsystem, a vendor billing subsystem and a sales commission subsystem.

In another preferred embodiment the system of the present invention includes an enrollment subsystem that is in communication with multiple databases having a data structure that includes multiple tables having a record structure that includes fields. The fields have data or keys that point to data stored in other record structures. These keys provide links to common data used by a quoting, the enrollment, a billing and a monitoring subsystem.

In a preferred embodiment, a system for creating and administering insurance contracts, includes a front-end subsystem in communication with a client, a database subsystem accessing a plurality of stored databases, and a back-end subsystem in communication with a plurality of subsystems to source information and monitor the creation, and administration of an insurance contract. The front-end subsystem communicates via a network such as, for example, the Internet, and is further operative with a set of executable instructions to collect contract information, from and deliver contract information to a plurality of clients. The front-end subsystem includes at least one of a set of executable instructions for quoting a plurality of terms of the contract, an enrollment process, a billing process and contract maintenance. The back-end subsystem communicates with a network and accesses the databases. The back-end subsystem includes a system application having a quoting subsystem, an enrollment subsystem, a billing subsystem, and a resource management subsystem, and communicates with the front-end subsystem which in turn communicates with the client and an insurance carrier or vendor to communicate the creation, execution and management of the insurance contract to the client. In preferred embodiments, the back-end subsystem further comprises an underwriting and eligibility subsystem, a reporting subsystem, an archiving subsystem, and an electronic data interchange (EDI) subsystem. The front-end subsystem communicates with an insurance vendor.

In accordance with another aspect of the present invention, in a data processing system, a method of implementing insurance contracts between a client and an insurance provider includes receiving a plurality of inputs for a quoting subsystem from the client, processing the plurality of inputs and generating a quote in response to the plurality of inputs, transmitting the quote to the client, executing the insurance contract and enrolling the client upon receiving an approval with respect to the quote, generating invoices that correspond to the contract using a billing subsystem, monitoring and managing the quoting subsystem process, a customer service process and the billing subsystem.

The method further includes creating and storing in a database a plurality of contract templates or forms having terms and conditions of the contract. The method further includes reviewing eligibility and underwriting requirements upon receiving the plurality of inputs from the client.

In accordance with another aspect of the present invention, a computer program product for implementing an insurance contract between a client and a provider, includes a computer usable medium having a computer readable code, including program code which receives a plurality of inputs from the client, processes the plurality of inputs, generates a quote, and executes the insurance contract by enrolling the client, monitors and manages the plurality of client inputs and generates corresponding invoices.

In accordance with a preferred embodiment the apparatus for implementing the insurance contract between a client and an insurance provider or carrier includes a data processor having multiple tables. Each table in the database has a record structure that includes fields having data or keys that point to data stored in tables. These keys provide links to common data used by the quoting, enrolling, billing and monitoring subsystems.

The foregoing and other features and advantages of the system and method for insurance products will be apparent from the following more particular description of preferred embodiments of the system and method as illustrated in the accompanying drawings in which like reference characters refer to the same parts throughout the different views. The drawings are not necessarily to scale, emphasis instead being place upon illustrating the principles of the invention.

### BRIEF DESCRIPTION OF THE DRAWINGS

FIG. 1 is a schematic block diagram of the integrated insurance system in accordance with a preferred embodiment of the present invention;

FIGS. 2A and 2B are schematic flowcharts illustrating the customer resource/relationship management (CRM) process flow in accordance with a preferred embodiment of the present invention;

FIG. 3 illustrates a schematic flowchart detailing the CRM process for the sales process in accordance with a preferred embodiment of the present invention;

FIG. 4 illustrates a flowchart detailing the CRM process for the customer service process in accordance with a preferred embodiment of the present invention;

FIG. 5 illustrates a flowchart detailing the CRM process for the finance process in accordance with a preferred embodiment of the present invention;

FIG. 6 is a diagram illustrating the portal subsystems in accordance with a preferred embodiment of the present invention;

FIG. 7 illustrates a schematic block diagram detailing the employer portal subsystem in accordance with a preferred embodiment of the present invention;

FIG. 8 illustrates a schematic block diagram detailing the employee portal subsystem in accordance with a preferred embodiment of the present invention;

FIG. 9 illustrates a schematic block diagram detailing the vendor portal subsystem in accordance with a preferred embodiment of the present invention;

FIG. 10 illustrates a flowchart detailing the process flow in the quoting subsystem in accordance with a preferred embodiment of the present invention;

FIG. 11 illustrates a flowchart detailing the process flow in the enrollment subsystem in accordance with a preferred embodiment of the present invention;

FIG. 12 illustrates a flowchart detailing the process flow in the billing subsystem in accordance with a preferred embodiment of the present invention;

FIG. 13A illustrates a flowchart detailing the process flow in the client invoicing subsystem which is included in the client billing subsystem which in turn is included in the billing subsystem in accordance with a preferred embodiment of the present invention;

FIG. 13B illustrates a flowchart detailing the process flow for posting invoices which is included in the billing subsystem in accordance with a preferred embodiment of the present invention;

FIG. 14 illustrates a flowchart detailing the process flow in the billing subsystem, in particular the client payment process in accordance with a preferred embodiment of the present invention;

FIG. 15A illustrates a flowchart detailing the process flow for the billing subsystem, in particular the vendor billing subsystem in accordance with a preferred embodiment of the present invention;

FIG. 15B illustrates a flowchart detailing the carrier remittance subsystem process flow as part of the vendor billing subsystem in accordance with a preferred embodiment of the present invention;

FIG. 15C illustrates a flowchart detailing the carrier payment subsystem included in the vendor billing subsystem in accordance with a preferred embodiment of the present invention;

FIGS. 16A-16B are table diagrams used in the enrollment subsystem for the integrated insurance system in accordance with a preferred embodiment of the present invention;

FIGS. 17A-17B are table diagrams used in the billing subsystem and support tables in accordance with preferred embodiments of the present invention;

FIGS. 18A and 18B illustrate flow diagrams detailing exemplary interactions for the employer portal and the employee portal, respectively, in accordance with a preferred embodiment of the present invention;

FIG. 19 illustrates a view of a display screen that a user interfaces with in order to allow an account executive to view which users have access to the system in accordance with a preferred embodiment of the present invention;

FIG. 20 illustrates a view of a display screen that a user interfaces with in order to log into a portal and setup an account access in accordance with a preferred embodiment of the present invention;

FIG. 21 illustrates a view of a display screen that a user interfaces with in order to view account information in accordance with a preferred embodiment of the present invention;

FIG. 22 illustrates a view of a display screen that a user interfaces with to view quotes in accordance with a preferred embodiment of the present invention;

FIG. 23 illustrates a view of a display screen that a user interfaces with in order to access the account as part of customer service menu option in accordance with a preferred embodiment of the present invention;

FIG. 24 illustrates a view of a display screen that a user interfaces with in order to view the account information from within the CRM system in accordance with a preferred embodiment of the present invention;

FIG. 25 illustrates a view of a display screen that a user interfaces with in order to view the invoices from within the CRM system in accordance with a preferred embodiment of the present invention;

FIG. 26 illustrates a view of a display screen that a user interfaces with in order to view invoice details from within the CRM system in accordance with a preferred embodiment of the present invention;

FIG. 27 illustrates a view of a display screen that a user interfaces with for viewing payments from within the CRM system in accordance with a preferred embodiment of the present invention;

FIG. 28 is a flowchart detailing the setup of a policy in accordance with a preferred embodiment of the present invention;

FIG. 29 illustrates a view of a display screen that a user interfaces with in order to view a policy in accordance with a preferred embodiment of the present invention;

FIG. 30 illustrates a view of a display screen that a user (CSR) interfaces with in order to enter all pertinent information when adding a new policy in accordance with a preferred embodiment of the present invention;

FIG. 31 illustrates a view of a display screen that a user interfaces with in order to map plans to a policy in accordance with a preferred embodiment of the present invention;

FIG. 32 illustrates a view of a display screen that a user interfaces with in order to assign sales roles as part of the enrollment process in accordance with a preferred embodiment of the present invention;

FIG. 33 illustrates a view of a display screen that a user interfaces with in order to setup policy holders in the enrollment process in accordance with a preferred embodiment of the present invention;

FIG. 34 illustrates a view of a display screen that a user interfaces with in order to list all the policies in the particular account and indicate different status in accordance with a preferred embodiment of the CRM/billing subsystem of the present invention;

FIG. 35 illustrates a view of a display screen that a user interfaces with in order to setup or review the billing attributes of a policy in accordance with a preferred embodiment of the present invention;

FIG. 36 illustrates a view of a display screen that a user interfaces with in order to display enrollment policy details in accordance with a preferred embodiment of the present invention;

FIG. 37 illustrates a view of a display screen that a user interfaces with in order to display an override plan that is used to manually set a rate for a plan in accordance with a preferred embodiment of the present invention;

FIG. 38 illustrates a view of a display screen that a user interfaces with, in particular a customer to log into the system in accordance with a preferred embodiment of the present invention;

FIG. 39 illustrates a view of a display screen that a user interfaces with in order to display customer specific information such as, for example, previous quotes and coverage profile in accordance with a preferred embodiment of the present invention;

FIG. 40 illustrates a view of a display screen that a user interfaces with in order to display a client, in particular, a company profile in accordance with a preferred embodiment of the present invention;

FIG. 41 illustrates a view of a display screen that a user interfaces with in order to display the employee profile and corresponding employee information in accordance with a preferred embodiment of the present invention;

FIG. 42 illustrates a view of a display screen that a user interfaces with in order to perform a new rate comparison that includes the entering of company information in accordance with a preferred embodiment of the present invention;

FIG. 43 illustrates a view of a display screen that a user interfaces with in order to enter employee information to perform a new rate comparison in accordance with a preferred embodiment of the present invention;

FIG. 44 illustrates a view of a display screen that a user interfaces with in order to enter employer contribution to perform a new rate comparison in accordance with a preferred embodiment of the present invention;

FIG. 45 illustrates a view of a display screen that a user interfaces with in order to display a comparison of all the plans offered in accordance with a preferred embodiment of the present invention;

FIG. 46 illustrates a view of a display screen that a user interfaces with in order to display the comparison of the plan rate for each individual employee in a company in accordance with a preferred embodiment of the present invention;

FIG. 47 illustrates a view of a display screen that a user interfaces with in order to selectively remove certain plans from a quote page in accordance with a preferred embodiment of the present invention;

FIG. 48 illustrates a view of a display screen that a user interfaces with in order to enroll in the integrated insurance system in accordance with a preferred embodiment of the present invention;

FIGS. 49 and 50 illustrate views of display screens that a user interfaces with in order to enter all the pertinent information for an employer such as all the billing information for an employer in accordance with a preferred embodiment of the present invention;

FIG. 51 illustrates a view of a display screen that a user interfaces with in order to enter a level of employer contribution in accordance with a preferred embodiment of the present invention;

FIG. 52 illustrates a view of a display screen that a user interfaces with in order to enter employee information for each employee in accordance with a preferred embodiment of the present invention;

FIG. 53 illustrates a view of a display screen that a user interfaces with in order to map employee plans in accordance with a preferred embodiment of the present invention; and

FIG. 54 illustrates a view of a display screen that a user interfaces to display a list of employees with the corresponding forms which need to be completed for the enrollment process in accordance with a preferred embodiment of the present invention.

### DETAILED DESCRIPTION OF THE INVENTION

The integrated insurance system is a fully integrated contact management, quoting, enrollment and billing system for insurance products that is implemented by an insurance broker. The insurance coverage that the integrated system offers includes insurance for, but not limited to, medical, life, dental, short-term disability, long-term disability, property and casualty, automobile and homeowner's insurance. These products are directed towards groups and individuals, hereinafter described as employers and employees, respectively.

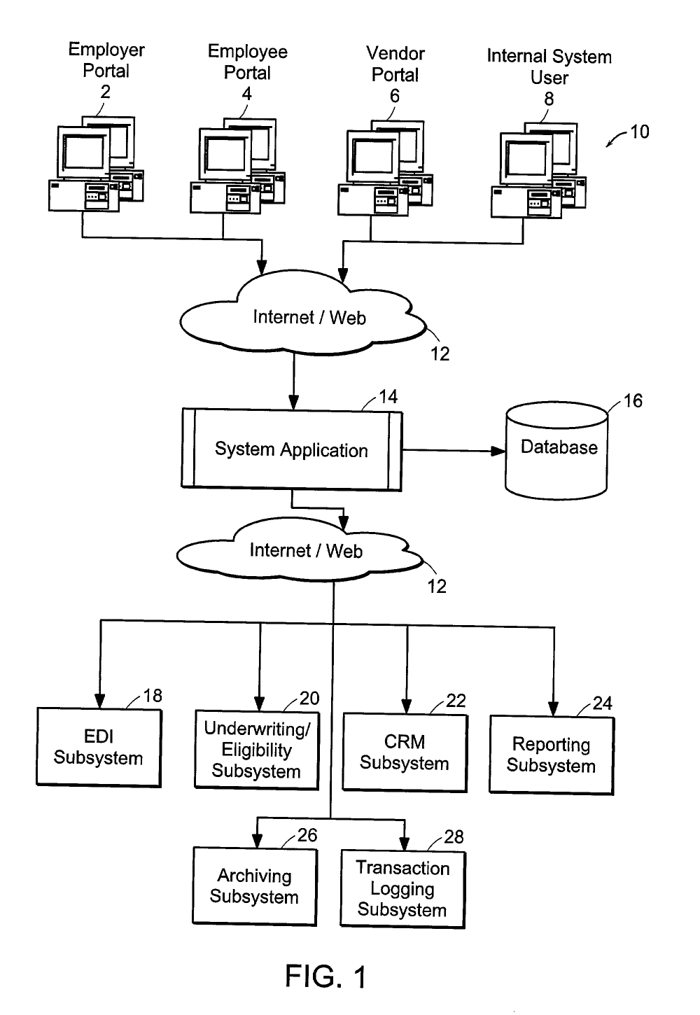

FIG. 1 is a schematic block diagram of the integrated insurance system 10 in accordance with a preferred embodiment of the present invention. The integrated insurance system can be divided into two systems: the internal system(s), designed for the employees who service the system, and the external system, designed for all other users that interface with the system 10. The internal system includes the customer resource management (CRM) system 22, including all customizations. In a preferred embodiment, the external subsystems include the portals for the employer 2, employee 4 and vendor or carrier 6 that interface with the quoting or rate comparison, enrollment, and billing subsystems. Internal users make use of the CRM system 22, and have access to the external systems, while external users can only access specific sites, such as quoting and enrollment. The internal users can be subdivided along business lines, such as sales, customer service and finance. The CRM system tracks all manners of tasks, electronic mail (e-mails), product literature and activities for the customers, vendors and carriers. The CRM system is integrated into each of the other modules.

In a preferred embodiment, the billing process is responsible for generating and tracking invoices, generating and tracking commissions on sales of premiums and generating and tracking payments to the carriers. Invoices are generated each month for all active accounts. An invoice is based on the premium rates which are calculated when a company first enrolls. An enrollment period is typically one year. Each year the individual plan rate is updated based on new information received from the carrier. In general, a monthly invoice is composed of the plan chosen by each employee. Each plan has a rate which is determined by the carrier. When a payment is collected from an employer, a portion of the payment (known as the carrier remittance) is passed back to the carrier. The remaining portion is broken down to the sales person's commission and the company profit:

Monthly Invoice=Total Premium Collected=carrier Remittance+Sales Commission+Profit

A preferred embodiment billing process flow is as follows:

TABLE 1

| | |
|---|---|
| Generate | Each month the system generates invoices to the |
| Bills | employer groups. These invoices are based on the plans |
| | (aka policies) setup by the employer group. |
| Mail Bills | The bills are mailed to the employer groups before the |
| | first of the month. |
| Pay Bills | The employer group sends a check to the insurance |
| | company or system administrators for the invoiced amount. |
| Apply | When the check arrives, the payment is applied to the |
| Payment | outstanding invoice(s). |
| Release | If the invoice is paid in full, the invoice is marked closed |
| Funds | and the payment is “released” to the carrier. |
| Hold Funds | If the full amount is not received, the invoice is marked |
| | “Pending” and the funds are not paid to the carrier. If the |
| | invoice is not paid after the grace period (typically |
| | 30 days; however, the grace period is specific to the |
| | carrier), then the account is automatically “Suspended” |
| | and their coverage stopped. |

Those skilled in the art will readily see that the number of components of the insurance processing system 10 can be increased beyond what is depicted while maintaining the functionality of the processing system. The insurance processing system makes use of multi-user computer operating systems and network software which makes it possible to scale the capacity of the insurance processing system to the number of portals and the amount of processing activity. The insurance processing system includes a front end processing subsystem that comprises of portals 2, 4, 6, 8 to communicate with each party, be it an individual client (employee) 4, a group client (employer) 2, a carrier or vendor 6 or the system agents or service personnel who administer the functionality of the system. The system 10 includes multiple database data processors 16 to access and store a plurality of databases. The system 10 further includes a plurality of back end processing subsystems such as, but not limited to, the electronic data interchange (EDI) subsystem 18, an underwriting and/or eligibility subsystem 20, the CRM subsystem 22, a reporting subsystem 24, an archiving subsystem 26 and a transaction logging subsystem 28.

In a particular embodiment, the insurance processing system 10 makes use of a computer network, such as the Internet 12 to link together portals, and subsystems interested in processing insurance contracts and products. The system application 14 using a stored sequence of instructions communicates via the network 12 with each portal and each subsystem.

An operating environment for the system 10 of the present invention includes a processing system with at least one high speed processing unit and a memory system. In accordance with the practices of persons skilled in the art of computer programming, the present invention is described below with reference to acts and symbolic representations of operations or instructions that are performed by the processing system, unless indicated otherwise. Such acts and operations or instructions are sometimes referred to as being “computer-executed”, or “processing unit executed.”

It will be appreciated that the acts and symbolically represented operations or instructions include the manipulation of electrical signals by the processing unit. An electrical system with data bits causes a resulting transformation or reduction of the electrical signal representation, and the maintenance of data bits at memory locations in the memory system to thereby reconfigure or otherwise alter the processing unit's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic disks, and any other volatile or non-volatile mass storage system readable by the processing unit. The computer readable medium includes cooperating or interconnected computer readable media, which exist exclusively on the processing system or is distributed among multiple interconnected processing systems that may be local or remote to the processing system.

A preferred embodiment of the system is used in states which offer non-community medical rated. This requires the system to handle the complex nature of non-community medical underwriting. The system can be a rules-based, java-based application which codifies carrier eligibility rules. This embodiment automates the processes of on-line eligibility checking in order to cut down on enrollment and renewal errors which can potentially delay the enrollment process.

A preferred embodiment includes instantaneous access to information within the CRM system and therefore, a dynamic on-line reporting system.

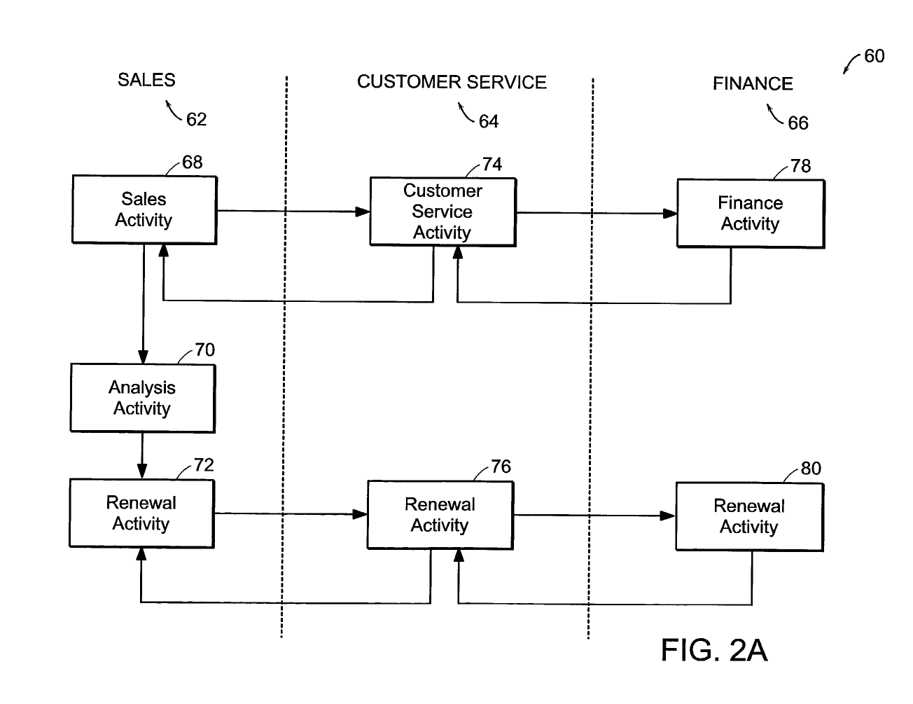

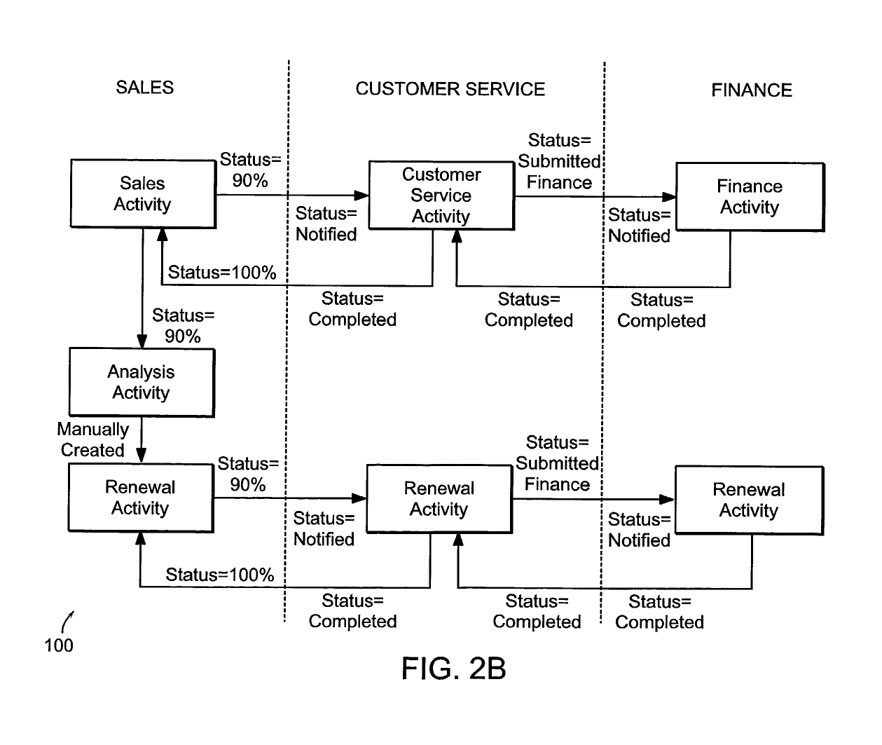

FIGS. 2A and 2B are schematic flowcharts 60, 100 illustrating the customer relationship management (CRM) process flow in accordance with a preferred embodiment of the present invention. The CRM process flow includes a sales process 62, a customer service process 64 and a finance process 66. In a preferred embodiment, the sales activity step 68 initiates the new sales activity. This initiation can occur from purchased lists or from an interaction on-line using a wide area network web product such as the Internet. The status of the sale process is tracked as shown in FIG. 2B. Once the status reaches 90%, a customer service activity 74 is automatically created. When the sales activity reaches a status of 100% complete, an analysis activity 70 is created. In a preferred embodiment the analysis activity may not occur for a web-based inquiry. Further, a renewal activity 72 is automatically created when the analysis activity 70 reaches a status of 100% complete. The activities may be automatically created or in an alternate embodiment be manually created.

The customer service activity 74 tracks the enrollment process and related subsystem activity. Once the enrollment status reaches a status of 90% complete, a finance activity 78 is created. The finance activity 78 tracks all of the steps necessary to activate an account for the billing subsystem. Once this activity has a status of 100%, the customer service activity is automatically updated to a status of 100% complete and the sales activity is automatically updated to a status of a 100% completed.

In a preferred embodiment, the CRM system is based upon any CRM system, for example, the employee portal such as, but not limited to one provided by Onyx Software which is modified for use by the integrated system. The CRM system offers standard contact management functionality, such as tracking customer names and addresses, as well as contact names and addresses. Additionally, the CRM system tracks customer notes and customer “events”. These events are broken into two major categories: tasks (which are items to be performed for the customer at a later date in time) and activities. In a preferred embodiment, the CRM system defines three types of activities: sales activities, service activities, and support activities.

The integrated system utilizes all three of these activities. Sales activities are used by the sales department, service activities are used by the customer service department and support activities are used by the finance department. Sales, support and service activities give the system the ability to track minute details related to customer events. Each department defines their activity types by way of a custom status, call results, priorities and activity source. An example of a sales activity is a new sales lead; an example of a service activity is a new enrollment. The CRM system has additional functionality, such as product tracking, quoting and mail merge, used in preferred embodiments of the present invention.

The CRM process flow in preferred embodiments also includes maintenance processes. These maintenance provisions include, but are not limited to, processes to accommodate revisions (additions, deletions), terminations of policies and grievances.

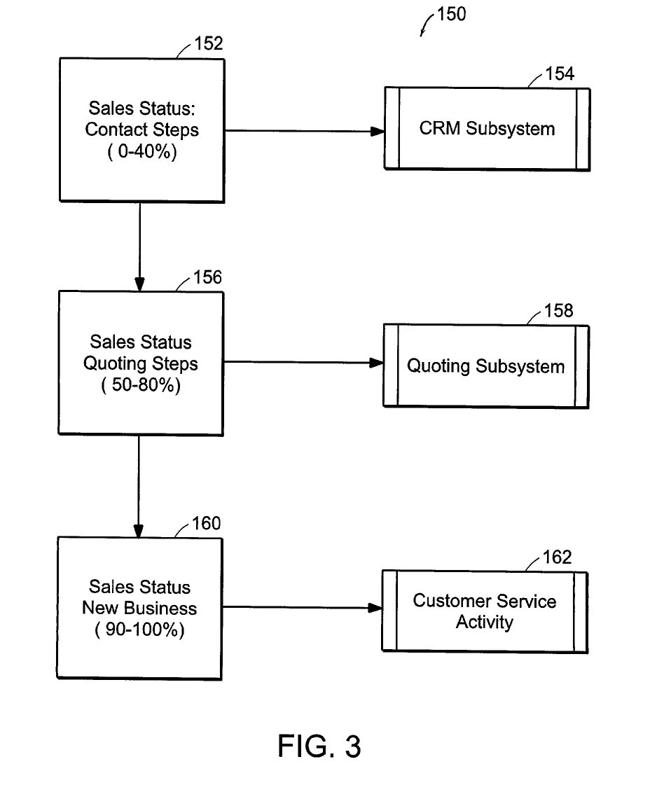

FIG. 3 illustrates a flowchart detailing the CRM process for the sales process in accordance with a preferred embodiment of the present invention. This process flows 150 illustrates the interaction between the sales process steps and subsystems of the integrated insurance system 10. The sales CRM process 150 includes contact steps 152 that occur either via telemarketing efforts or in an alternate preferred embodiment via on-line transactions using the Internet web product for the integrated insurance system 10. For web access, the CRM subsystem 154 can generate a user name, a corresponding password and contact record. In a preferred embodiment the contact steps 152 can include a prequalification step, a data management step and an application step.

The quoting steps 156 make use of the quoting subsystem 158 in order to generate a quote. In a preferred embodiment the quoting steps 156 include a written proposal process and an execution of the proposal process. The new business steps 160 include the creation of a new customer service activity 162 when the sales status is set to 90% in accordance with a preferred embodiment of the system.

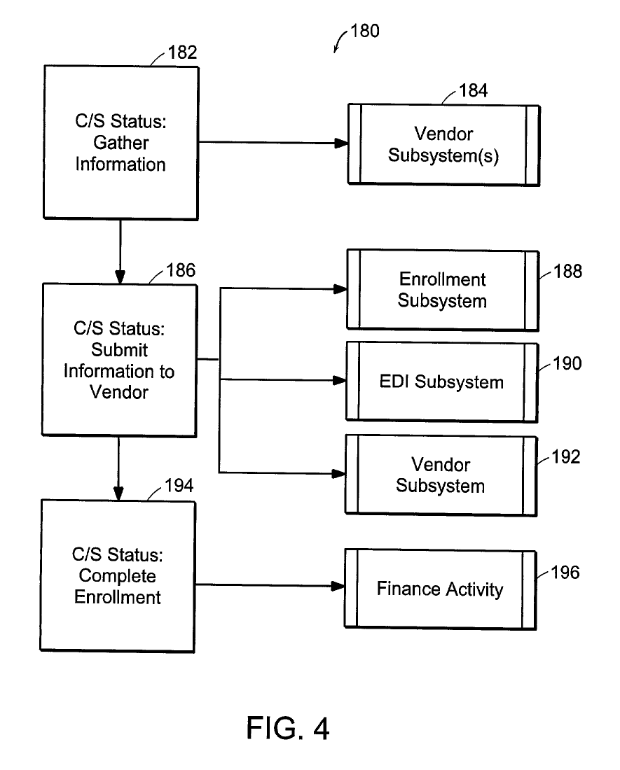

FIG. 4 illustrates a flowchart detailing the CRM process for the customer service process in accordance with a preferred embodiment of the present invention. The customer service process 180 includes a step 182 for gathering information which serves as a first step. This step allows gathering of group or individual information via, but not limited to, telephone, web or electronic access from another vendor system, such as, for example, a payroll company. During this process all necessary forms, if applicable, are filled in and all required documents and signatures are gathered. A vendor subsystem 184 is in communication with the CRM process to enable step 182.

The process includes a subsequent step 186 of submitting information to a third party, such as a vendor. The information gathered from step 182 is transmitted to the vendor subsystem 192 for approval. The data gathered is also submitted to the enrollment subsystem 188 and the electronic data interchange (EDI) subsystem 190. Data can be transmitted either via paper or hardcopy, facsimile or using the EDI exchange. The next step 194 is the completion of the enrollment process which includes the finance activity 196 approving the account information and in a preferred embodiment activating the account for billing the client.

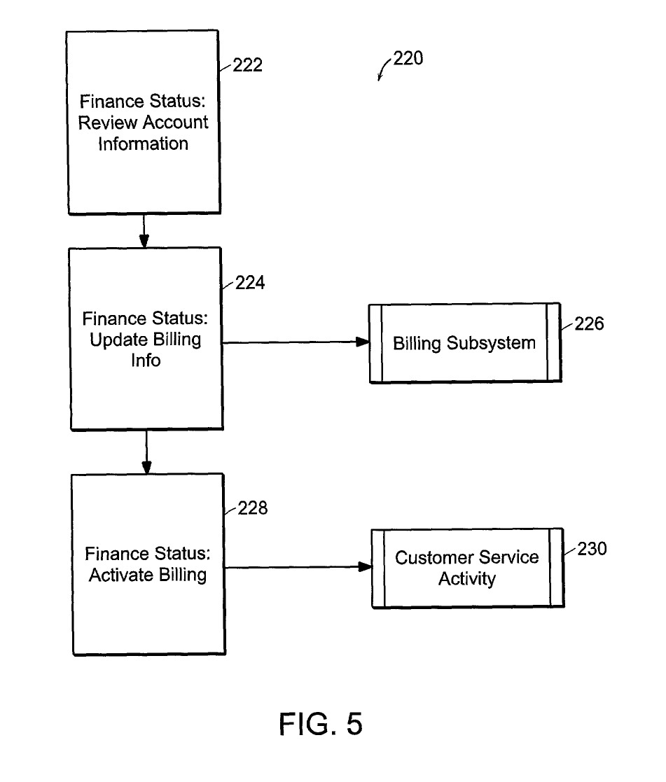

FIG. 5 illustrates a flowchart detailing the CRM process for the finance process in accordance with a preferred embodiment of the present invention. The finance CRM process 220 includes the step of reviewing the account information 222. In a preferred embodiment the finance subsystem can make use of different subsystems to verify account information. Further, the billing information is updated per step 224. The billing subsystem 226 is in communication with the finance CRM process to enable the billing information update. The billing subsystem 226 is used to make any necessary account changes and to fill-in required billing fields for billing purposes.

The step 228 for activating the account for billing completes the finance subsystem's activity. Once the account is activated, the customer service activity 230 has a status of 100% complete.

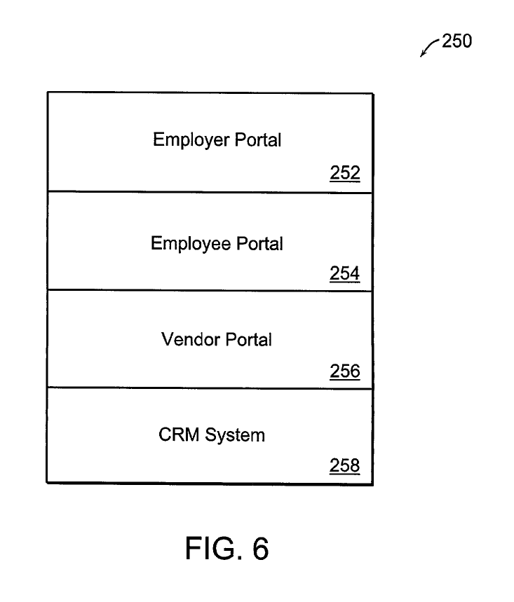

FIG. 6 is a diagram illustrating the portal subsystems in accordance with a preferred embodiment of the present invention. The integrated insurance system application is composed of multiple portals which are used to access the system 10. All users of the system access the system via the CRM system. The portal subsystem 250 includes the employer portal 252 also known as the customer portal. This portal is used for group insurance purposes. The employer portal ties together all of the employer functionality, including quoting, enrollment and, eventually, billing history into one central location. The customer is able to access the portal using one simple, secure log-in, located at, for example, https://secure.valuebenefits.com/login. In the system, the customer username and passwords are setup via the CRM primary contact record. In the system, the username and password are created before the system account is created.

Within the CRM system, the primary contact screen includes a username, password, password expiration date and user type. This username and password is used to validate the customer when they log into the system. The password expiration date permits the account executive (AE) or customer service representative (CSR) to deactivate an account on a specific date. In a preferred embodiment, the user type field indicates whether the user is an employer or an employee.

The employer portal is the central location from which the employer can access, and control, his/her account. The employer portal consists of three main components in a preferred embodiment, for example, profiles (both company and employee profiles), quoting history and coverage policies.

The profile section of the portal allows the employer to change his/her company address and contact information. The purpose of this section is to gather information which is used in all future quotes and enrollment processes. The employee profiles contain demographic and contact information for each employee, including their dependent(s). The employee list is used to populate census information for quotes and policy enrollment. The advantages of maintaining profile information include the availability of easy data entry. Instead of having to enter company information or employee information when creating quotes and enrollment, the profile information is available for easy data entry.

The quoting section of the employer portal allows all new quotes to be saved automatically to the account. This allows an AE who calls up the account in the CRM system to see all existing quotes for the customer. Furthermore, when the customer creates a new quote, their existing customer and employee information pre-populates the quote using the account profile information.

A preferred embodiment enables the ability to edit quotes for different insurance products. Any eligibility issues which arise if a customer changes company or employee profiles is manually tracked by the CSR and appropriate actions taken to resolve them. Another preferred embodiment implements a more sophisticated method of tracking potential eligibility issues which arise when profile information is changed by automating the tracking.

In a preferred embodiment, when adding, editing or deleting enrollment information, an archive is made of all changes for tracking purposes. The archive tables store a copy of all of the information after it is changed by the user, as well as a flag which indicates the type of change: add (a), edit (e) or delete (d). The date and time of the change is also recorded along with user who made the revision.

A preferred embodiment of the system contains the capabilities for terminating and changing coverage for employees. Employees can be terminated by accessing the employee list (under the employee profile) and pressing the link to delete an employee from the company. The employer is then presented with a list of all policies the employee participates in. The employer can terminate coverage for one or more of these policies.

To change the coverage for a specific employee, the employer is able to follow a link from the main page to “Change Employee Coverage.” This link displays a list of coverage for each employee. The employer can then chose which employee and coverage they wish to change.

It should be noted that each carrier has sophisticated eligibility rules for providing coverage to small groups. The preferred embodiment system determines if any of these rules are violated by terminating one or more employees. This ability may be left to the CSR who monitors all changes to the group. The system can incorporate carrier rules which dynamically track these types of changes and informs the customer if they are violating a carrier eligibility rule in a preferred embodiment. Thus, each time a customer changes the company, employee or dependent profile information, the information is backed up to an archive table. This archive table is used to keep track of adds, edits and deletes within the system, as well as to send change information to the carrier.

Another preferred of the employer portal tracks employee discount cards. Discount cards are membership plans consisting of ancillary health care benefits that offer point of service discounts on products and services. The system provides these cards from a distributor to offer this service to the customers. On-line electronic payment capabilities are included in preferred embodiments.

Another portal, the employee portal 254 is used by individuals, including employees of a group. The employee portal is the central location for an employee to log-in to manage his/her account. The need for an employee portal is driven by the system's expansion into individual lines of coverage, such as, for example, home owner's and automobile insurance. These types of policies are typically sold directly to an individual and not a small group.

Thus, the employee portal allows the individual employee access to his/her company and private information. An example of an employee's company information is home address, telephone number. The employee's private information can include the names, date of births and social security numbers of his/her dependents. Other private information includes potential automobile and home owner's insurance policies which the user has elected to receive through the employer, but ultimately passes through to the employee. The employee portal contains both company information, i.e. information related to their group, and individual information, such as an individual automobile insurance policy. Another embodiment provides employee's access to on-line provider directories. On-line provider directories help the customer select the best available plan which is offered with their existing physician, for example.

The vendor portal 256 is an additional portal providing access to the vendors of disparate insurance products to system information such as, for example, reports on group counts, total premium sold, and commission tracking. The CRM system 258 is included in the portal subsystem which is used by the employees of the integrated insurance system, and as such is a portal available only for internal sources of the system 10. This CRM system 258 is different from the CRM subsystem described hereinbefore which can be accessed by groups, individuals or vendors.

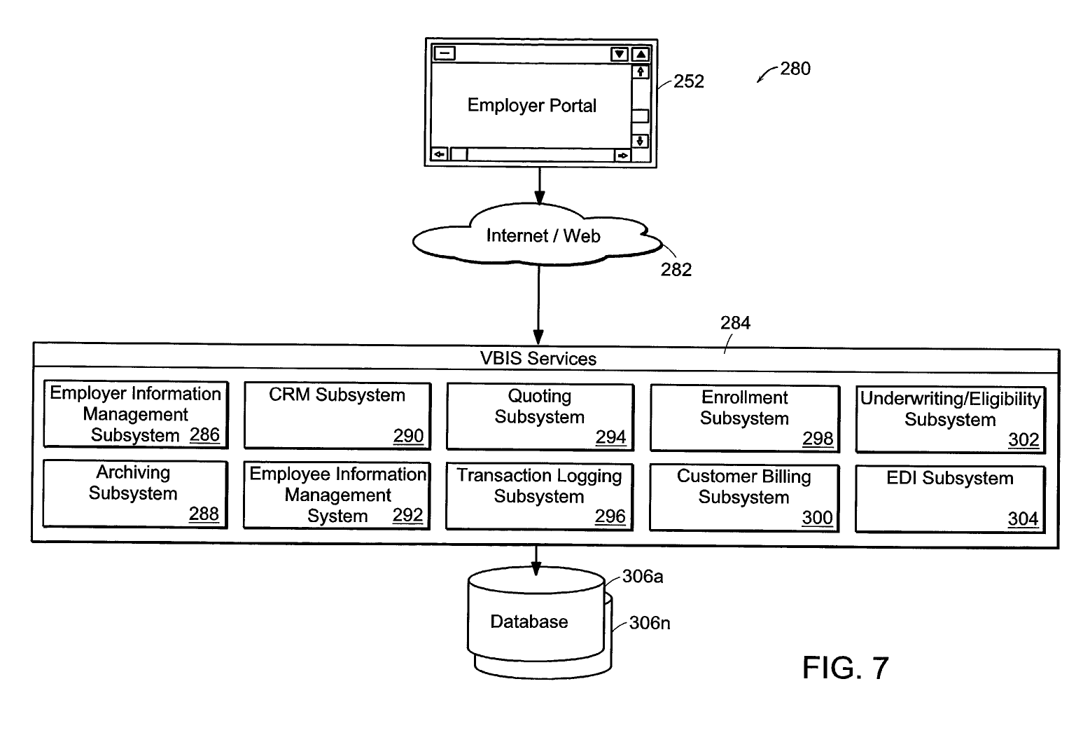

FIG. 7 illustrates a schematic block diagram detailing the employer portal subsystem in accordance with a preferred embodiment of the present invention. The employer portal 252 accesses the integrated insurance system application 284 using the Internet 282. The application 284 includes multiple subsystems which in a preferred embodiment can be customized for the particular group or employer. These subsystems include the employer information management subsystem 286, an archiving subsystem 288, the CRM subsystem 290, employee information management system 292, a quoting subsystem 294, a transaction logging subsystem 296, enrollment subsystem 298, customer billing subsystem 300, an underwriting and/or eligibility determining subsystem 302 and an EDI subsystem 304. In a preferred embodiment, the subsystems may communicate with other subsystems for data exchange or verification purposes. For example, the quoting subsystem can call the vendor subsystem for particular information.

The application 284 accesses and is in communication with the system database 306a . . . n such as, for example, a CRM database or an application specific database. The employer portal is a central location where the customer can manage his/her account, including, for example, company name and address, employee names and addresses, quotes and lines of insurance coverage.

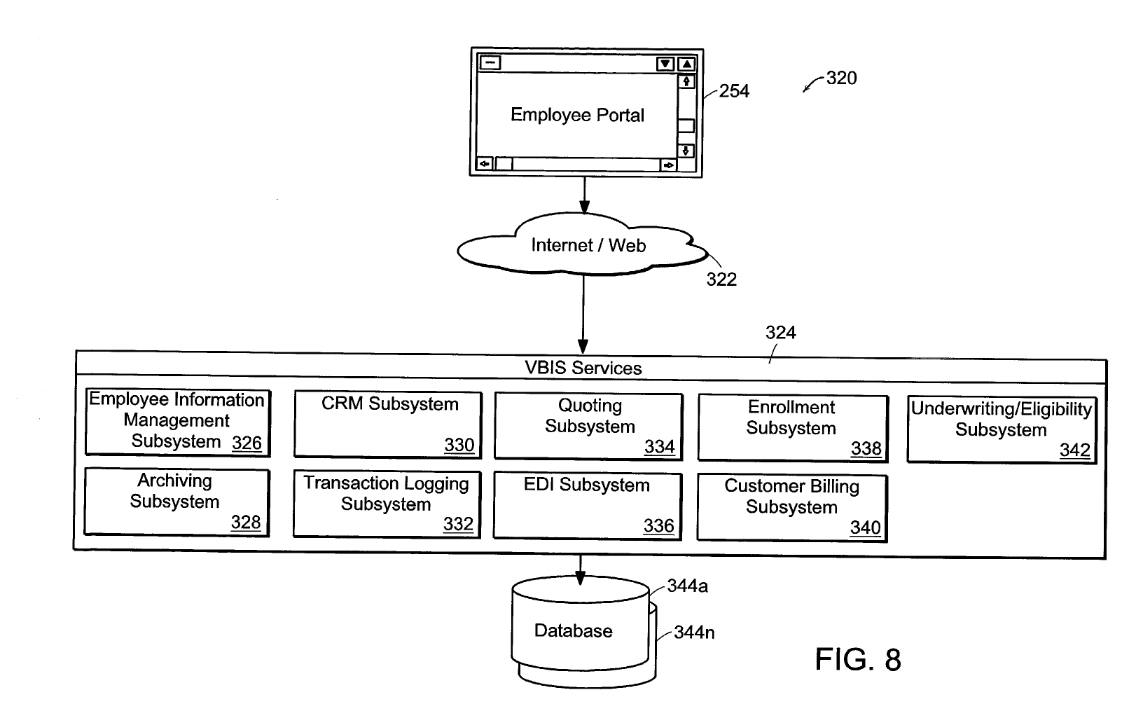

FIG. 8 illustrates a schematic block diagram detailing the employee portal subsystem in accordance with a preferred embodiment of the present invention. Similar to the communication paths and access to subsystems, the employee or individual portal 254 communicates with the integrated insurance system application 324 using the Internet 322. The subsystems such as, for example, employee information management subsystem 326, archiving subsystem 328, CRM subsystem 330, transaction logging subsystem 332, quoting subsystem 334, EDI subsystem 336, enrollment subsystem 338, customer billing subsystem 340 and underwriting/eligibility subsystem 342 can be customized for the particular employee portal. Further, in the preferred embodiments the subsystems may interface with other subsystems described with respect to other figures, such as the vendor subsystem.

The databases 344^{a . . . n} are included in storage devices for the storage of data and can be accessed when required for the employee portal process flow. The insurance coverage that the integrated insurance system 10 offers includes insurance for medical, property and casualty, automobile and homeowner's insurance. These products are directed towards individuals and groups. This individual service allows the system to grow beyond managing small business accounts. The employee portal allows the individual to view and modify private data, irrespective of their employer. The system coordinates employee changes with employer updates.

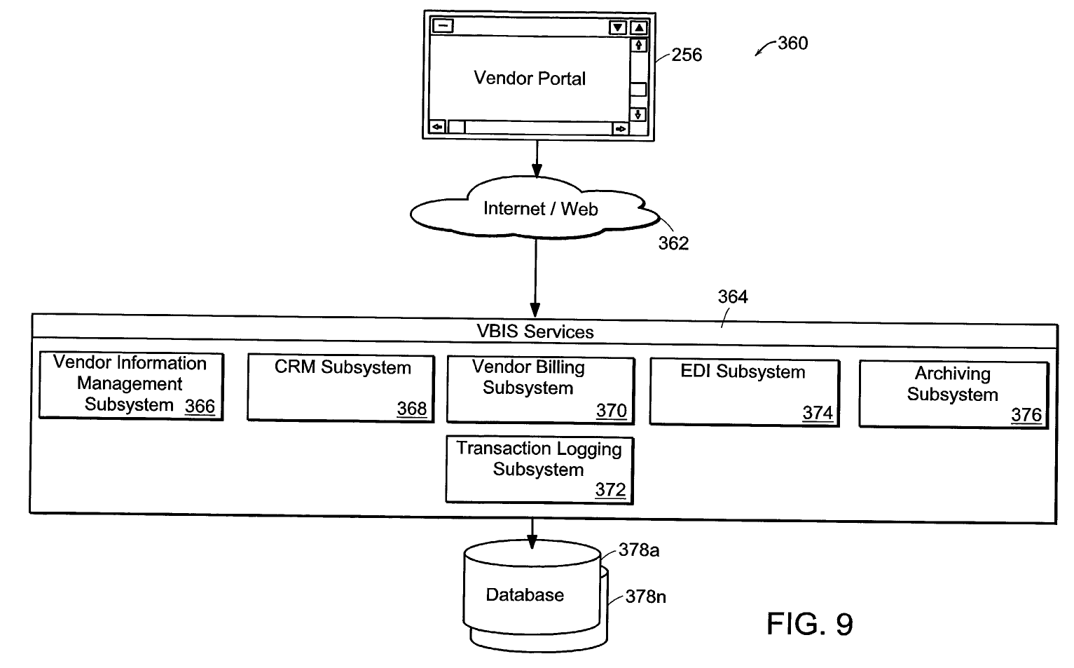

FIG. 9 illustrates a schematic block diagram detailing the vendor portal subsystem in accordance with a preferred embodiment of the present invention. The vendor portal 256 communicates with the application 364 using, for example, the Internet 362. The application subsystems and thus services include vendor information management 366, CRM subsystem 368, vendor billing subsystem 370, transaction logging subsystem 372, EDI subsystem 374 and archiving subsystem 376. The application 364 uses databases 378a . . . n to store and access information.

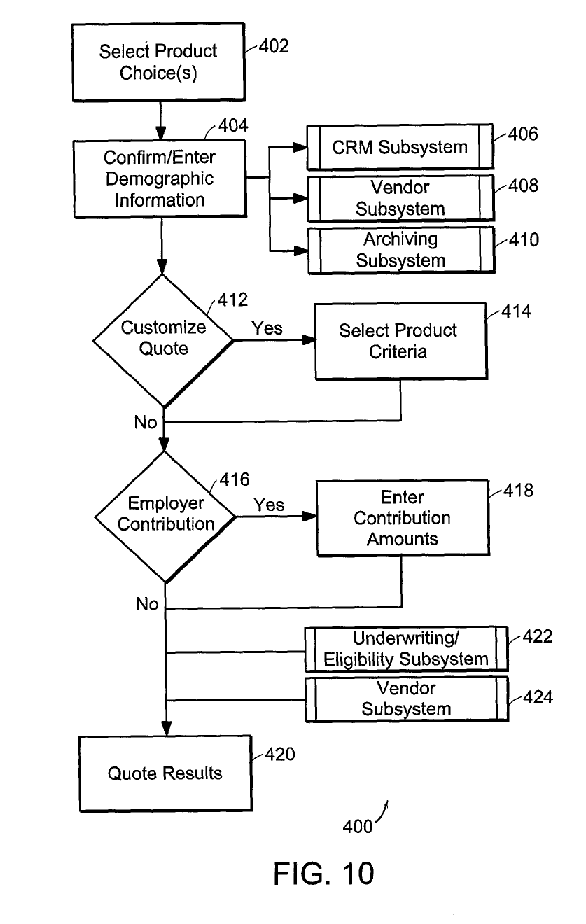

FIG. 10 illustrates a flowchart detailing the process flow in the quoting subsystem in accordance with a preferred embodiment of the present invention. The quoting system 400 includes the step of selecting product choice(s) 402 which can include group product choices or individual product choices. The group product choices include: medical, dental, term life, short/long term disability, worker's compensation, and commercial automobile insurance. The individual product choices include: medical, dental, term life, short/long term disability, automobile, home owners, and property and casualty insurance. The quoting system then includes the step of confirming and/or entering demographic information 404. This step 404 communicated with the CRM subsystem 406, vendor subsystem 408, and the archiving subsystem 410. These subsystems may be called to automatically enter the employer/employee information. For group quoting, the employer may enter employee census information. The archiving subsystem tracks all changes to the system. The quoting subsystem then includes the determination step of customizing a quote 412. If a custom quote is required then the method 400 includes the step of selecting a product criteria 414. The type of product criteria is dictated by several factors, including, but not limited to, product choice and vendor choices. If, however, a custom quote is not required then a second determination is made in the step of ascertaining employer contribution 416. If the employer is contributing then the user is prompted to enter contribution amounts per step 418. The contribution amounts may only apply to some products and not all. If, however, the employer is not contributing then the process communicates with the underwriting/eligibility subsystem per step 422, and the vendor subsystem per step 424. The underwriting subsystem may be used for some product lines, but not all. In some instances the underwriting or eligibility checking can be carried out by a vendor subsystem. The final step includes quoting the results per step 420.

In a preferred embodiment the quoting system is a stand-alone system which is securely accessed via the system's home page on the Internet. In order to access the quoting system, the user logs into the system using a valid account identifier (id) and password. The account id and password is distributed by an account administrator. The preferred embodiment quoting system can accommodate “anonymous” users. The concept of the anonymous user is based on a model in which a customer can create a quote using minimum information, i.e., no address or contact information, and save the quote. In a preferred embodiment, these quotes are not connected to an account. Unless the customer specifically tells the administrator which quote they have created, the administrator has no way of linking the quote to the customer's account. In an alternate embodiment of the system of the present invention this constraint is removed and tightly couples an account to a quote. The system can quote medical insurance and ancillary lines, such as, for example, but not limited to, term life, dental, long or short term disability.

The quoting process is initiated by the customer logging into the system. Once the customer logs into the quoting system, they have the option of either creating a new quote or reviewing existing quotes. The review of existing quotes screen contains a list of quotes, including the quote name, date of the quote and the company name. Links exist to edit, preview or delete the quote.

In a preferred embodiment, to create a new quote, the customer begins by entering their business zip code. The business zip code is used to determine if plans exist within the specified zip code. If plans do exist, then a list of carriers who represent the plans is displayed as well as a brief description of the process for creating a quote. The next screen gathers the customer's name, address, coverage start date and the employee count. The coverage start date, employee count and business zip codes are used to determine which plans and which rates to use to generate the quote. The customer does not have to re-enter his/her company information and employee information for each quote in a preferred embodiment of the integrated system.

In an alternate embodiment, once the company information is saved, the next screen asks the customer to enter their standard industry code (SIC) code or to lookup the SIC code via an application that guides the user through the process screens, for example, a wizard. This screen is optional and can be skipped if desired. The next screen collects the employer census information. The total number of employees displayed on the screen is determined from the customer information screen. For example, if the customer indicated they had five (5) employees, then this list would include five employees. The employee names are defaulted to “Employee n” where “n” represents a number 1 through 5. Additionally, the customer fills in the date of births, gender and type of coverage (either individual, individual plus spouse, individual plus child or children or family) for each employee. The census information is used to determine the exact rate to charge for each product.

The next screen asks the customer to select the amount they wish to contribute to their employee's medical plan coverage. The customer can contribute in three ways: flat fee, which is a specific dollar amount, percent of cost, which is a percentage of the cost for each plan, or the percent of lowest individual plan, which is a percentage of the lowest individual plan offered by the carrier within the determined market. These contributions can be made for each of the coverage levels, individual, individual plus spouse, individual plus child or children or family.

The final screen displays all of the medical plans offered within the customer's business zip code. The plans are displayed in order of lowest price to most expensive. However, the customer can sort the list by any column by clicking on the column header.

In a preferred embodiment, the customer can save the quote if they wish to view it again. To save a quote, the customer must enter a name for the quote, their electronic mail (e-mail) address and a password. In an alternate preferred embodiment quotes are automatically saved to a user's account.

In another preferred embodiment, the quoting subsystem of the customer portal includes displaying ancillary insurance quotes. Instead of using the application wizard approach to creating quotes, the quote has a more form-like appearance with the customer information at the top of the quote and employee coverage sections related to desired insurance products, such as medical, dental, life and short/long term disability. Each section of the quote has a button to change or edit the details. All quotes are created by an AE using the custom screens described hereinafter. The company and employee demographic information is used to pre-populate the quote.

In a preferred embodiment, the employer can request a quote on-line. The employer enters basic information and is directed to the website via an insurance broker. After entering the employer information and filling in the employee demographics, a quick quote is generated. The quick quote contains the various plans offered, including the low, medium and high options. The quick quote is an initial ball park quote that is based on basic information, such as employer zip code and alternatively based on the employee's age and gender. Its purpose is to demonstrate to the customer that the system can offer competitive prices along with employee choice of plans. In other words, it is fundamentally a qualification tool. Someone who requests a quick quote can be reasonably assumed to be in the market. And getting a prospect to request a quick quote is the first major milestone in the sales process. The inputs to a quick quote are: employer's zip code, the employer's name and address are optional, employer's county (automatically filled in based on the zip code), SIC code for the business (for most states is an optional parameter), total number of employees to be covered and employer's contribution level (also an optional parameter). For each employee the inputs include age (this depends on the State where the business is located), gender (this depends on the State where the business is located), and coverage type (Individual, Family, Individual+Spouse, or Individual+Child(ren)). The inputs are applied to a set of Base Rate Tables supplied by the carriers. In a preferred embodiment, at least three schedules of benefits from each carrier are provided based on feature set (and thus price), for example, low, mid, high. The carrier supplies the system with their rates for all of their plans. Included with the rates are all applicable qualifiers, such as age banding, gender, employee count banding and/or SIC codes. Furthermore, the carrier determines which “regions” each of the plans are offered in. A region is defined as a set of zip codes. A region can be as simple as one or more counties or can a custom-defined selection of zip codes. In either embodiment, each region must contain a unique set of zip codes within the state, in other words, a single zip code cannot appear in more than one region. A quick quote can be formatted using HTML.

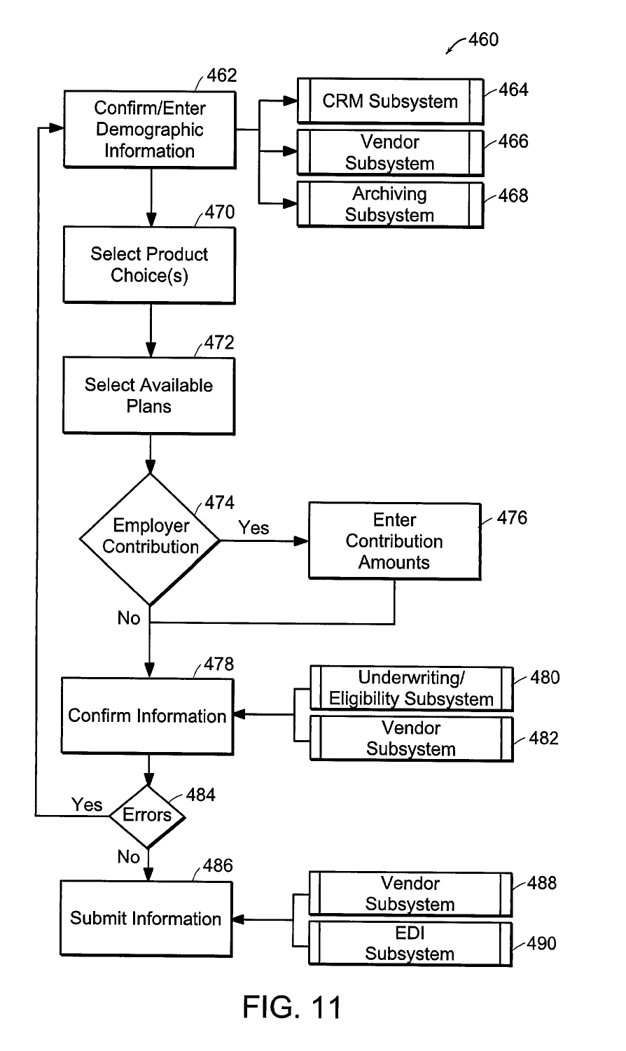

FIG. 11 illustrates a flowchart detailing the process flow in the enrollment subsystem in accordance with a preferred embodiment of the present invention. The enrollment subsystem 460 includes the step of confirming and/or entering demographic information 462. This information is communicated to the CRM subsystem per step 464, the vendor subsystem per step 466, and the archiving subsystem in step 468. These subsystems can be called to automatically enter the employer/employee information. For group quoting the employer can enter employee census information or use the CRM subsystem to setup username and passwords for employees to enter the system themselves. The archiving subsystem tracks all changes to the system.

The next step in the process includes selecting product choice(s) per step 470. The group product choices include: medical, dental, term life, short/long term disability, worker's compensation and commercial automobile insurance. Further, the individual product choices include: medical, dental, term life, short/long term disability, automobile, home owners, and property and casualty insurance.

The next step in the process 460 includes the step of selecting available plans per step 472. Since the quote typically offers the clients, for example, the employer/employee, one or more choices, some products can require the employer/employee to select one or more plans from the available options. The next step in the process includes the determination whether there is an employer contribution per step 474. If yes then the user is prompted to enter contribution amounts per step 476. The contribution amounts may only apply to some products and not all. If the employer is not contributing, then the next step includes confirming the information 478. The underwriting/eligibility subsystem per step 480, and, the vendor subsystem 482 provide inputs to step 478. The underwriting subsystem can be used for some product lines, but not all. In some instances the underwriting or eligibility checking may be carried out by a vendor subsystem. The next step includes checking for errors in step 484. If errors are found by the underwriting/eligibility subsystem, or reported by the vendor subsystem, the user may be asked to return to any of the previous steps to correct the problem. However if no errors are found then the process proceeds to the step of submitting information per step 486. The vendor subsystem 488, and the EDI subsystem 490 provide inputs to step 486. Information can be transmitted via mail, facsimile, EDI or vendor web services in the vendor subsystem.

The enrollment system is a simple interface for the customer in a preferred embodiment. The enrollment system centers around a workflow application which walks the customer through the enrollment process. The enrollment system accommodates medical enrollment, life insurance enrollment, dental insurance, automobile and other insurance enrollments without limitation. The enrollment process is started by the customer service representative (CSR) in the CRM system. The process continues with the customer logging into the system, filling in the required information, and then completing the enrollment by pressing the “Complete” button. The CSR finalizes the enrollment after reviewing the information for accuracy and eligibility and activates the account. The customer's role of filling in the enrollment details is described hereinafter.

The customer starts the enrollment process by logging into the system. The log in page is located, for example, at https://secure.valuebenefits.com/ and is described with respect to screens that a user interfaces with hereinafter. After logging in, the customer has access to a menu, for example, Complete New Enrollment. This option brings the customer to the new enrollment workflow application, for example, a wizard. The workflow wizard application is setup to handle the enrollment of any insurance product. The application walks the user through all of the steps necessary to complete the enrollment process, including, but not limited to, employer demographics screen, employer information screen, employer contributions screen, employee information screen, employee plan list screen; employee plan choose screen, and the insurance forms screen.

In a preferred embodiment, the first screen in the enrollment application is the employer demographics screen. This screen asks the customer to enter their company contact name and address. All required fields are indicated with a red asterisk. The customer cannot save the information unless all required information is entered. This is true for all of the remaining screens.

The next screen, the employer information screen, gathers the following information: tax identification number (TIN), business start date, number of employees in the company, the medical policy effective start date, the employer's SIC code and an employee probation period. The employer information screen is unique in that data input elements at the bottom of the screen are dynamically loaded for each carrier. This allows the system 10 to setup custom input fields for each vendor or carrier and to collect company information for the carrier. This custom information can then be used to populate carrier group enrollment forms.

The next screen, the employer contributions screen, is similar to the employer contributions screen in the quoting system. Continuing on, the employee information screen lists all of the employees for the company. This list contains the employee's name, social security number (SSN) and date of birth. An add button at the top of the list functions as the user interface and allows the customer to setup new employees, while a delete button next to the employee's name allows the customer to delete the specified employee. Clicking on the employee's name opens a new window, the employee information window. This screen contains detailed information on the employee, including, but not limited to, for example, his/her name, address, date of birth, social security number (SSN) and other specific employee information. As with the employer information screen, this screen is unique in that data input elements at the bottom of the screen are dynamically loaded for each carrier. This allows the system 10 to setup custom input fields for each carrier and to collect employee-level information for the carrier. This custom information can then be used to populate carrier member enrollment forms.

The employee information screen contains a link to a list of dependents. Similar to the employee list, the system provides a lists of all dependents associated with this employee. The same steps can be followed to add, edit or delete a dependent.

The next screen in the enrollment workflow application is the employee plan list. This list is meant to be a print out for the employer. It contains all of the available plans for each employee, including the rates for individual, individual plus spouse, individual plus child or children and family. The employer can print out this list for each employee, hand it to the employee and ask them to select their plan and coverage level.

Once the employer gathers the list from the employee, the next screen allows the employer to input which employee selected which plan at which coverage level. The employee plan chooser screen contains a list of all employees in the company and selection fields for the plan names and coverage levels. After saving this information, the customer can proceed to the next screen. By matching the employee to specific carrier plans, the system can accurately determine which enrollment forms need to be filled-in in order to complete enrollment.

The final screen in the enrollment application displays a list of the employees with the corresponding forms which need to be filled in to complete the enrollment process. The system automatically matches up which enrollment forms are necessary for the selected plan.

In a preferred embodiment the system does not pre-populate the enrollment forms with group or employee information. Another preferred embodiment includes functionality to pre-populate the basic enrollment fields for each of the carrier forms. The basic enrollment fields are defined as the common fields shared by each carrier, including employee and dependent name, address, date of birth, SSN and gender. Pre-populating the enrollment forms is a significant time saver for the customer and/or CSR who fills-in the forms.

Once the medical or any other enrollment information has been gathered, the customer can press the “Complete” button on the workflow page of enrollment application. Pressing this button initiates two steps including the step of checking all information to ensure no required fields are missing and if all required information has been completed then the policy status is set to “Pending.” A CSR who monitors the account then knows to complete the enrollment process.

In another preferred embodiment, the coverages more closely resembles the quoting format. In a different preferred embodiment the coverage information is divided among the enrollment wizard application pages. This can make it difficult to get a quick overview of the policy coverage. The preferred embodiment starts with a list of active policies. This list contains an item for each active policy, including the policy name, the effective coverage dates, the policy status and a button to review the coverage details. The coverage detail page displays the company information at the top of the page, followed by a section on the employer's contributions. The employer's contribution section is divided into each elected coverage type, such as medical contributions, dental contributions, etc. The next section displays which employees elected which line of coverage. The list includes the employee names, plan numbers and rates for the various coverage sections.

The enrollment process is customizable in that each of the required carrier data elements can be setup in the system and gathered through the enrollment process. The enrollment process is dynamic in that which ever carrier is selected during the enrollment process, the enrollment screens dynamically change to accommodate the individual carrier requirements. For example, if a customer selects Aetna Conn., then the enrollment process includes all of the customized data elements for Aetna.

When dealing with renewals, the system take a proactive stance. The system prompts a contact with the client 30-45 days in advance of their renewal date. The goal is to make the renewal process as simple as possible. If the client does not respond by canceling their policy, the assumption is that they will continue using the updated rates. Each customer has user preferences defined on how they would like to be contacted for renewal, for example, electronic mail, fax, letter.

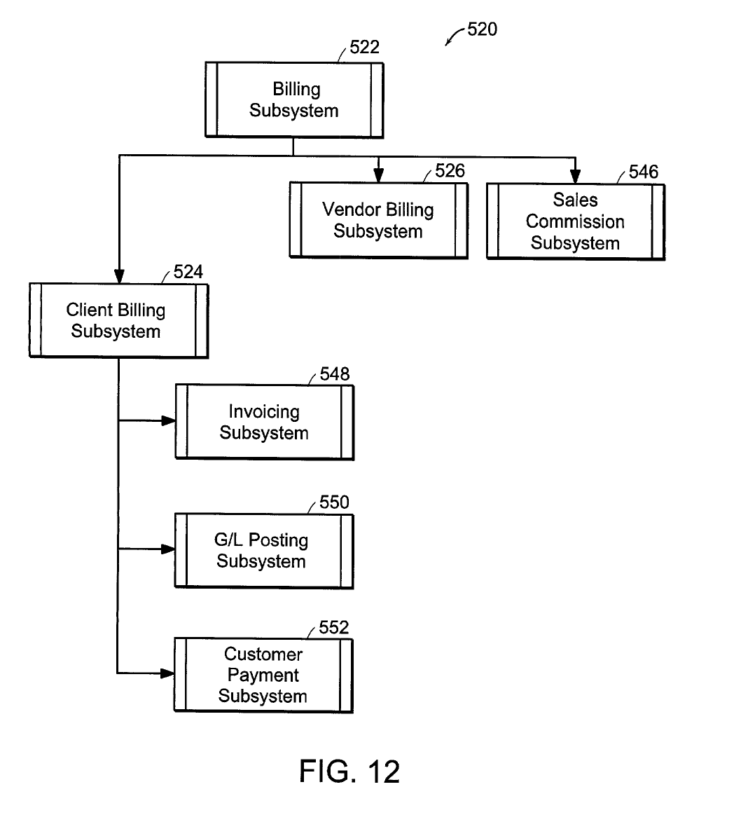

FIG. 12 illustrates a flowchart detailing the process flow for the billing subsystem in accordance with a preferred embodiment of the present invention. The billing system builds a custom invoicing system which performs basic billing functions, including tracking customer invoices, customer payments and carrier remittances. These transactions are recorded in a general ledger which produce a basic balance sheet and profit and loss statement. The basic functionality is to generate basic invoices based on enrolled individuals, post the monthly invoices to a general ledger account, calculate the carrier's remittance at the time of posting and to post the remittance amounts to the carrier's holding account, receive payments against the posted invoices, upon receiving payment, move the carrier's holding to a carrier's liability account, remit the carrier's liability, generate a basic chart of accounts, and generate a basic balance sheet and profit/loss statement based on the transactions listed hereinbefore.

A preferred embodiment of the present invention includes a custom billing application to accommodate the unique needs of any business. The billing system includes a chart of accounts, G/L module and basic Account Receivable (AR) module for tracking customer invoices. The embodiment of the system tracks customer invoices and payments, carrier remittances and basic account adjustments. A Chart of Account is used to keep track of carrier balances. A Profit and Loss (P/L) and Balance Sheet (B/S) are used to keep track of all transactions in the system.

The general process for enrolling a new company in a preferred embodiment includes, the customer service representative creating a new account. The CSR receives the employer's name, address and primary contact. The CSR receives the name of the carrier who the employer wishes to enroll with and the schedule which is used by this carrier. The customer service representative then creates a new policy for the account, for example, type=“medical” and creates a user name and password for the employer. The customer service representative selects the carrier for the policy, and the employer logs on to the system. The employer enters his/her company information, SIC Code, enrollment terms, employer's contribution (a.k.a. “Matching”) levels for each coverage type. The employer enters the employee's name and address and prints out a list of all of the plans available for each employee. The list is given to the employee for him/her to select a plan and a coverage level. The employer gathers the list and enters into the system which plans the employee selected. The employer prints out the enrollment forms for his/her employees and distributes them, the employer reviews, submits the group employee enrollment information.

The following table is a list of the basic enrollment reports for reporting on and tracking the customer service issues and enrollment. These forms can be viewed by typing the report name.

TABLE 2

| Type | Report | Description |
|---|---|---|
| CRM | Customer Service | Summary of CRM activities, such as New |
| | Activity Summary | Enrollments, BORs, grievances, etc. |
| CRM | Customer Service | Detailed report which lists each customer |
| | Activity Details | by Customer Service activity. The reports |
| | | displays the current status and call result. |
| | | NOTE: This report has three variations: |
| | | 1.) All Items in the customer activity |
| | | list |
| | | 2.) Only open items in the customer |
| | | activity list |
| | | 3.) Only closed (inactive) items in |
| | | the customer activity list. |
| CRM | CRM carrier | This report displays a summary of all the |
| | Enrollment Summary | enrolled groups, including the total |
| | | number of enrollees and the average |
| | | enrollee size. |
| CRM | CRM carrier | This report displays the details of all the |
| | Enrollment Details | enrolled groups sorted by carrier. |
| | | including the group address, policy and |
| | | enrolled type |
| | Pre-Enrollment | Displays all of the accounts in the system |
| | Summary | which are not currently active. The |
| | | policy status is also included on the |
| | | report. |
| | Enrolled Group | This reports give a summary of all of the |
| | Summary | active groups enrolled in the system. |
| | Enrolled Employee | This reports give a summary of all of the |
| | Summary | active employees enrolled in the system. |
| | Enrollment Change | Report which is sent to the employer |
| | Report | indicating any changes to enrollment, |
| | | including Company, Employees and/or |
| | | dependents. |
| | Enrollment Change | Summary report which lists how many |
| | Tracking | adds/edits/deletes occurred within |

The general processing on renewing an existing plan includes approximately 30-45 days before renewal, the client is sent a reminder of renewal. The reminder includes the new renewal rates (based on their current enrollment), and information on all other policies plans with rates and contract levels (low/med/high). A copy of the contract can be sent in a preferred embodiment.

The general steps for changing the coverage type includes the employer selecting the employee whose coverage has changed, and the employer selecting the new coverage type. For example, the employee may change from an individual policy to a family policy. The reason for the change is selected and the effective date of the change is entered. The Policy Holder table (and/or Monthly Billing Profile table) is updated with the new information. When the enrollment information is changed, the following rules are likely to affect billing: changing the carrier plan, this can affect the cost, changing the contract type (family versus individual), adding or removing employees can affect the billing, if their plan is based on employee counts and adding or removing dependents do not affect billing.

Some examples of typical enrollment changes are listed below, as are the items that appear on the client's bill. Changes in enrollment affect monthly billing.

TABLE 3

| | Coverage | | Effective | |
|---|---|---|---|---|
| Person ID | Type | Status | Date | Month |
| John Smith | Family | Add | 01/01/01 | JAN. 01 |
| Mary Jones | Individual | Add | 01/01/01 | JAN. 01 |
| John Smith | Individual | Change | 01/01/01 | FEB. 01 |
| Mary Jones | Individual | — | | FEB. 01 |
| John Smith | Individual | — | | MAR. 01 |
| Mary Jones | Individual | Delete | 02/01/01 | MAR. 01 |
| John Smith | Individual | — | | APR. 01 |

In a preferred embodiment, in order to change the coverage type for an employee the following are required: qualifying event code (provided by individual carriers), qualifying event reason (same as above), and effective date (note the effective date must equal the qualifying event date).

The following are examples of coverage type changes. In a first example, Bob has been married for two months. He goes to employer and asks to have his wife added to his policy. Because the carrier has a 30 day retroactive rule, he is not be able to add her until the next open enrollment. In example two, before the open enrollment, Bob's wife give birth to a new baby boy. Because the birth of his son qualifies as a Qualifying event, he is able to change his coverage type. At this time, he can add his wife and his child to the policy effective as of the child's birth. In example three, Bob has never had coverage from his employer since he has always been covered under his wife's policy. However, his wife looses her job. Bob can now ask his employer to change his coverage type. He and his wife (and family if present) can be added to plan. The effective coverage would begin at the point when his wife's date of coverage loss. In example four, the company is growing leaps and bounds and adds 10 new employees within the year. The employer's base rate of coverage would not change. However at renewal, the system calculates a new base rate for the company based on the current employee count. In scenario five, Bob's employer knows that one of his employee's will be terminating in two months. He goes into the system and enters a future end date. The system continues to bill Bob for his employee's coverage until the future month is reached.

Some of the business rules that apply for enrollment changes include qualifying event codes are only applied to adds, not deletes, check if the change date falls within the carriers accepted retroactive period, adjust billing if change falls within previous billing period, no billing adjustments need to be made for families who add or delete dependents unless the coverage type changes, and if a change does not fall within the qualifying event date (or reason) then the employee must wait until the next open enrollment period. This is typically once per year and falls on the Employer's renewal date. Note births and deaths are typical qualifying events. Each time a new invoice line item is created, the policy rate needs to be looked up, since the carrier rates can change. In order to terminate coverage in accordance with a preferred embodiment, an employee requires a termination code (provided by individual carriers), termination reason, and termination date. The applicable business rules include checking if the termination date falls within the carriers accepted retroactive period.

The billing subsystem process flow 520 may be called to automatically enter the employer/employee information. The billing subsystem 522 includes a client billing subsystem 524, a vendor billing subsystem per step 526 and a sales commission subsystem 546. The client billing subsystem 524 includes the invoicing subsystem 548 which is responsible for generating customer bills. These bills are generated based on information in a table described hereinafter called ENR_PolicyHistory. The client billing subsystem 524 also includes the general ledger posting subsystem 550. This subsystem 550 includes the process of copying all invoices to the general ledger (G/L). The G/L is associated with the table BIL_GenLedger described hereinafter. The client billing subsystem 524 further includes the customer payment subsystem 552. This subsystem 552 is responsible for tracking those invoices that are paid in full or partially paid by the customer. In a preferred embodiment, a system credit liability account is used to track customer credits, which can result from overpayment of invoices, or sending in checks before invoices are submitted to a customer.

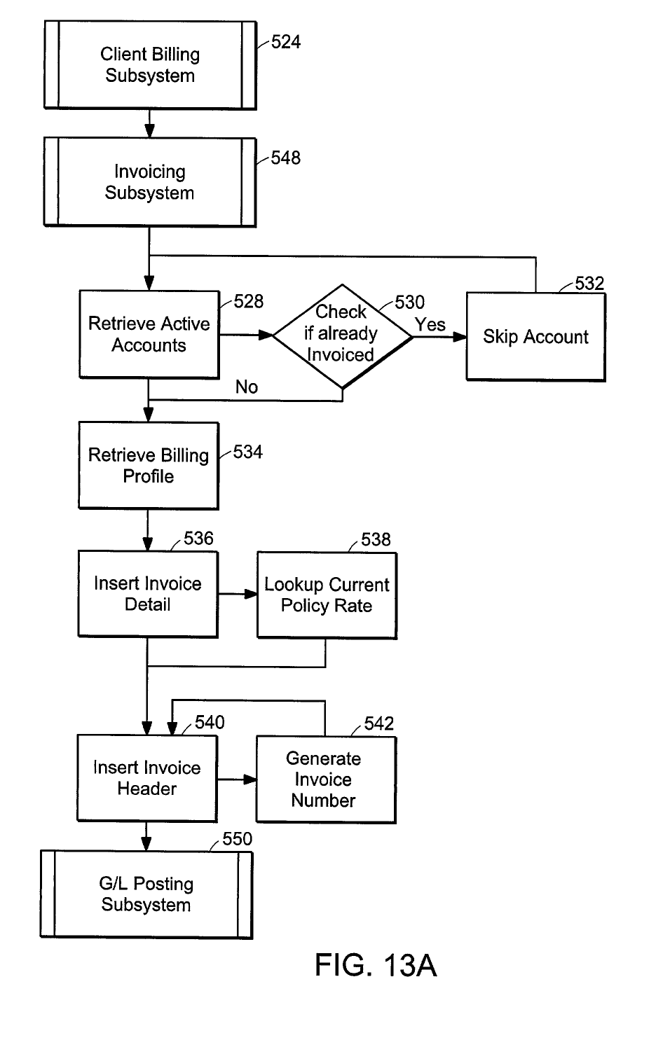

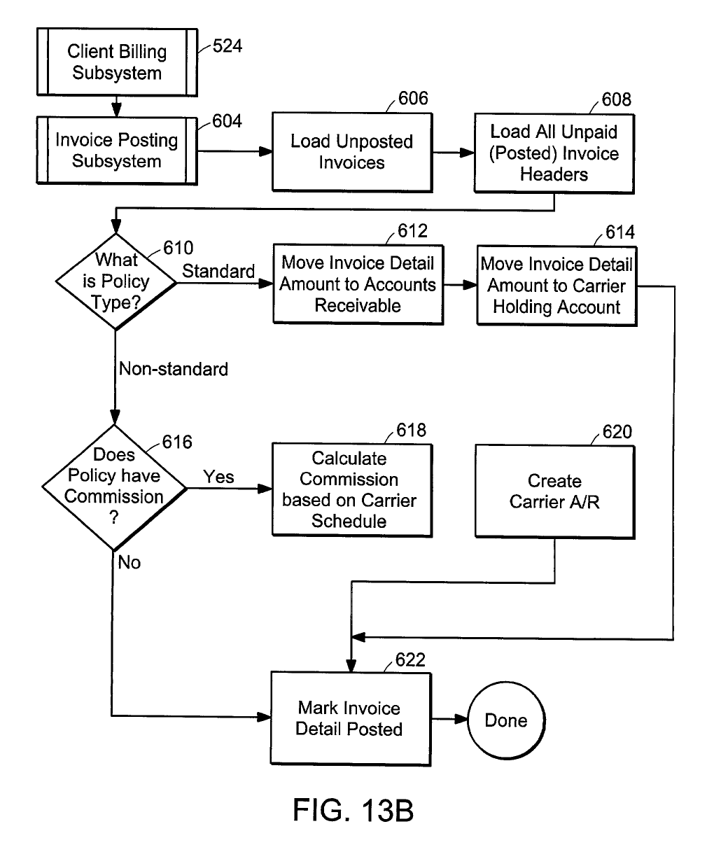

FIG. 13A illustrates the flowchart detailing the process flow for the invoicing subsystem 548 included in the client billing subsystem which is included in a billing subsystem in accordance with the present invention. For a client invoicing process in accordance to a preferred embodiment, the process includes the step of retrieving active accounts per step 528. Then a determination is made to check if the account has already been invoiced per step 530. If yes, then the account is skipped per step 532. If not then the next step in the process includes retrieving a billing profile per step 534. The process next includes inserting invoice details per step 536. The process then includes the step of looking up the current policy rate (based on invoice date) per step 538. An invoice header is inserted per step 540 and an invoice number is generated per step 542. Invoices are posted to the G/L posting subsystem per step 550.

FIG. 13B illustrates a flowchart detailing the process flow for posting invoices which is included in the billing subsystem in accordance with a preferred embodiment of the present invention. The invoice posting subsystem 604 includes the step 606 of loading unposted invoices. Per step 608 all unpaid but posted invoice headers are loaded. It is then determined per step 610 what policy type forms the subject matter of the invoice. If the policy is a standard policy then per step 612 invoice detail amount is moved to accounts receivable. Further, invoice detail amount is moved to carrier holding account per step 614. The process then culminates in step 622 where the invoice detail is marked as posted.

If however, the policy is a non-standard policy then it is determined if the policy has an associated commission in step 616. If there is no commission then the process concludes at step 622 by marking the invoice detail as posted. If however, a commission is associated with the policy then, the commission is calculated based on a carrier schedule per step 618. A carrier accounts receivable (A/R) matter is then created per step 620, followed by the culmination of the process in step 622.

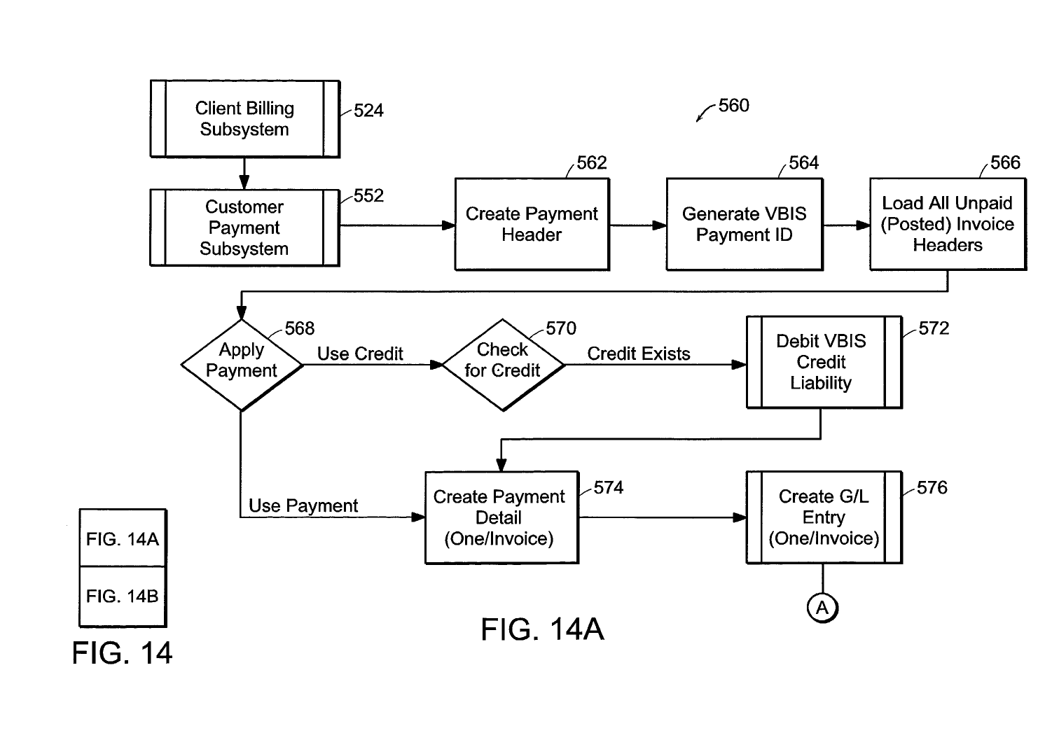

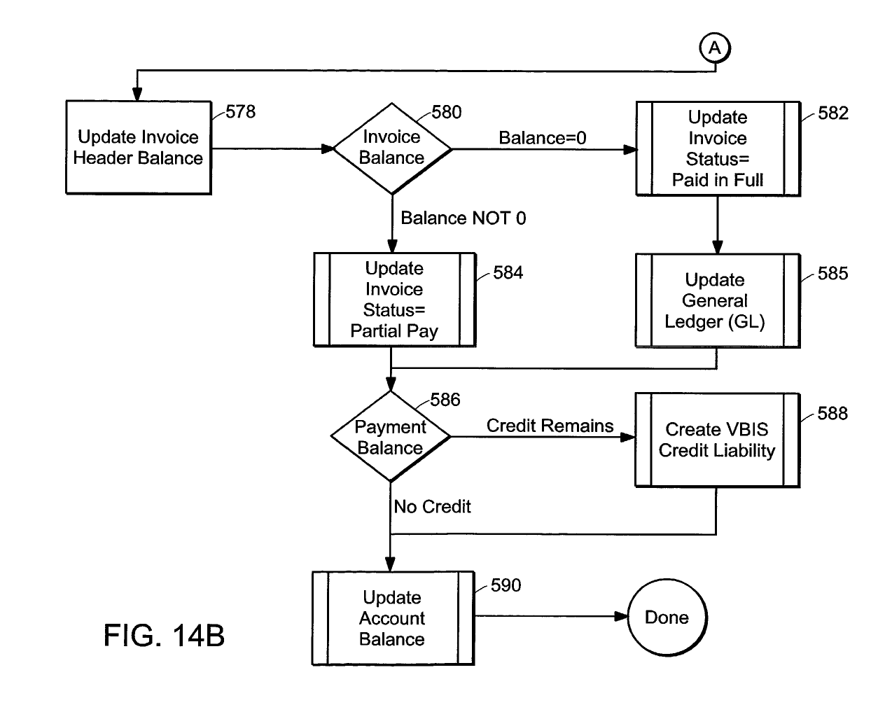

FIG. 14 illustrates a flowchart detailing the process flow for the billing subsystem, in particular the client payment process in accordance with a preferred embodiment of the present invention. The billing subsystem includes a client payment method 560 which includes the step of creating a payment header per step 562. The process then includes generating a system payment identifier (id) per step 564 and loading all unpaid (posted) invoice headers per step 566. The next step includes the determination whether to apply payment per step 568. If credit needs to be used then per step 570 a check for credit is conducted. If credit exists then debit systems credit liability per step 572. If, however, a payment is provided then per step 574 a payment detail such as an invoice is created. Then per step 576 a general ledger (G/L) entry in the invoice is created. The process then includes updating the invoice header balance per step 578. The determination is then made if the invoice is balanced per step 580. If the balance equals zero then the invoice status which equals paid in full is updated per step 582. Per step 585, the general ledger is then updated and the process progresses to step 586 described hereinbelow. If, however, the balance is not zero, then the invoice status which equals partial pay is updated per step 584. It is then determined if the payment is balanced per step 586. If credit remains then a system credit liability is created per step 588. If, however, no credit remains then per step 590, the account balance is updated.

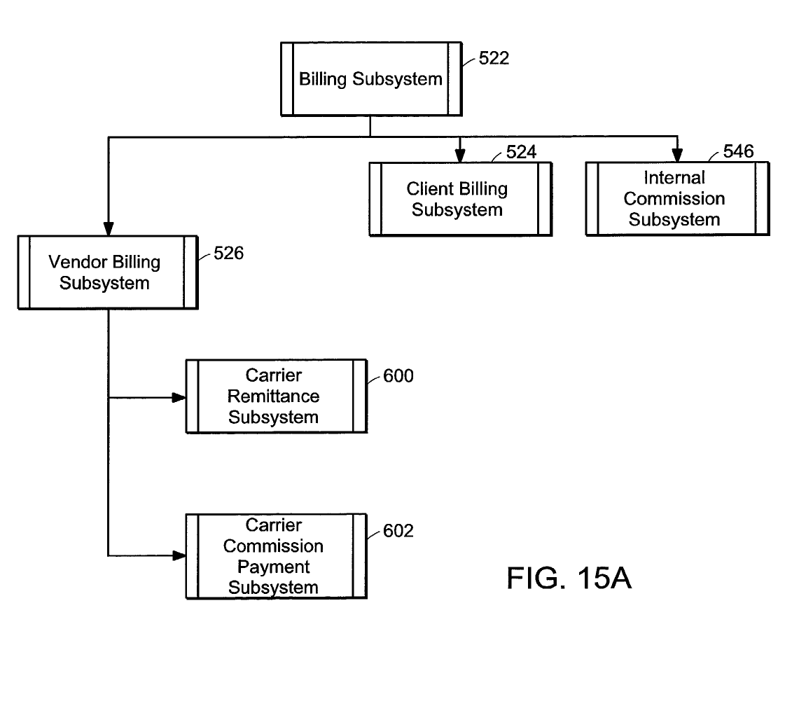

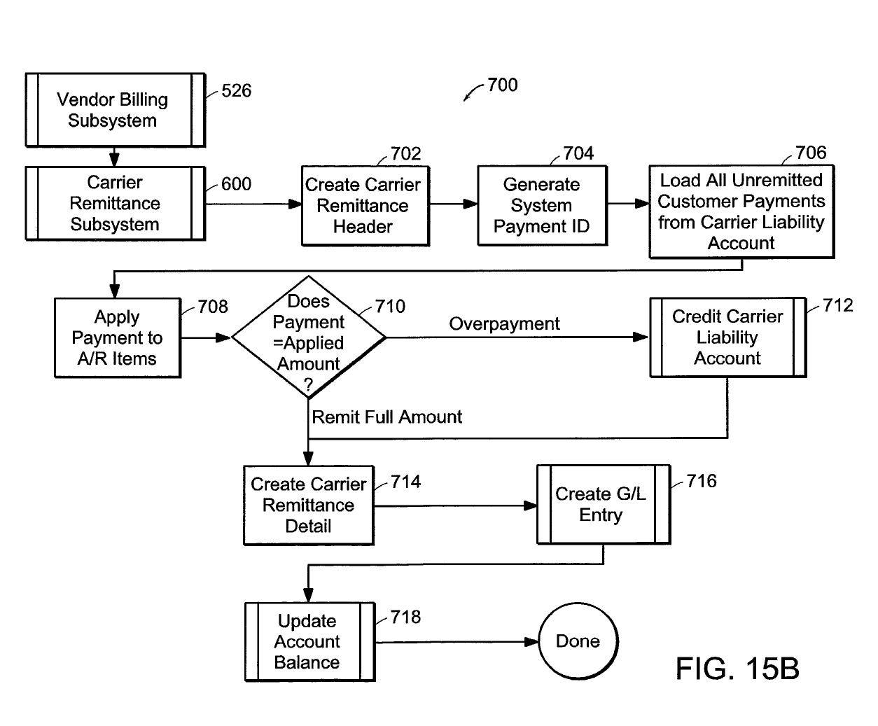

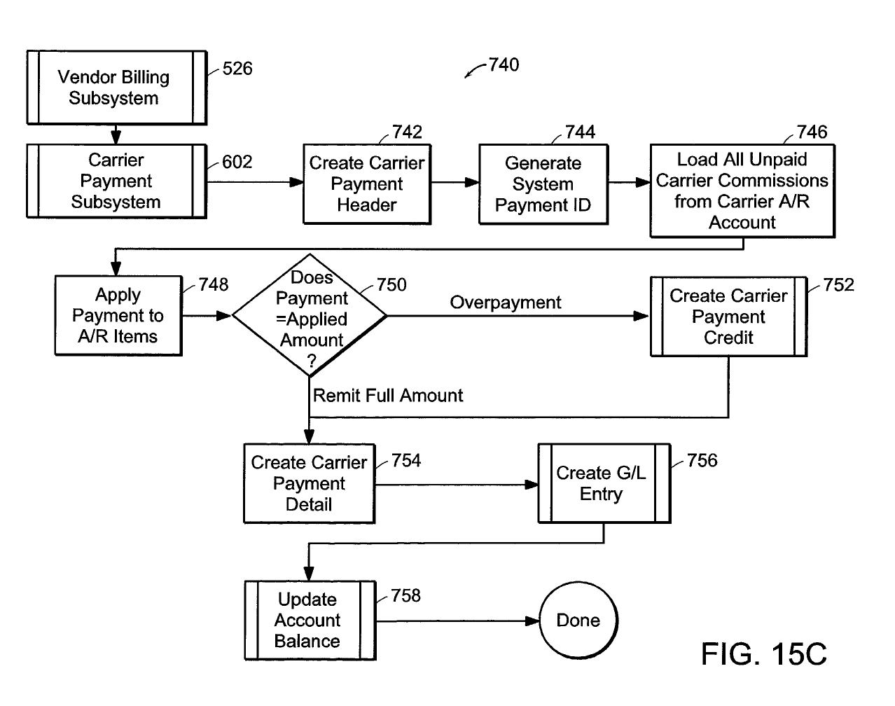

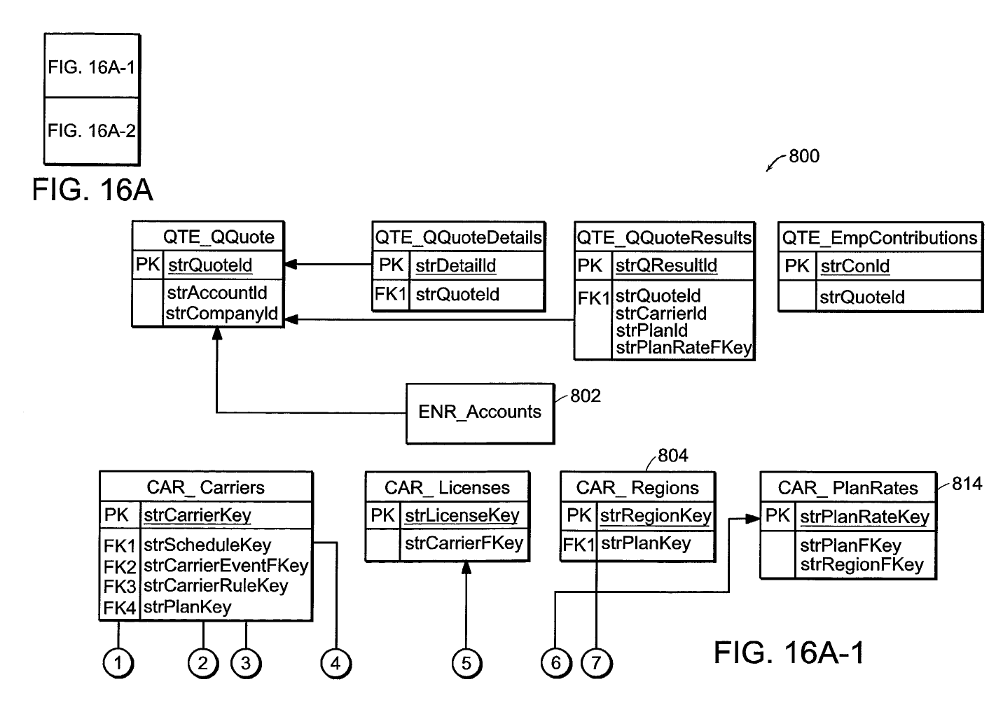

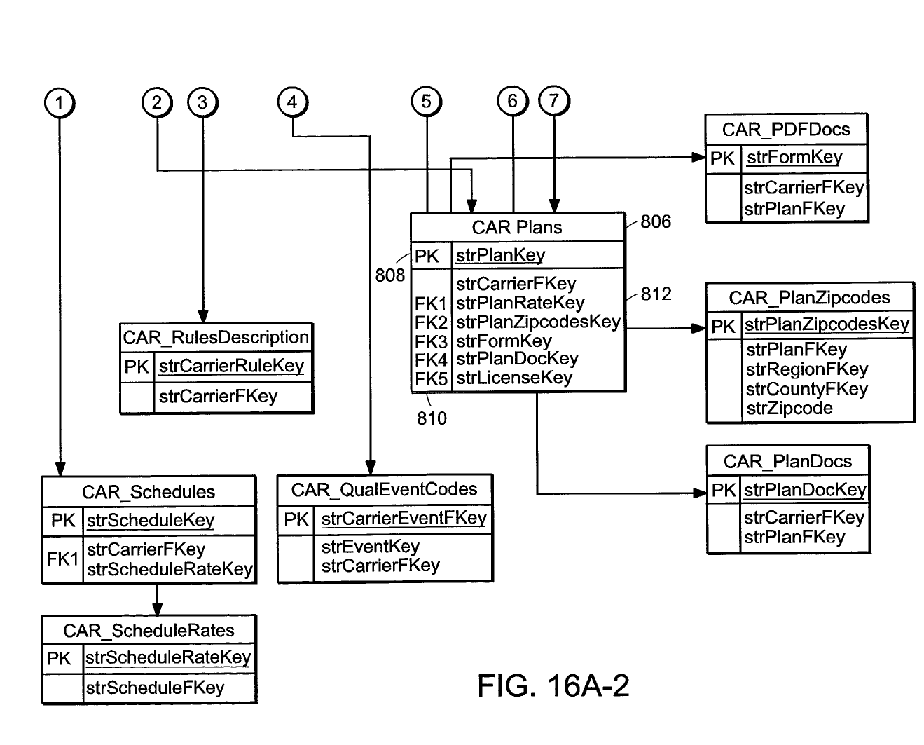

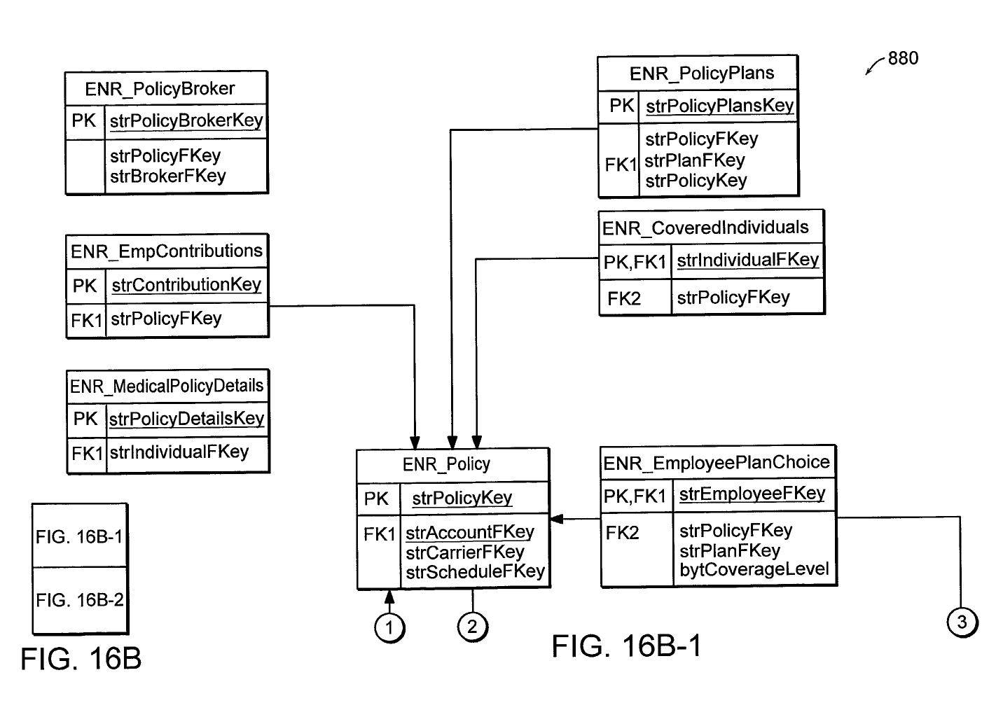

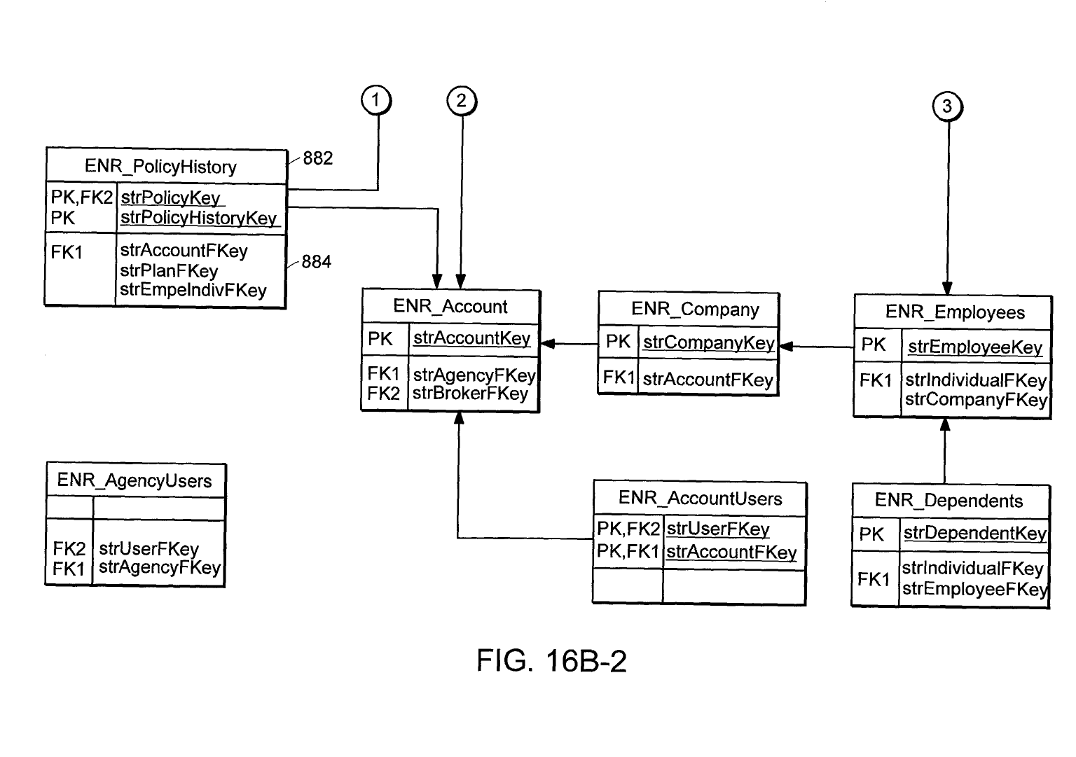

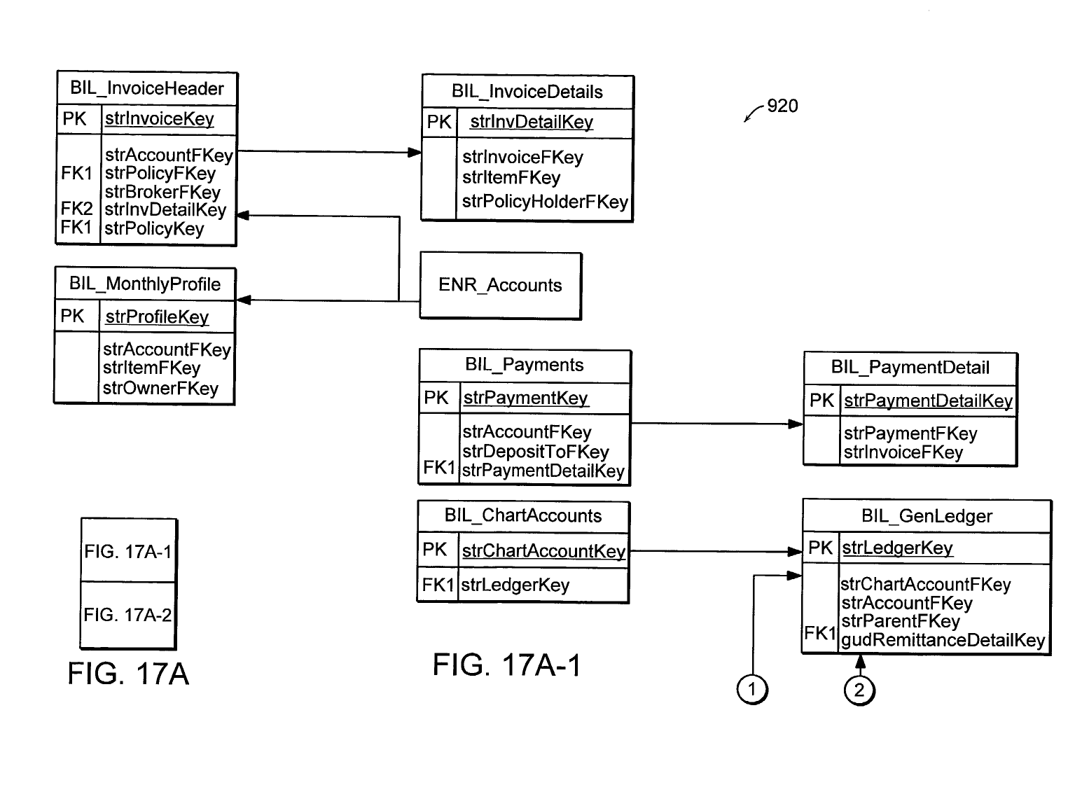

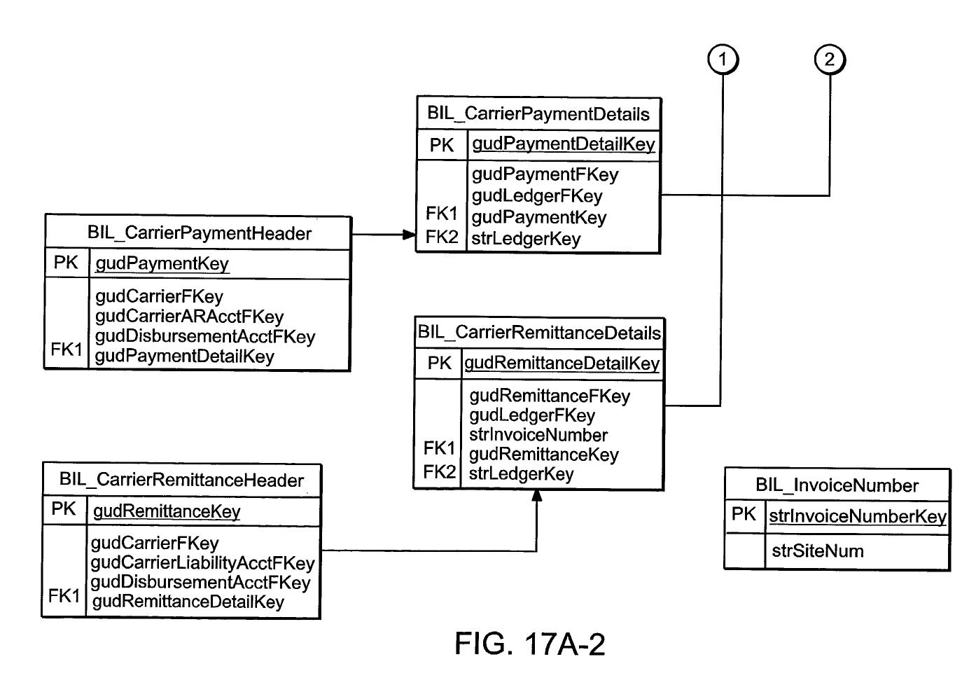

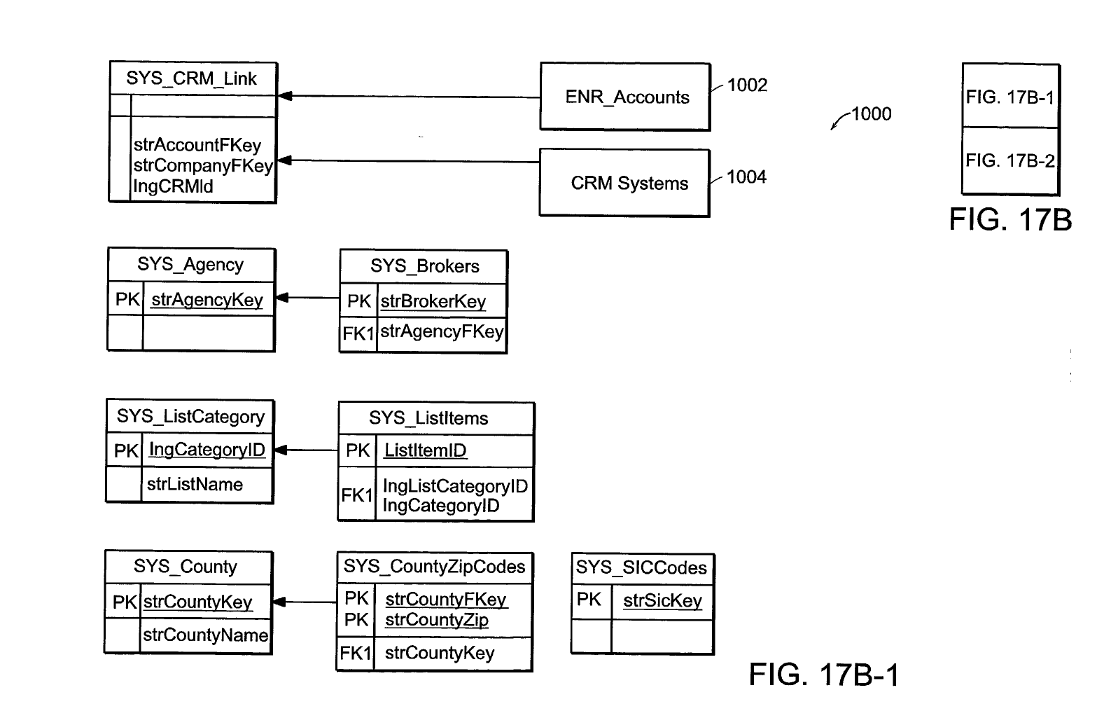

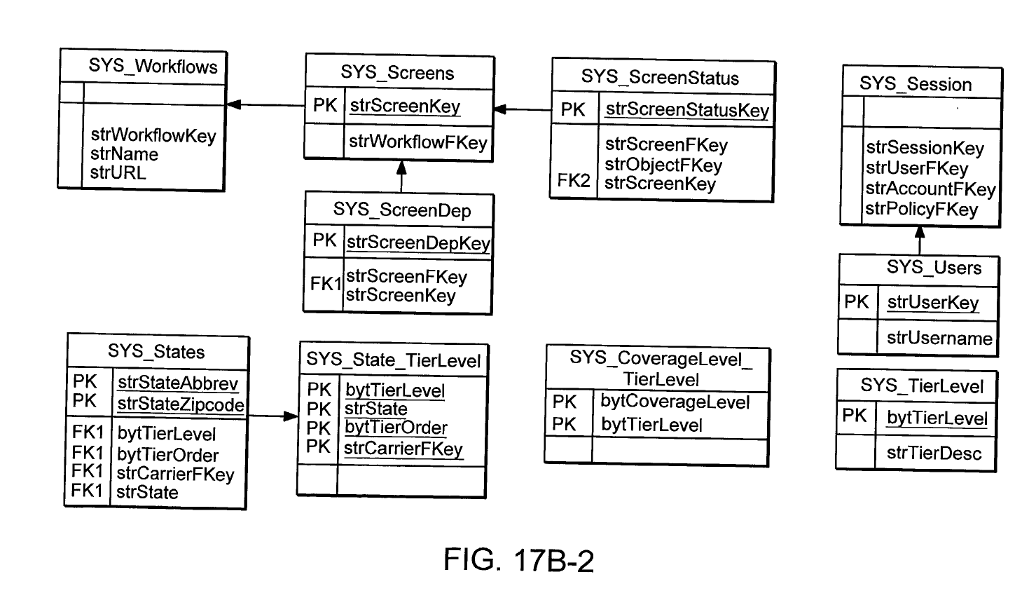

FIG. 15A illustrates a flowchart detailing the process flow for the billing subsystem, in particular the vendor billing subsystem 526 in accordance with a preferred embodiment of the present invention. The vendor billing subsystem 526 is one component of the billing subsystem 522 and includes a carrier remittance subsystem 600 and a carrier commission payment subsystem 602. The carrier remittance subsystem 600 is responsible for tracking all fully paid customer invoices and remitting the correct premium amount back to the carrier. The amount can either be the gross payment or a net payment based on the payment schedule established between the system and the carrier. The information pertaining to this subsystem 600 is stored using tables such as CAR_RemittanceHeader, CAR_RemittanceDetails that are described with respect to FIGS. 16A, 16B, 17A and 17B. The carrier commission payment subsystem is responsible for tracking commissions owed to the system by the carrier for any premium collected from the customer directly. In a preferred embodiment, the commission amount is based on the payment schedule established between the system and the carrier. The data for this subsystem is stored in tables such as, but not limited to, BIL_CarrierPaymentHeader and BIL_CarrierPaymentDetails, described with respect to FIGS. 16A, 16B, 17A and 17B.

The structure for the commission calculation in the system is flexible to accommodate multi-tiered commission based billing and tracking. The method of calculating the premium is based on factors for both the carrier chosen and the Agent who brokers the deal. Each carrier and Agent have associated business rules for determining their commission on the sale. The billing system provides for billing the premium to the employer group, billing a service fee to the employer group on top of the premium bill, billing for late fees (or finance charges), generating payments to the carriers which displays the aggregate totals, generating itemized submission statements to the carriers, and generating itemized payment statements to the agent.

The remittance amount for the carrier is typically either percentage based or flat fee per employee per month (FFEM), however, the system handles flat rate adjustments. Each carrier has a base rate (usually percentage based). This base rate is set for each of the markets the carrier participates in. Note that each carrier is able to setup their own markets. This is done by zip code. Each carrier can have adjustments to their base rates based on premium volumes. The adjustment rate may be based on the specific carrier markets as well. Furthermore, the adjustment rates may be affected by the date of the sale (either per month, per quarter or per year). Normally the volume adjustments are based on carrier markets, however, override adjustments based on total carrier volumes can be made. For example, when a volume across all of a carrier's market reaches a value, adjustments can be made.

Each carrier can have adjustments to their base rates based on premium volumes or employee count for specific employer groups. For example, a carrier can negotiate a deal on commission rates when dealing with a large employer group. When a commission rate changes (either due to volume or employer group parameters), the changes can be retroactive to the start of the year. For multi-region employer groups, a single bill can be generated to the employer group listing each member by group and by market. When making payments to carriers, a sole depository for each carrier market is identified.

In a preferred embodiment agent commission portion (a.k.a. sales person, individual or agency brokers) are considered when calculating commissions on each sale. In the preferred embodiment of the present system, agents can be either system sales people, individual external brokers or external broker agencies. In order to unify the billing process, system sales people are considered a “type” of agent. A manager working as an insurance broker for the system may be an agent and she/he may have individual brokers (“sales people”) working for her/him. Each agent may have a different commission rate per carrier. Agents and individual brokers may have volume steps on premiums. These steps are percentage based, but may be flat fee based as well. Agencies require one check with itemized commissions for individual brokers.

When a prospect accepts a final quote and decides to sign up, what they have accepted is a quote based on their specific employees. The quote is provided in two ways including list-billed (actual per individual) rates and composite rates. A list bill is one in which each employee is billed at the rate specified by the carrier's plan. A composite bill takes the average of all carrier's plan rates for each tier level. The following table is a composite rate sample (individual tier).

TABLE 4

| Person | Carrier A | Selected | Carrier B | Selected |
|---|---|---|---|---|
| Person 1 | $200 | 1 | $200 | |
| Person 2 | $300 | 1 | $500 | |
| Person 3 | $400 | | $800 | 1 |
| Composite Rate | $300/P | 2 | $500/P | 1 |
| Composite Bill Amount | $600 | | $500 | |

Notice that the composite rate is based on the total number of participants. For example for carrier A the composite rate is calculated as:

composite rate (carrier A)=((1 person * $200)+(1 person*$300)+(1 person*$400))/3 People

composite rate (carrier A)=$300 per person

Note: If there were people who chose family over Individual, their total cannot be used to calculate this composite rate. The composite rate is for a specific tier level. The composite rate is based on a hypothetical and the algorithm includes identifying the total number of different tier levels actually selected, for each tier level, identifying the total number of different plans selected, for each tier level, identifying which employees selected that tier level, for each tier level and for each selected plan within that tier level, and calculating the average actually cost as if all employees within that tier level had selected the plan. The employer specifies their contribution policy. There are options for this, for example, the business owner agrees to pay 100% of the composite individual rate and 0% beyond this (i.e., no contribution to the family rate), or the business owner agrees to pay 50% of the composite rate for any plan. The type of group options (tier levels) offered varies by state. For example, Massachusetts uses two groups: individual and family. Other states offer more groups, for example, individual, employee/spouse, employee/one dependent, and employee/two dependent. The employer gets billed on the composite rate based on the actual plans chosen.

There is a possibility that the composite rate does not add up to the individuals. In a preferred embodiment a monthly billing process occurs in order to generate invoices for the client. The process is based on the client's monthly billing profile (MBP) table. This table contains all of the “line items” which appear on the bill. The monthly configuration table consists of the following types of line items, for example, policy items (i.e. carrier plans). For example, each employee's policy is a policy line item. (Item Type=1). Another line item includes carrier items (items which are passed on to the carrier). A carrier may receive a special charge which is charged to the employer. (Item Type=2). Agency items (items which are passed on to an external broker agency) address agency having an additional charge, such as an administration fee, which is charged to the employer. (Item Type=3). System items (items which are passed on to the company) attach additional charges, such as finance or administration charges, to an invoice. (Item Type=4). The monthly billing is based on the current enrollment for each account. Enrollment changes which affect the client invoicing appear in the monthly profile table. At the beginning of each month, the monthly invoicing process views these changes and updates the invoicing accordingly. An invoice number generator generates the invoice number which is built using the following components: Invoice Num=Site ID+MMYY+“−”+Monthly Counter. The counter is reset each month to zero. To maintain the monthly invoice number, a table is created which holds the customer site id, last invoice date and the invoice counter.

An example of how enrollment changes affect monthly billing is described in accordance with the present invention. In the sample configuration table below, Joe's Garage has 5 employees: Patrick Houle, Terry Isaks, Mark Petins, Paul Peters and Bob Jones. Joe's Garage was last invoiced in March 2001. During the month of March, Patrick decided to change his coverage from individual to family, effective February 2001; Mark decided to terminate employment as of Mar. 31, 2001; Paul decided to switch from Aetna to Cigna's plan; and Bob decided that starting in May 2001 he would like to change from Individual to Family coverage. The billing configuration table below represents Joe's Garage's billing situation for April 2001.

TABLE 5

| | | | Start | End | Last | |
|---|---|---|---|---|---|---|
| Plan | Policy Holder | Coverage | Date | Date | Invoiced | Remarks |
| AET01 | Patrick Houle | Individual | September 1998 | February 2001 | March 2001 | Change |
| AET01 | Patrick Houle | Family | February 2001 | — | — | |
| AET01 | Terry Isaks | Family | January 1998 | — | March 2001 | |
| AET01 | Mark Petins | Family | April 1998 | April 2001 | March 2001 | Terminate |
| AET01 | Paul Peters | Individual | April 1998 | February 2001 | March 2001 | Change |
| CIG01 | Paul Peters | Individual | February 2001 | — | — | |
| CIG01 | Bob Jones | Individual | May 1998 | May 2001 | March 2001 | Future |
| CIG01 | Bob Jones | Family | May 2001 | — | — | Change |

the resulting invoice is:

TABLE 6

| | Policy | | | |
|---|---|---|---|---|
| Plan | Holder | Coverage | Description | Rate |
| AET01 | Patrick | Individual | Reversed Medical Coverage | ($235) |
| | Houle | | for February 2001 | |
| AET01 | Patrick | Family | Medical Coverage for | $435 |
| | Houle | | February 2001 | |
| AET01 | Patrick | Individual | Reversed Medical Coverage | ($235) |
| | Houle | | for March 2001 | |
| AET01 | Patrick | Family | Medical Coverage for March | $435 |
| | Houle | | 2001 | |
| AET01 | Patrick | Family | Medical Coverage for April | $435 |
| | Houle | | 2001 | |
| AET01 | Terry | Family | Medical Coverage for April | $435 |
| | Isaks | | 2001 | |
| AET01 | Paul | Individual | Reversed Medical Coverage | ($256) |
| | Peters | | for February 2001 | |
| CIG01 | Paul | Individual | Medical Coverage for | $242 |
| | Peters | | February 2001 | |
| AET01 | Paul | Individual | Reversed Medical Coverage | ($256) |
| | Peters | | for March 2001 | |
| CIG01 | Paul | Individual | Medical Coverage for March | $242 |
| | Peters | | 2001 | |
| CIG01 | Paul | Individual | Medical Coverage for April | $242 |
| | Peters | | 2001 | |
| CIG01 | Bob | Individual | Medical Coverage for April | $242 |
| | Jones | | 2001 | |

Note that Mark does not show up on the invoice because he was terminated during the last month that was invoiced.

TABLE 7

| | | | | | | |
|---|---|---|---|---|---|---|
| | | | Start | End | Last | |
| Plan | Policy Holder | Coverage | Date | Date | Invoiced | Remarks |

| | | | | | |
|---|---|---|---|---|---|
| AET01 | Patrick Houle | Family | February 2001 | — | April 2001 |
| AET01 | Terry Isaks | Family | April 1998 | — | April 2001 |
| CIG01 | Paul Peters | Individual | February 2001 | — | April 2001 |
| CIG01 | Bob Jones | Family | May 2001 | — | April 2001 |

The resulting invoice is:

TABLE 8

| | Policy | | | |
|---|---|---|---|---|
| Plan | Holder | Coverage | Description | Rate |
| AET01 | Patrick | Family | Medical Coverage for May | $435 |
| | Houle | | 2001 | |
| AET01 | Terry | Family | Medical Coverage for May | $435 |
| | Isaks | | 2001 | |
| CIG01 | Paul | Individual | Medical Coverage for May | $234 |
| | Peters | | 2001 | |
| CIG01 | Bob | Family | Medical Coverage for May | $455 |
| | Jones | | 2001 | |

Once the invoices have been created via the “Generate Monthly Invoice Step” they can be previewed and finally posted. The posting process copies the invoice totals to the G/L table and updates all necessary account balances. This step can be considered the final “quality check” before the bills are sent to the customer. Once an invoice is posted to the G/L account it can be changed only through reverse entries to the system.

In the course of business, carrier's may adjust their rates and ask to have the rates retroactively applied to customer accounts. The following outlines how this example works in accordance with a preferred embodiment. Any carrier adjustments occur after the monthly billing cycle, i.e. once the monthly billing is completed. This cycle also uses the monthly configuration profile to determine how to apply the rate changes. All rate changes are handled by reverse entry line items. For example, Joe's employees have policies from Aetna and Cigna. In May 2001, Cigna notified the integrated system 10 that their rates changed and that this change is effective as of February 2001. In March 2001, one of Joe's employees, Terry, left the company. However, according to this change, Joe still needs to pay the rate change for the months of February and March.

TABLE 9

| | | | Start | End | Last | |
|---|---|---|---|---|---|---|
| Plan | Policy Holder | Coverage | Date | Date | Invoiced | Remarks |
| AET01 | Patrick Houle | Family | February 2001 | — | May 2001 | |
| AET01 | Mark Petins | Family | April 1998 | — | May 2001 | |
| AET01 | Terry Isaks | Family | January 1998 | March 2001 | March 2001 | Currently |
| | | | | | | Inactive |
| CIG01 | Bob Jones | Individual | February 2001 | April 2001 | April 2001 | |
| CIG01 | Bob Jones | Family | April 2001 | — | May 2001 | |

TABLE 10

| | Policy | | | |
|---|---|---|---|---|
| Plan | Holder | Coverage | Description | Rate |
| AET01 | Patrick | Family | Medical Coverage for May | $435 |
| | Houle | | 2001 | |
| AET01 | Mark | Family | Medical Coverage for May | $435 |
| | Petins | | 2001 | |
| CIG01 | Terry | Family | Reversed Medical Coverage | ($455) |
| | Isaks | | for February 2001 | |
| CIG01 | Terry | Family | New Rate Medical Coverage | $475 |
| | Isaks | | for February 2001 | |
| CIG01 | Terry | Family | Reversed Medical Coverage | ($455) |
| | Isaks | | for March 2001 | |
| CIG01 | Terry | Family | New Rate Medical Coverage | $475 |
| | Isaks | | for March 2001 | |
| CIG01 | Bob | Family | Reversed Medical Coverage | ($455) |
| | Jones | | for February 2001 | |
| CIG01 | Bob | Family | New Rate Medical Coverage | $475 |
| | Jones | | for February 2001 | |
| CIG01 | Bob | Family | Reversed Medical Coverage | ($455) |
| | Jones | | for March 2001 | |
| CIG01 | Bob | Family | New Rate Medical Coverage | $475 |
| | Jones | | for March 2001 | |
| CIG01 | Bob | Family | Reversed Medical Coverage | ($455) |
| | Jones | | for April 2001 | |
| CIG01 | Bob | Family | New Rate Medical Coverage | $475 |
| | Jones | | for April 2001 | |
| CIG01 | Bob | Family | Medical Coverage | $475 |
| | Jones | | for May 2001 | |

When a payment is received from a client, several steps are followed as detailed in the subsequent table.

TABLE 11

| | |
|---|---|
| Payment Arrives | A system staff member receives a check in the mail |
| Find Client | Search for the client in the system and display all |
| | open invoices. |
| Apply Payment | Apply the payment to one or more invoices. |
| Complete | If the payment amount exactly matches the outstanding |
| Payment | invoice(s), then apply the entire amount and mark the |
| | invoice(s) closed. |
| Partial Payment | If the payment amount does not match the outstanding |
| | invoice(s), then apply the received amount to the |
| | invoice and mark the invoice “partially paid.” |
| Overpayment | If the client overpays, then need to issue the client |
| | a credit. (Need to determine the process for handling |
| | this occurrence) |

An exemplary bill payment in accordance with a preferred embodiment is illustrated hereinafter.

TABLE 12

| Plan | Carrier | Rate | Payment Received |
|---|---|---|---|
| Employee Plan 100 | Carrier A | $250 | $250 |
| Employee Plan 200 | Carrier B | $100 | — |
| Employee Plan 110 | Carrier A | $300 | $300 |
| | Invoice Total | $650 | |
| | Received | | $550 |

In this example, the entire payment is held until the invoice is paid in full, even though carrier A received his entire payment amount.

The following steps take place when a payment is applied and include, the user selecting a customer to apply a payment against, the user selecting a deposit account to place the payment in, the user is presented with a list of all invoices that are not marked as paid in full, and the user selecting invoices from the list and specifying amounts to apply to each invoice (apply-amounts). The user is given the option to apply any account credits with this payment. If the payment amount is greater than or equal to the apply-amounts, then the credit is not be used, the payment amount plus credits (if applicable) can be greater than or equal to the total of the apply-amounts or an error occurs. The process for payment application also includes the system creating a payment detail entry for each invoice specified. If the payment amount plus credit amount is greater than the total apply-amounts, then a credit is created associated with the current payment and is associated with overpayment. If a credit is created, then the account credit total is updated, if a credit or a portion of a credit is used, then existing credit payment entries associated with the account are updated appropriately. The account credit total is adjusted accordingly for any changes here. Further, the invoice received amount and balance are updated to reflect the payment and possible credit application. If the invoice balance=$0, then the invoice amount from the carrier holding to carrier liability is removed, the invoice is marked as “paid in full.”

If the invoice receive balance >$0 and invoice balance >$0 then the invoice is marked as “partially paid.”

The following example illustrates the stream of events followed when applying a payment. If there are the following 2 invoices

TABLE 13

| Invoice ID | Amount | Received | Balance | Status |
|---|---|---|---|---|
| INV01 | $250 | 0 | $250 | Unpaid |
| INV02 | $200 | 0 | $200 | Unpaid |

Now a payment P1 is received for $500 and is applied to the above invoices as follows:

TABLE 14

| Payment ID | Amount | Invoice ID | Is Credit? |
|---|---|---|---|
| P1 | $250 | INV01 | No |
| P1 | $200 | INV02 | No |
| P1 | $50 | — | Yes |

At this point, 3 payment detail entries are created, one for each invoice that the payment is applied to and one for a credit amount left over from the payment. This overpayment is also recorded in the Account entry for the account associated with the invoice. For another invoice, INV03 as shown below:

TABLE 15

| Invoice ID | Amount | Received | Balance | Status |
|---|---|---|---|---|
| INV01 | $250 | $250 | $0 | Paid in Full |
| INV02 | $200 | $200 | $0 | Paid in Full |
| INV03 | $245 | $0 | $245 | Unpaid |

and a new payment for $245, P2, is applied to that invoice. The user also chooses to apply credit to the in voice. The existing payment detail credit for $50 is deleted, and replaced with a detail for $45 and a detail for a $5 credit. The Account Credit field is updated accordingly to equal $5.

TABLE 16

| Payment ID | Amount | Invoice ID | Is Credit? |
|---|---|---|---|
| P1 | $250 | INV01 | No |
| P1 | $200 | INV02 | No |
| P1 | $45 | INV03 | No |
| P1 | $5 | — | Yes |
| P2 | $245 | INV03 | No |

This leaves the invoices looking like the following:

TABLE 17

| Invoice ID | Amount | Received | Balance | Status |
|---|---|---|---|---|
| INV01 | $250 | $250 | $0 | Paid in Full |
| INV02 | $200 | $200 | $0 | Paid in Full |
| INV03 | $245 | $245 | $0 | Paid in Full |

FIG. 15B illustrates a flowchart 700 detailing the carrier remittance subsystem 600 process flow as part of the vendor billing subsystem in accordance with a preferred embodiment of the present invention. The carrier creates a remittance header per step 702. The system then generates a payment identifier per step 704. All unremitted customer payments from the carrier liability account are then loaded into the identifier per step 706. Payments are then applied to the accounts receivable items in step 708. A determination is then made to ascertain if the payment is equal to the applied amount in step 710. If there is an overpayment then the carrier liability account is credited per step 712. If the full amount is remitted then per step 714 the carrier remittance detail is created. The general ledger entry is created in step 716 followed by updating the account balance in step 718.

FIG. 15C illustrates a flowchart 740 detailing the carrier payment subsystem 602, in particular the process for paying a commission, included in the billing subsystem 15 in accordance with a preferred embodiment of the present invention. The carrier creates a payment header per step 742. A system payment identifier is then created per step 744. The process includes loading all unpaid carrier commissions from the carrier accounts receivable (A/R) account in step 746. The payments are then applied to the A/R items in step 748. It is then determined per step 750 if the payment equals the applied amount. If an overpayment has occurred then per step 752 the carrier payment credit is created and the process continues to step 754. If the remittance is the full amount then in step 754 a carrier payment detail is created. A general ledger entry is then created per step 758 by updating the account balance. It should be noted that carrier commissions are created when an invoice is posted or paid in full during the billing process as described with respect to the posting of invoice process flow. When a carrier commission is created, an A/R note is generated for the carrier. The billing system contains minimum maintenance screens which permit the billing agent to access or change the billing tables that are stored in the system database. In a preferred embodiment, all changes are made through the administrative application. The preferred embodiment includes the ability to change the policy history table, delete an unposted invoice, adjust a customer account, i.e. write-off an invoice line item, edit an unposted invoice, reverse entry an invoice line item, and create a manual invoice.

When the billing agent logs into the CRM system using a user interface in a computer, the user sees a custom menu on the navigation bar: “billing.” Clicking on this menu evokes a custom screen which offers the user the ability to: generate monthly invoices, review invoices, pay invoices, review payments, make adjustments, create remittances, review remittances and to view a balance sheet and profit and loss statement.

The generate monthly invoices screen uses the profile history table to determine which accounts should be billed during the indicated period. In a preferred embodiment of the system, the billing period can be the first of the month. All invoices are created with an invoice date of the first of the month. The generate invoice process follows these steps in order to create invoices: the user selects a month (i.e. invoicing period), active accounts are loaded from the account table, active policies are loaded from the policy table, the invoice table is scanned to be certain an invoice does not exist for the invoicing period, and the policy history table is used to determine which employee's to bill and which plans at what rate to invoice.

Initially, all invoices are created with an unposted status. This allows the billing agent to check the invoice for accuracy before posting it to the general ledger account. Once an invoice is posted, it can only be changed via reverse entries to the general ledger.

The review invoices list contains a list of all of the invoices in the system, included unposted, posted, partially paid and fully paid invoices. This list is displayed once the generate monthly invoices is successfully completed. The review invoices displays the invoice number, client name, invoice amount and invoice status.

Unposted invoices contain a check-box next to the invoice status. The billing agent can post any unposted invoices, by selecting the invoice and pressing the post button.

The pay invoices screen allows the billing agent to pay one or more posted invoices. To pay an invoice, the billing agent selects the system account, fills in the check amount, date received, a reference number (i.e. check number) and a description (optional), and selects a system asset account. At this time, one or more invoices can be paid. In a preferred embodiment, payment must be made against each outstanding invoice. If the payment equals the invoice total, then the invoice is marked paid in full and is not displayed on this screen in the future. If the invoice is partially paid, then the invoice status is set to “partially paid” and is displayed until it is paid in full. If at any time the billing agent does not apply the total payment to one or more invoices, the balance is credited to the customer's account. Credits can be applied to outstanding invoice balances at any time.

In a preferred embodiment the billing system handles simple account transfers using the adjustment screen. This screen enables the billing agent to move money from one account to another. In another preferred embodiment the billing system includes write-offs, reverse entries, overpayment adjustments and underpayment adjustments.

In a preferred embodiment the billing system generates a carrier remittance at the time the invoice is posted or paid in full. The remittance is calculated based on the carrier schedule which is setup for the policy. Once a carrier remittance is generated, the system allows the billing agent to review previous transactions. In another preferred embodiment, the billing agent can change a past payment or make adjustments to the payment, i.e. via a reverse journal entry.

The preferred embodiment provides a basic balance sheet (B/S) and profit and loss (P/L) report. For any account within the B/S or P/L, the details behind the number can be easily viewed by clicking on the chart of account number. The billing system includes a “double-entry” accounting program. The system contains a chart of accounts which keeps track of all accounts in the system. The program contains the following standard accounts in accordance with a preferred embodiment:

TABLE 18

| Chart of Account | Description |
|---|---|
| Accounts Receivables | Account which keeps tracks of outstanding |
| | invoices |
| Premium | Account to track income from monthly |
| Income Account | premium billing charges |
| Finance Charge | Account to track income from finance charges |
| Income Account | |
| Carrier Liability | Each carrier will have a corresponding liability |
| Account | account which keeps track of premium |
| | which need to paid out. |
| Cost of Goods | |
| Account | |
| Sales Person | Each sales person will have a corresponding |
| Commission | liability account which keeps track of |
| Liability Account | commissions which need to paid out. |
| Sales Person Expense | Each sales person will have a corresponding |
| Account | expense account which keeps track of |
| | commissions |
| Retained Earnings | Short term profit account |
| Account | |
| Revenue Account | Company profit account |
| Cash Account | Basic “Savings” account for the company |

In general the billing system further contains the following base tables:

TABLE 19

| System Table | Description |
|---|---|
| Chart of Accounts | Contains all of the accounts listed above |
| Invoice Header | Tracks all of the invoices sent to customer |
| Invoice Detail | Tracks the details of the invoices. |
| Payment Table | Track all payment received from clients |
| Customer Table | Tracks all of the customers in the system. Note: This |
| | table will mostly be called the “Account” table |
| Carrier Table | List of all carriers in the system. Note: This table is |
| | the AR Vendor table. |
| Item Table | Keeps track of all of the items which can appear on an |
| | invoice |
| Transaction Table | Tracks all of the transaction which occur in the billing |
| | system. Note: the Income Statement and Balance |
| | Sheet will be derived from this table. |

The application in a preferred embodiment is a web-based application operable with most of the standard commercially available browsers. The program's instructions are designed using Microsoft's n-tier architecture, utilizing ASP for the client front end, VB COM objects for the business and data tiers and SQL Server for the database system. The preferred embodiments are cross-browser compatible, and scaleable to tens of thousands of simultaneous users per day.

FIGS. 16A and 16B illustrate table diagrams used in the enrollment subsystem for the integrated insurance system in accordance with a preferred embodiment of the present invention. FIGS. 17A and 17B are table diagrams used in the billing subsystem and support subsystems in accordance with preferred embodiments of the present invention.

The system 10 servers store a plurality of databases including tables. Certain terms are used in the database architecture herein have specific definitions. Many of these terms are used generically in the industry to represent certain concepts related to databases. The database is a collection of tables. A table can be a collection of records. Each record is a collection of fields. The preferred embodiments of the present invention use a record structure that allows tracking of particular data through all the subsystems. The relationships between the subsystems are managed by the record structures that provide access to common data. The database can contain any number of tables. In practice, the database contains as a minimum several tables such as the tables described in FIGS. 16A, 16B, 17A and 17B with respect to the quoting subsystem, enrollment subsystem, billing subsystem and support tables. The database structure can be defined as the interrelationships between tables. A function of the server is to collect and assemble data from disparate and existing sources. These sources may consist of files, third-party databases, or even a website. The keys function as pointers to access the data stored in the database. There is a primary key in a table as well as a foreign key (FK) which typically points to another table. The strings (STR) are used as opposed to numbers in the particular fields. These strings are randomly generated, global unique identifiers for each geographic location. During a merging process these strings are easily combined without losing the unique information for each geographic location.

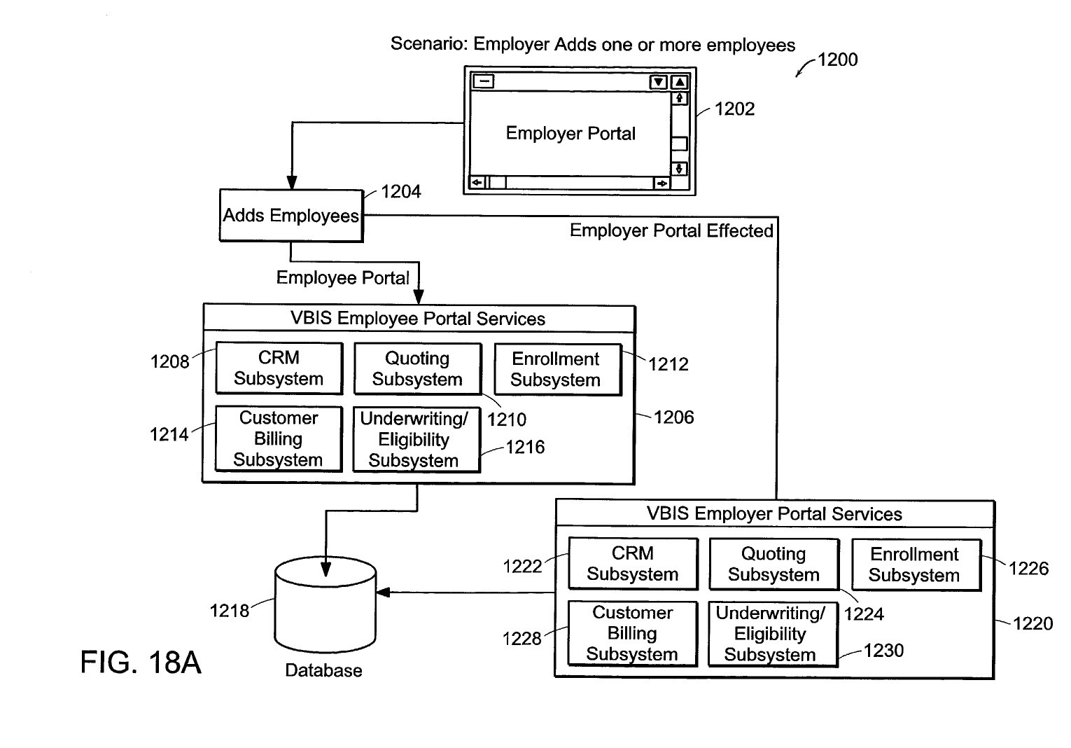

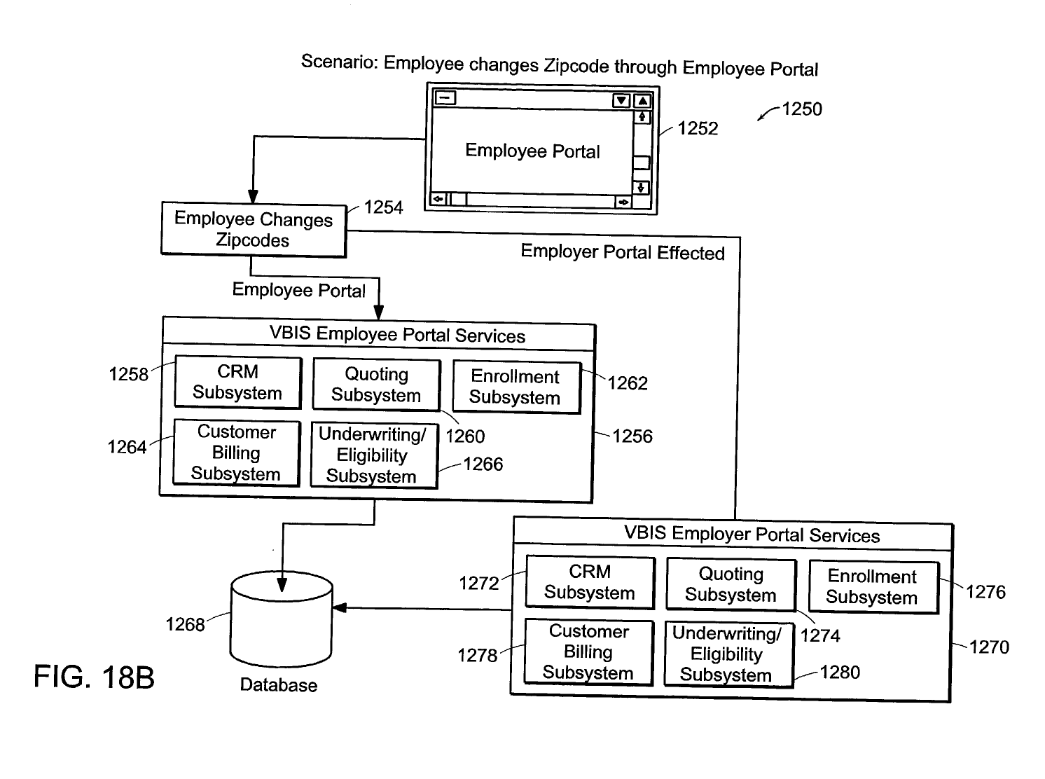

FIGS. 18A-18B illustrate flow diagrams detailing exemplary interactions for the employer portal and the employee portal, respectively, in accordance with a preferred embodiment of the present invention. FIG. 18A illustrates a flowchart 1200 describing exemplary interactions with the employer portal and various subsystems in the integrated insurance systems 10. In this example, if an employer includes additional employees, the employer company may be subjected to new rates based on carrier rules regarding different criteria, for example, number of employees. In this embodiment, the employer receives new rates through the quoting subsystem 1210, and changes to the enrollment 1212 and billing subsystems 1214. The CRM subsystem 1208 may be updated with the revised employee count. For any employee entering the employee portal, the employee can view the new rates quoted or changes to their individual enrollment profile. The database 1218 is accessed by the system portal services to update the enrollment and or billing tables.

FIG. 18B is an exemplary flowchart 1250 describing interactions between the employee portal 1252 and various subsystems in the integrated insurance system 10. If an employee accesses the employee portal 1252 and changes any shared information fields, the actions can result in changes to several subsystems within the employee portal and perhaps those in the employer portal. In both the portals, the CRM subsystems 1258, 1272, quoting subsystems 1260, 1274, enrollment subsystems 1262, 1276, billing subsystems 1264, 1278 and underwriting subsystems 1266, 1280 can be affected. The same effect can occur by changing other shared information such as, for example, social security number, date of birth, marital status and coverage election such as individual versus family coverage.

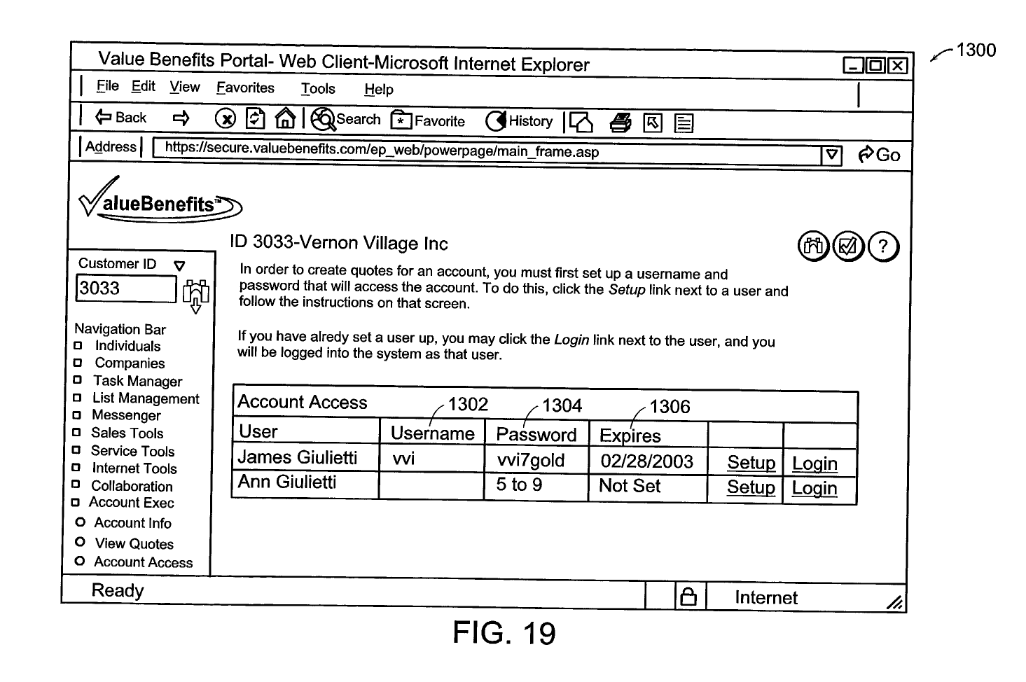

FIG. 19 illustrates a view of a display screen 1300 that a user interfaces with in order to allow an account executive to view which users have access to the system in accordance with a preferred embodiment of the present invention. The CRM system interface in accordance with a preferred embodiment is customized to include functionality which is intended to be used by classes of the system employees who administer the system. These administrative functions include creating new accounts, reviewing invoices and payments and generating customer payments. The custom CRM menu options are available to three classes of system users: account executives (AE), customer service representatives (CSR) and billing agents. In a preferred embodiment, the CRM custom portal can be found at a universal resource located such as https://secure.valuebenefits.com/ep_web/. The CRM system has multiple groups of users, for example, sales, customer services, finance, executives and administrators.

In the CRM system, the account executives have access to at least two functions, for example, viewing a customer account, viewing previous quotes and managing access to the system. The first function provides a simple way for the account executive to preview the customer's basic account information. This screen contains the account name, address and contact information as well as which policies have been setup for the account. The AE cannot make any changes to the information in the system.

The second function includes the ability to view, or edit customer quotes. Additionally, the AE can review existing quotes, edit a quote or delete a customer quote. In a preferred embodiment a quote to an account need not be attached.

In a preferred embodiment, a separate quoting tool is provided for the account executive. This tool is optimized for the AE to generate quotes for the customer which includes medical, dental, term life, short term disability and long term disability. This embodiment of the system is optimized for the account executives to quickly generate quotes. The system is tightly coupled to the account profile information, thus reducing the amount of information they must enter to generate a quote.

The quoting system is revised to determine which lines of coverage need to be quoted, what the employer's contribution is for each elected coverage and which employees select which lines of coverage. Display screens gather information for electronically producing a quote for ancillary lines of coverage. The AE is able to view a history which employees chose which cards.

As illustrated in the user interface display screen 1300, the account access link allows the AE to quickly view which users have access to the system and to manage access to the system. The setup link opens the setup account access screen, which allows a user to change the log in name 1302, password 1304 and password expiration date 1306.

The login link opens a new browser to the employer portal with the AE already logged in. In a preferred embodiment, the AE does not need to set up a username or password to log into the employer portal. The username and password are used by the customer to log in.

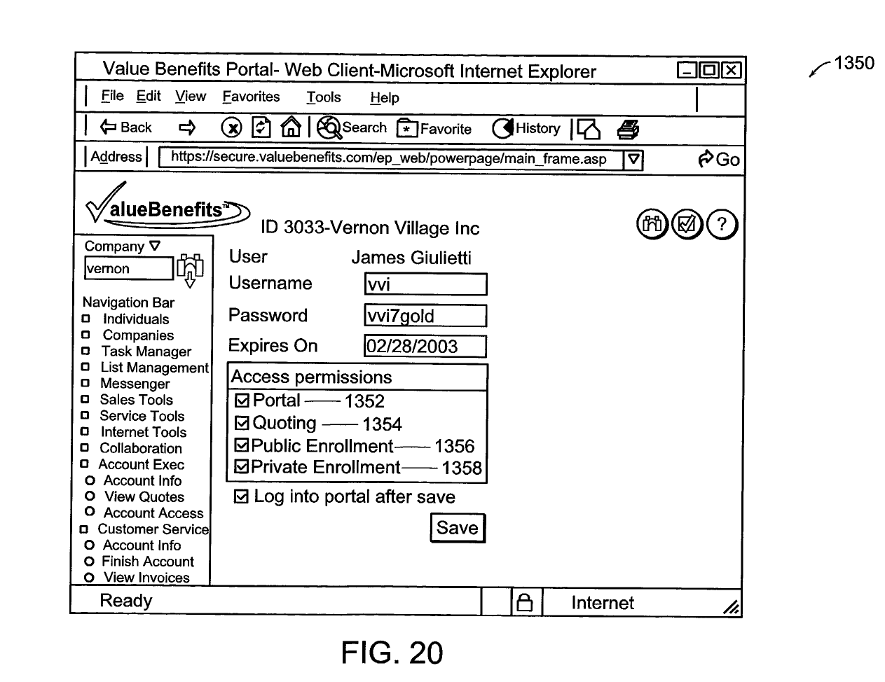

FIG. 20 illustrates a view of a display screen that a user interfaces with in order to log into a portal and set up an account access in accordance with a preferred embodiment of the present invention. In a preferred embodiment, the setup account access screen 1350 is used to manage the user's name, password, expiration date and access permissions. The expiration date is the date the password expires. The access permissions determine what a user can see when they log into the employer portal. Selecting by checking the portal permission 1352 allows the customer to enter the portal. Selecting by checking the quoting permission 1354 allows the customer to view or create quotes in the portal. Checking or selecting the public 1356 and private 1358 enrollment permissions allows the customer to review or enter enrollment information in the portal. If the log into portal save checkbox is selected or checked, then a window opens to the employer portal when the user presses save.

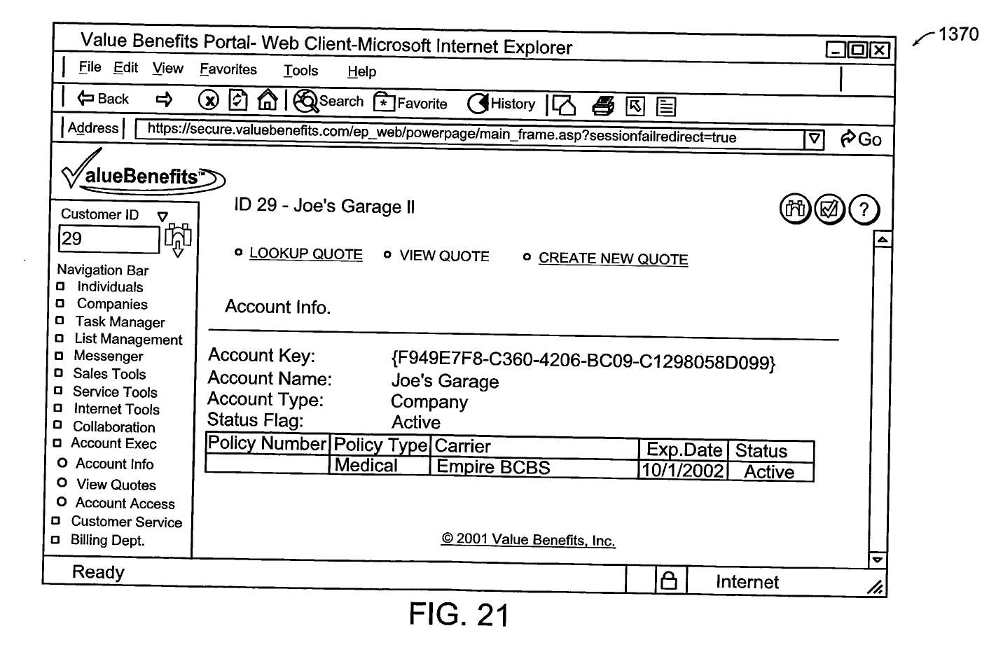

FIG. 21 illustrates a view of a display screen 1370 that a user interfaces with in order to view account information in accordance with a preferred embodiment of the present invention. The account executive can access and view the account information which includes an account key, name, type and status, without limitation.

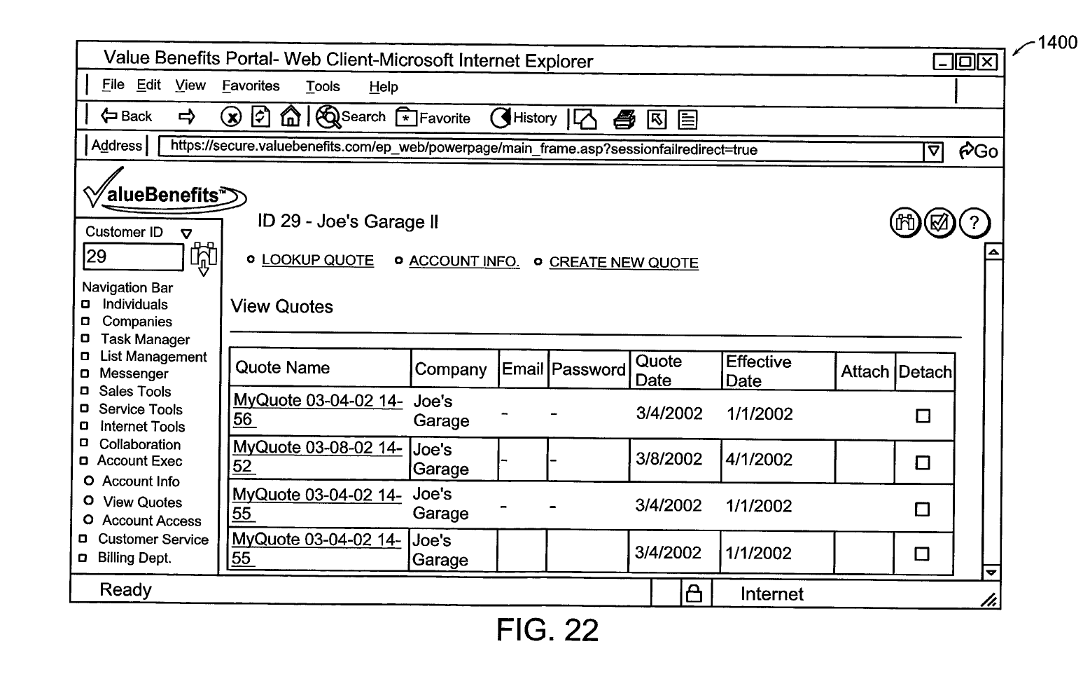

FIG. 22 illustrates a view of a display screen 1400 that a user interfaces with to view quotes in accordance with a preferred embodiment of the present invention. The user in this case is the account executive who can view the quote name, company, quote date and effective date at the very least.

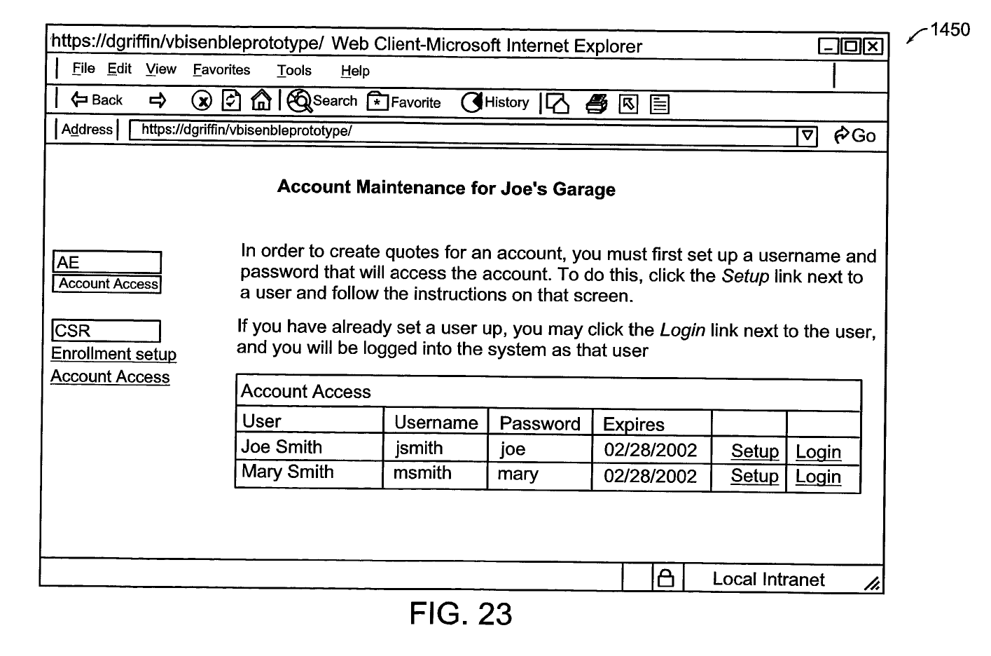

FIG. 23 illustrates a view of a display screen 1450 that a user interfaces with in order to access the account as part of the customer service menu option in accordance with a preferred embodiment of the present invention. This screen is accessed to set up quotes for an account or to post the setup login to the system. Thus the preferred embodiments of the system contain a complete on-line enrollment system. The enrollment system is designed to be used by either an Employer or a Customer Service Representative. The on-line enrollment system gathers all of the information required by the carrier. Either the system administrator or an Employer can review this information on-line. The enrollment information can be relayed back to the carrier in several formats, including comma-delimited, ANSI format or Adobe Acrobat® (PDF) files.

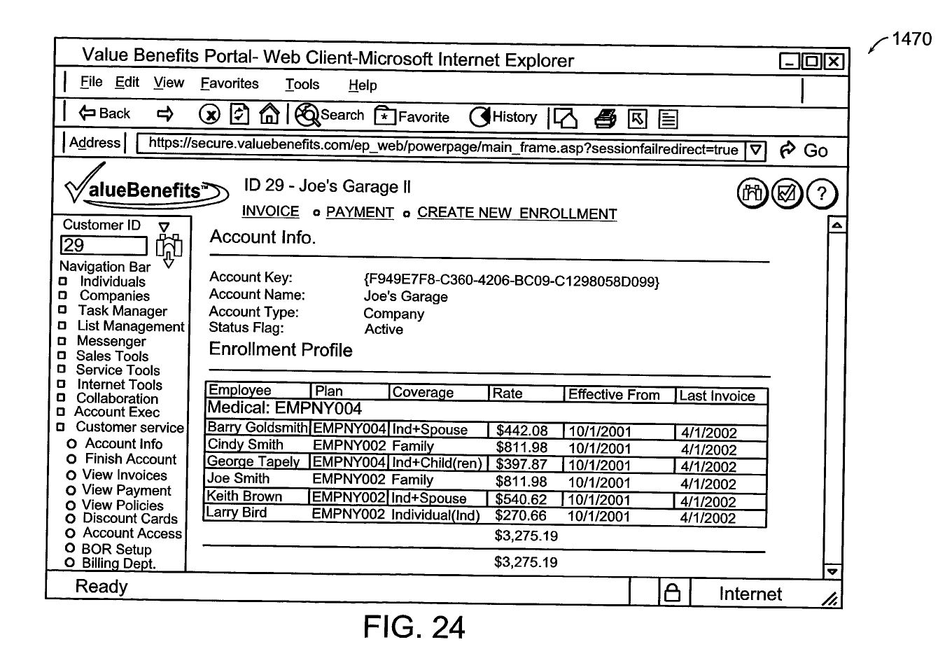

FIG. 24 illustrates a view of a display screen 1470 that a user interfaces with from within the CRM system in order to view the account information and enrollment in accordance with a preferred embodiment of the present invention. The account information provides user specific information. The enrollment profile includes the information for the plans, rates for specific employees of the employer.

FIG. 25 illustrates a view of a display screen 1500 that a user interfaces with in order to view the invoices from within the CRM system in accordance with a preferred embodiment of the present invention. The invoices are listed by invoice number, company, invoice date, amount and status.

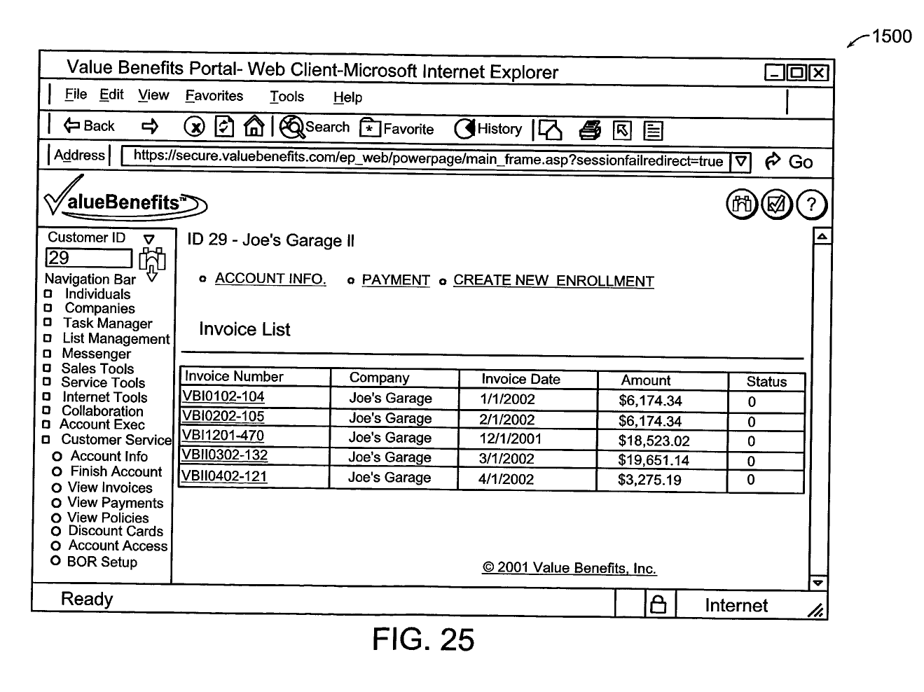

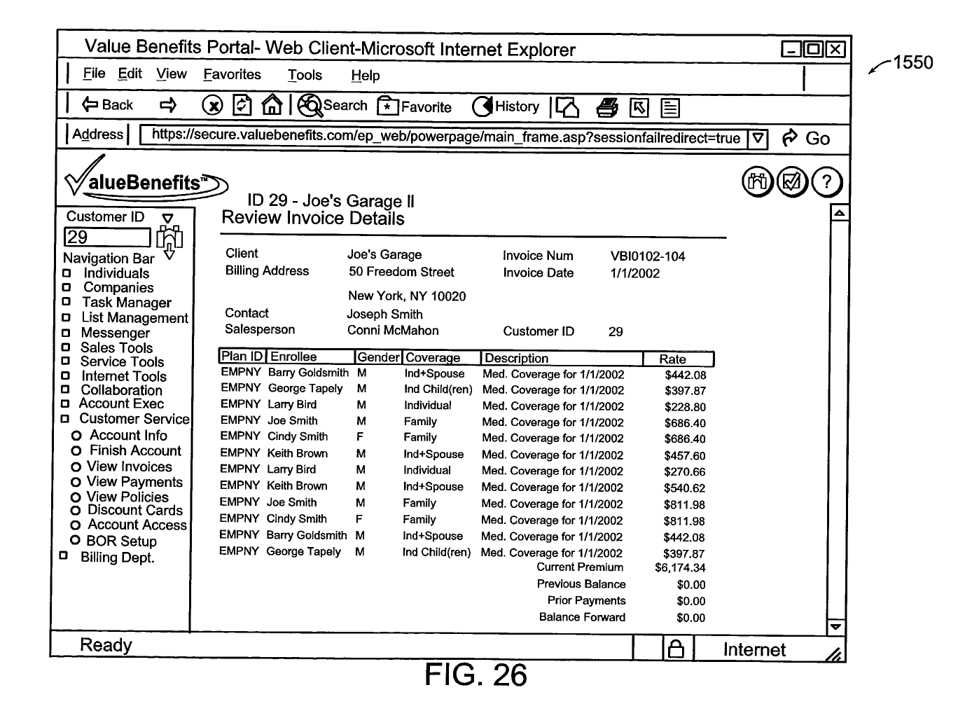

FIG. 26 illustrates a view of a display screen 1550 that a user interfaces with for viewing invoice details from within the CRM system in accordance with a preferred embodiment of the present invention. The invoice details that can be reviewed include information about the employer client and specific information about each of the employee enrollees.

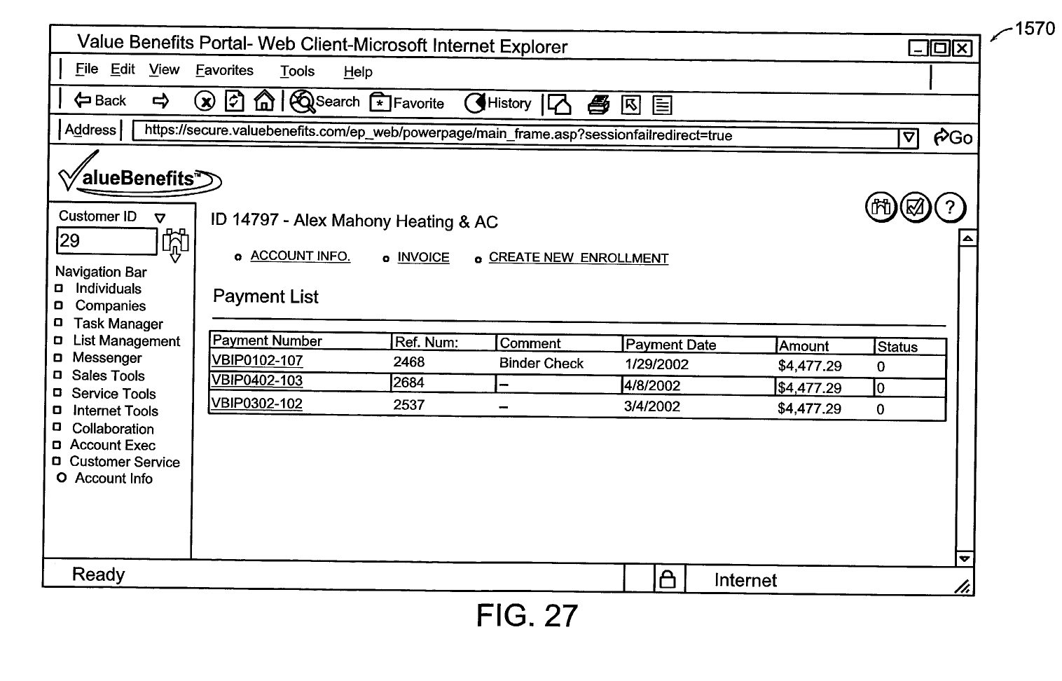

FIG. 27 illustrates a view of a display screen 1570 that a user interfaces with for viewing payments from within the CRM system in accordance with a preferred embodiment of the present invention. The payments are presented in a list format with payment numbers, comments, payment date, amount and status as details.

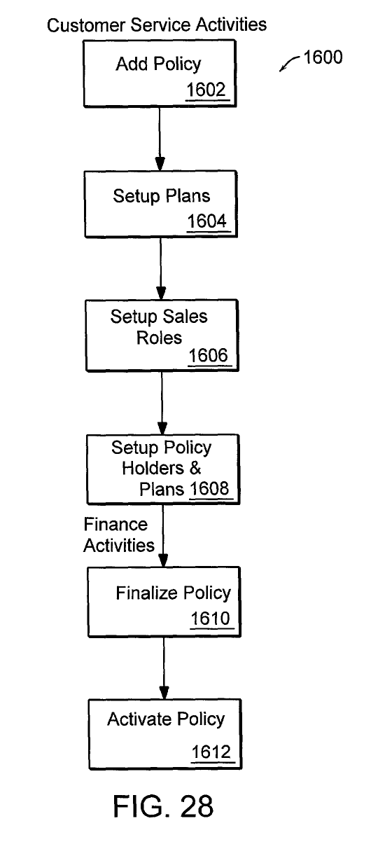

FIG. 28 is a flowchart 1600 detailing the setup of a policy in accordance with a preferred embodiment of the present invention. The customer service activities include adding a policy per step 1602, setting up plans per step 1604, setting up sales roles per step 1606 and setting up policy holders per step 1608 and plans. In step 1602 the user interface actions include selection of type of policy, be it medical, life, dental, home, without limitation, setting effective dates of policy, entering policy name and number, entering a billing address for the policy and selecting a carrier responsible for the policy. The corresponding tables that are sourced for the addition of a policy include ENR_Policy and SYS_Listitems. The user interface actions for the step 1604 for the setup of plans includes selecting one or more plans available for the policy holder to select from. The table links for the setup of plans includes, without limitation, ENR_PolicyPlans, CAR_Plans and SYS_Listitems. The business rules that apply for step 1604 include for the available plans selection based on employer's zip code, policy's effective range (from/to dates) and carrier effective on the policy. For step 1606 the applicable screen actions include selecting one or more sales people and assigning their role in the sales i.e., account executive, manager, vice president. The corresponding table links include, without limitation, ENR_PolicyBroker, SYS_Brokers, and SYS_Listitems.

For step 1608 the screen actions include, but are not limited to, selecting available employees, available plan from setup plans, assigning a coverage level i.e., individual, or family where appropriate, inserting optional information, such as gender or social security number (SSN) and assigning a manual rate if applicable. The corresponding table links include ENR_PolicyHistory, ENR_PolicyPlans, SYS_StateTierLevel, ENR_Employees, CON_Individuals, SYS_Listitems, without limitation.

The step 1608 for setting up policy holders and plans include business rules, for example, policy holders have to be enrolled under the company assigned to the policy, the available plans need to be selected from plan setup items, coverage types have to be selected from carrier coverage types for the area based on, for example, employer zip code, plan rate (non-manual only), have to be selected based on plan chosen, on policy effective dates and on employer's zip code.

The finance activities screen actions for step 1610 of finalizing policy includes setting the commission dates, if appropriate, setting the carrier commission schedule, remittance method and billing method. The corresponding table links include, without limitation, ENR_Policy, CAR_Schedules, and SYS_Listitems.

The screen actions that are associated with the step 1612 to activate policy include, without limitation, setting the billing status to active, which initiates customer billing. The corresponding table link includes, without limitation, ENR_Policy.

FIG. 29 illustrates a view of a display screen 1650 that a user interfaces with in order to view a policy in accordance with a preferred embodiment of the present invention. The view policy(s) screen has a link to allow the customer service representative to select the plans available during enrollment. The plans link 1652 opens the map plans to policy screen.

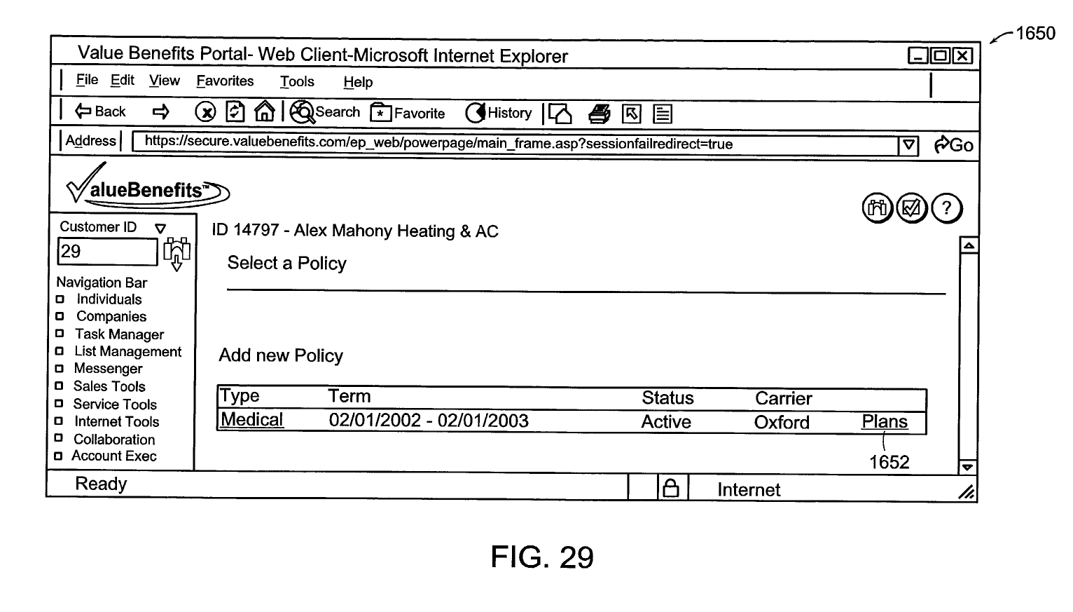

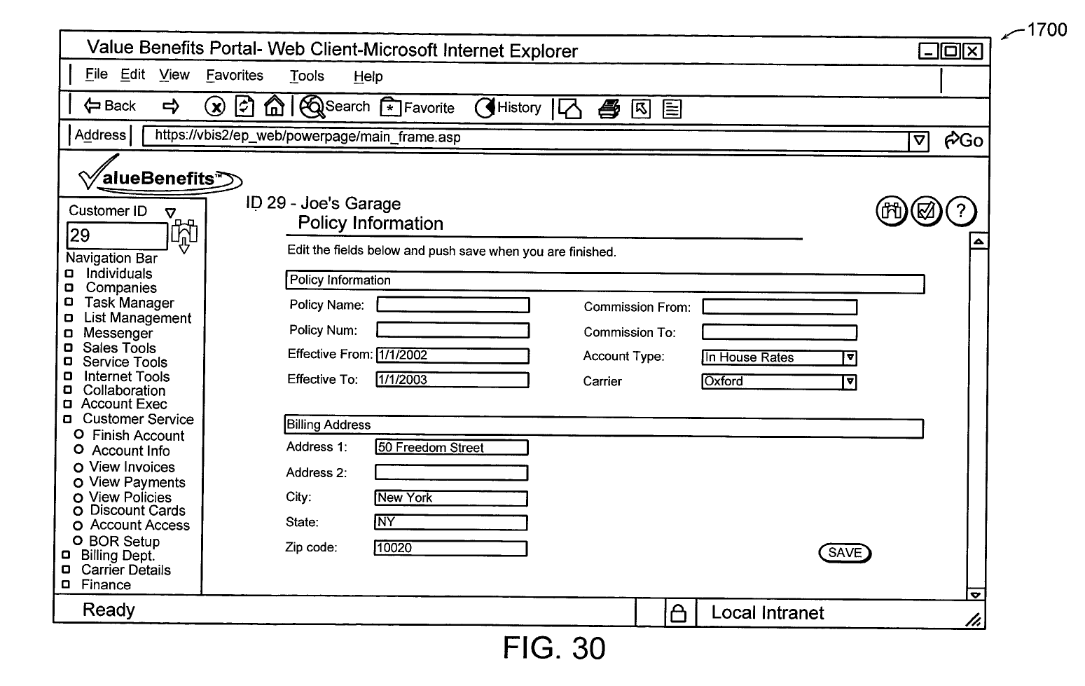

FIG. 30 illustrates a view of a display screen 1700 that a user interfaces with in order to enter all pertinent information when adding a new policy in accordance with a preferred embodiment of the present invention. The customer service representative accesses the screen to enter all the pertinent information when adding a new policy. The system is password protected including the quoting system which details how the typical user interacts with the system.

A preferred embodiment includes the automation of many of the current processes. For example, an alternate preferred embodiment system relies heavily on the customer service representative (CSR) tracking changes to the account in order to check enrollment eligibility. Preferred embodiments handle these responsibilities, by incorporating carrier eligibility logic or executable instructions into the system and alerting the customer service representative to possible problems. Another preferred embodiment of the system includes the electronic transfer of data between the system and the carrier partners or vendors. As carriers accept electronic enrollment and billing data, preferred embodiments include manual creation of data and sending of electronic files to the carrier. Preferred embodiment of the system automate this process and track transfers to ensure that the operation is successfully completed.

The second custom menu within the CRM system is for the customer service representatives. The CSR has the ability to: view customer account information, view invoices, view customer payments, create new accounts and view existing policies. The account information screen is the same as the AE's view.

The ability to review customer invoices and payments is provided for trouble shooting and handling customer inquiries. These views provide a list of which invoices were generated for the account and a list of payments which have been received by the customer. The CSR can review the details of any invoice or payment by clicking on the invoice or payment id. The CSR can not change any information on these screens.

The last two menu items, create new accounts and view policies, are directly related to setting up and maintaining customer accounts. The CSR is responsible for initiating and completing the enrollment process. These last two menu options provide the CSR with this capability. The CSR creates a account by clicking on the “create new account” link within the CRM system. In a preferred embodiment, the CSR enters the account name, the sales person's name and a password for the account. The reporting of sales commissions is tracked by the screen which assigns an AE to the account, (ENR_PolicyBroker).

Once the information is saved, the CSR sets up a policy for the account. By saving this information, the CSR creates an account record, company record and policy record in the system. At the start of the enrollment process the customer's account status is set to “inprogress” and the policy status is set to “inprogress.” These statuses are used to track the progress of the enrollment process, as well as to activate the billing process.

The enrollment process is completed by the CSR within the CRM system via the following steps. First, the CSR selects the “pending” medical policy from the CRM system by clicking on the “medical” link. After reviewing the information on the screen, the CSR presses the save button. This action causes the following to occur: the policy status is set to “active,” the account status is set to “activated,” and all employee, plan and rate information is copied to the policy history table. An account must be activated in order to initiate billing.

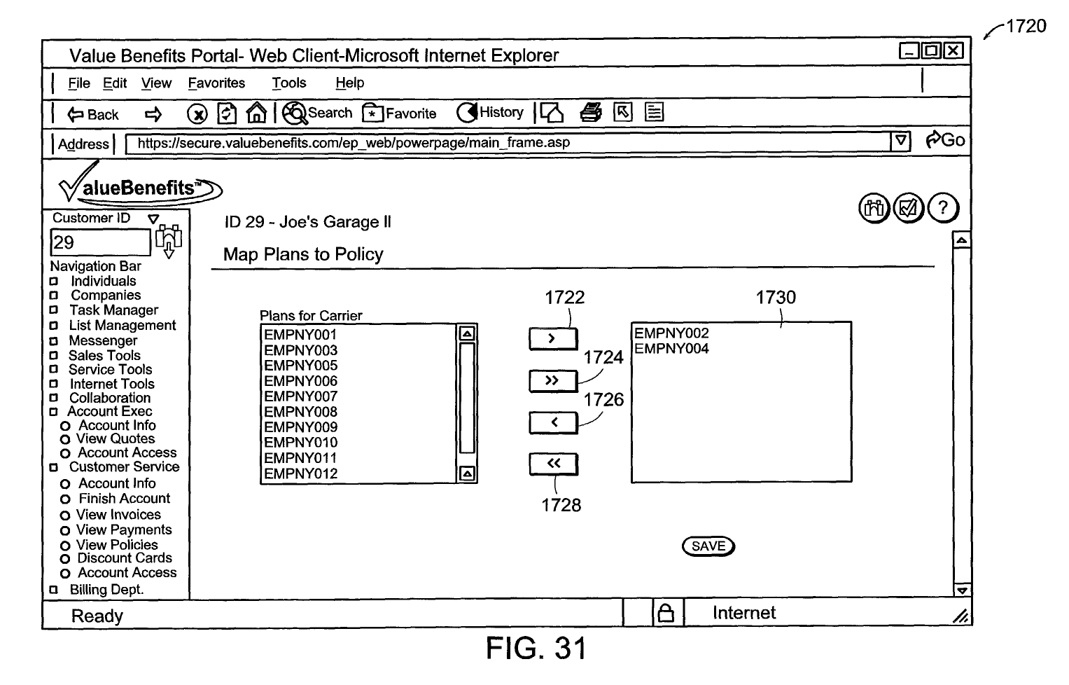

FIG. 31 illustrates a view of a display screen 1720 that a user interfaces with in order to map plans to a policy in accordance with a preferred embodiment of the present invention. When a new policy is setup, the customer service representative has the ability to determine which plans are displayed in the enrollment process. The add single item (>) 1722 and add all items (>>) 1724 buttons allows the CSR to add all of the plans to the policy. The remove single item (<) 1726 and remove all items (<<) 1728 buttons allows the CSR to remove all of the plans on the policy. Only plans which are added to the plan for policy list are displayed in enrollment. For example, the customer can only see the two plans, EMPNY002 and EMPNY004 in the plan select screen 1730.

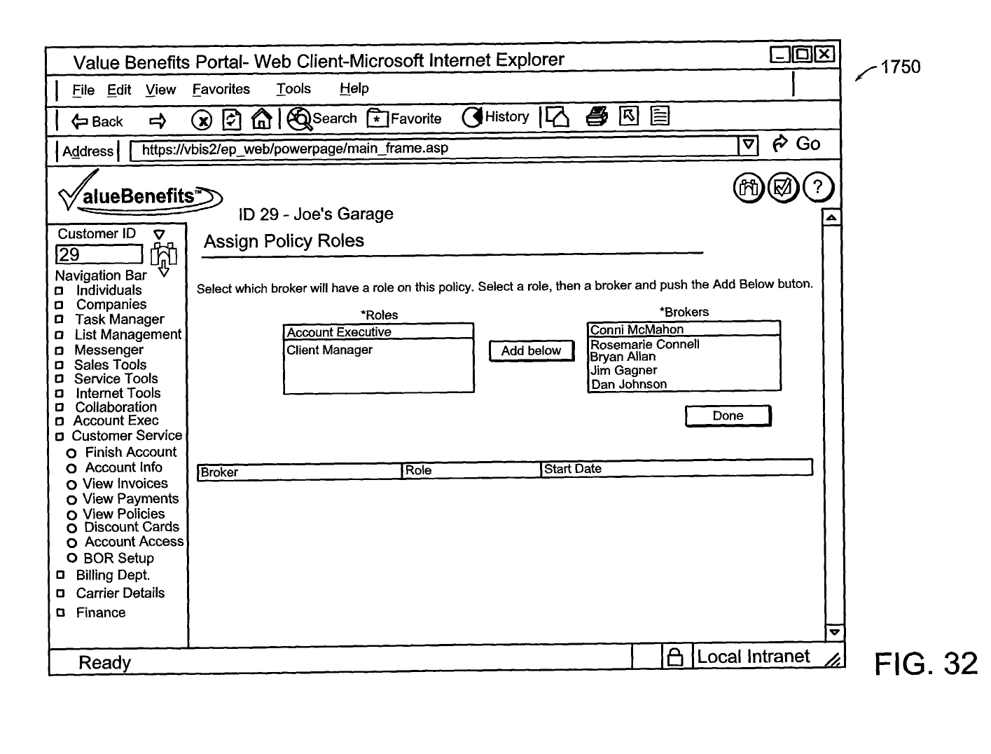

FIG. 32 illustrates a view of a display screen 1750 that a user interfaces with in order to assign sales roles as part of the enrollment process in accordance with a preferred embodiment of the present invention. This screen 1750 sets up which sales people are assigned to the policy. The screen allows a user to setup one or more sales people and to define their specific role in the sales process.

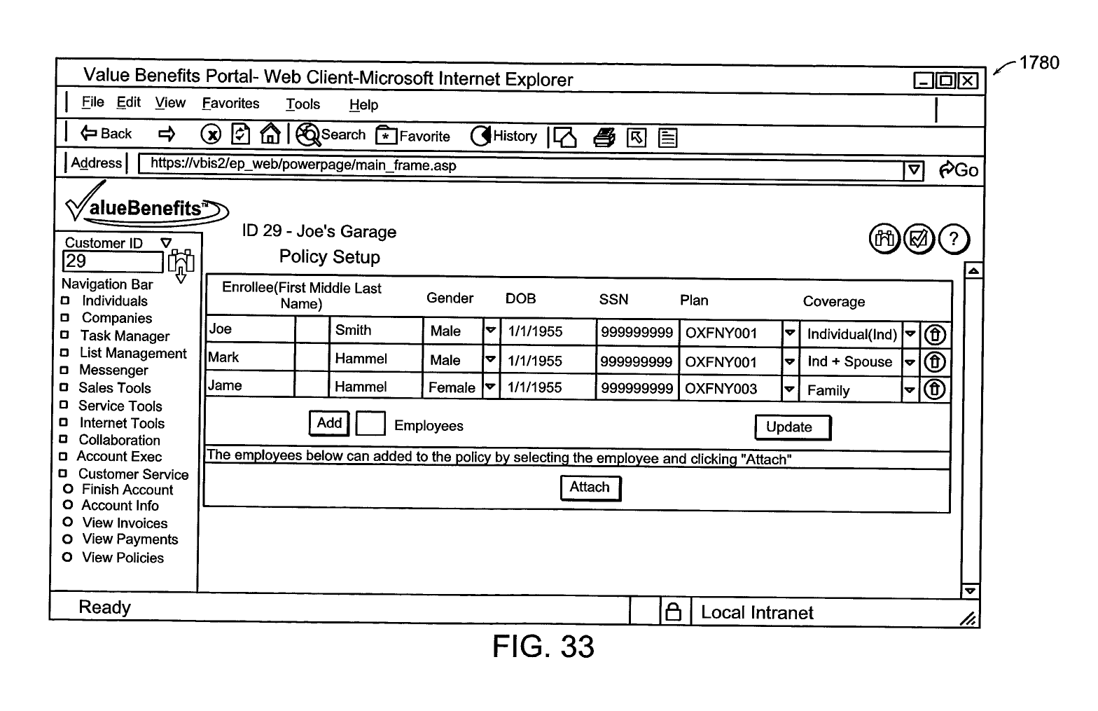

FIG. 33 illustrates a view of a display screen 1780 that a user interfaces with in order to set up policy holders in the enrollment process in accordance with a preferred embodiment of the present invention. The screen 1780 allows the user to add one or more employees to the active policy.

In a preferred embodiment, discount cards are included in the enrollment process. The CSR can add one or more cards for one or more employees. The available discount card list contains a list of all of the currently available discount cards. The employees list contains a list of all of the employees who have been setup on the account. The start/end dates represent the effective dates of the discount cards. The business rules associated with this screen include the provision such that any changes to the discount card options are immediately made to the billing system.

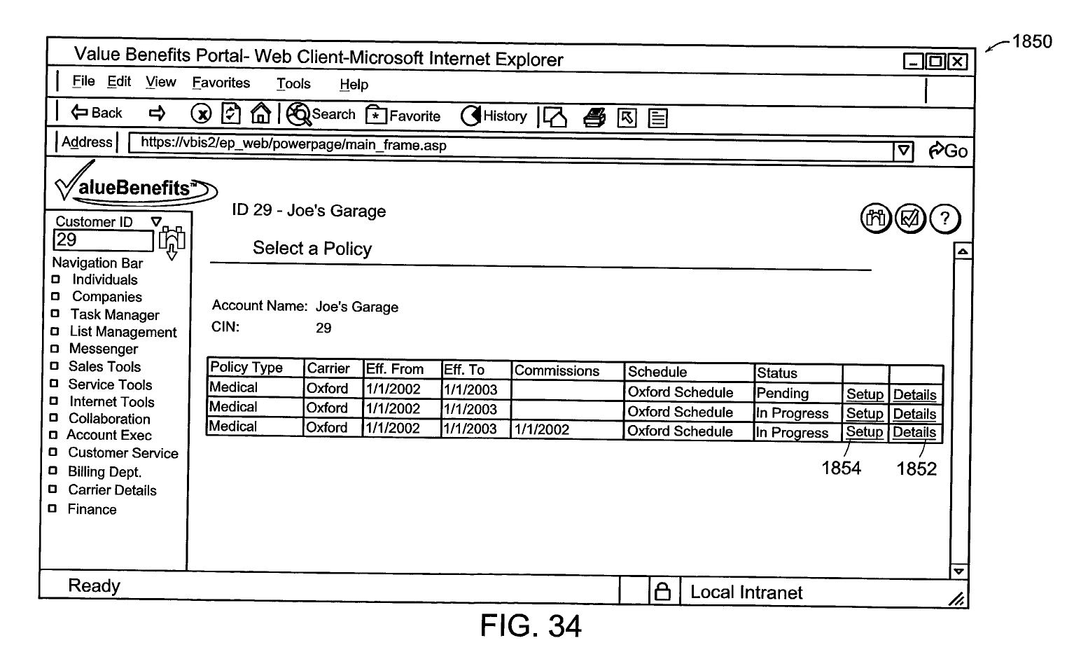

FIG. 34 illustrates a view of a display screen 1850 that a user interfaces with in order to list all the policies in the particular account and indicate different status in accordance with a preferred embodiment of the CRM/billing system of the present invention. The finance menu options are available from within the CSR system for all users who have rights to the finance group. The CRM system has at least five groups of users including sales, customer service, finance, executives and administration. The finance section includes the addition of the setup policy screen and the billing adjustment screens. These screens are used to review an account and to setup the items necessary to correctly bill the customer.

The setup policy screen is retrieved by clicking on Account Info under the CRM/Billing menu. This screen lists all of the policies on the account and indicates their current billing status. The details link 1852 allows the billing agent to review the enrollment information for the policy. The setup link 1854 displays the policy details and allows the billing agent to change items related to billing.

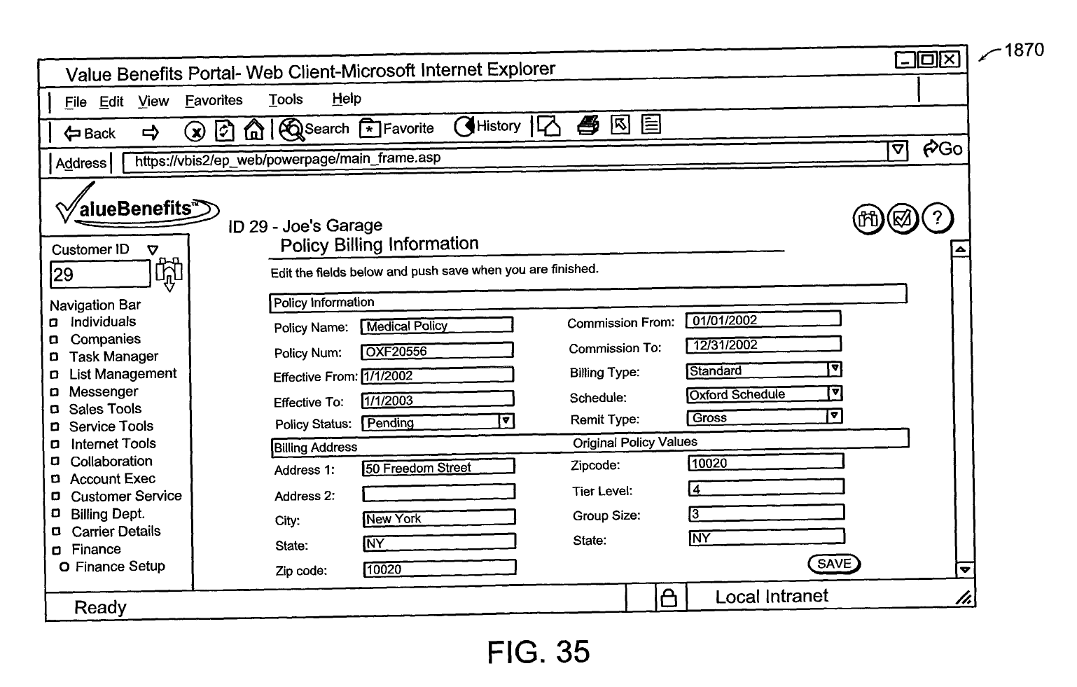

FIG. 35 illustrates a view of a display screen 1870 that a user interfaces with in order to set up or review the billing attributes of a policy in accordance with a preferred embodiment of the present invention. The setup policy is used to setup or review the billing attributes of a policy. The billing agent can set the commission start date, the type of billing, net remittance versus gross remittance, and select the carrier schedule to use for remittance. Pressing the activate policy button marks the policy as active and adds the policy to the next billing period. In a preferred embodiment, the features available to the billing agent are expanded to include sales commission tracking and broker of record (BOR) premium tracking. Additionally, the billing agent needs the ability to reconcile previous transactions such as payments received, carrier remittances sent and carrier commissions collected. The reconciliation process is important to ensure that all of the chart of accounts remain balanced.

In a preferred embodiment all of the billing features are available through the CRM system. When the billing agent logs into the CRM system, she/he views a custom menu on the navigation bar: “billing.” Clicking on this menu evokes a custom screen which offers the user the ability to: generate monthly invoices, review invoices, pay invoices, review payments, make adjustments, create remittances, review remittances and to view a balance sheet and profit and loss statement. These features are described hereinbelow.

“Generate monthly billing” screen is the main screen for billing clients on a monthly basis. With the click of a button, the system scans the accounts table and generate invoices for all active clients. Any supplemental charges which have been setup for the client are added on to the invoice at the end of the process.

The generate monthly invoices screen uses the profile history table to determine which accounts should be billed during the indicated period. In a preferred embodiment of the system, the billing period can be the first of the month. All invoices are created with an invoice date of any day of the month. The generate invoice process follows these steps in order to create invoices: the user selects a month (i.e. invoicing period), active accounts are loaded from the account table, active policies are loaded from the policy table, the invoice table is scanned to be certain an invoice does not exist for the invoicing period, the policy history table is used to determine which employee's to bill and which plans at what rate to invoice.

The first screen in the generate (monthly) invoice step asks the user to select a billing period. The user selects a date from the drop down list. Upon pressing the go button, the review invoice list is displayed with the new invoices. Initially, all invoices are created with an unposted status. This allows the billing agent to check the invoice for accuracy before posting it to the general ledger account. Once an invoice is posted, it can only be changed via reverse entries to the general ledger.

The review invoices list contains a list of all of the invoices in the system, included unposted, posted, partially paid and fully paid invoices. This list is displayed once the generate monthly invoices is successfully completed. The review invoices displays the invoice number, client name, invoice amount and invoice status. Unposted invoices contain a check-box next to the invoice status. The billing agent can post any unposted invoices, by selecting the invoice and pressing the post button. The business rules that apply include each account being invoiced once per month, if a bill already exists for the client for the specified month, then the bill is overwritten, however, the bill is not overwritten if it has already been paid, the create button scans the ENR_Accounts table to determine which clients are active and requires a bill for the specified period, if additional charges are setup for the client, they are added to the invoice. Further, when an invoice is created, the invoice amount is debited to Accounts Receivable and credited to the income account, any finance charges or miscellaneous charges which are not transferable, are credited to the retained earnings account, the invoice amount is added to the customer's outstanding balance in the chart of accounts, process for creating monthly invoices, load all active accounts, determine if an invoice already exists for the specified month, and determine if the Account has any active policies.

The review monthly invoices screen allows the billing agent to review all of the invoices before they are posted to the general ledger. The link on the invoice number displays the “preview invoice” screen. By clicking on the checkbox next to the “unposted” invoices, the user can post all of the select invoices with one click.

The preview invoice choice displays a read-only version of the invoice. The pay invoices screen allows the billing agent to pay one or more posted invoices. To pay an invoice, the billing agent selects the system account, fills in the check amount, date received, a reference number (i.e. check number) and a description (optional), and selects a system asset account. At this time, one or more invoices can be paid. Payment must be made against each outstanding invoice. If the payment equals the invoice total, then the invoice is marked paid in full and is not displayed on this screen in the future. If the invoice is partially paid, then the invoice status is set to “partially paid” and is displayed until it is paid in full. If at any time the billing agent does not apply the total payment to one or more invoices, the balance is credited to the customer's account. Credits can be applied to outstanding invoice balances at any time.

As the first step, the user must first select a account. Pressing the select button opens the review payments list. The business rules that apply include if the check amount does not equal the invoice amount, then the total amount is placed in a “holding account” and not the cash account, the check amount must equal the amount applied to the individual invoices, if a payment is applied to an invoice, the invoice is marked paid. Further, when payment is received, cash is debited from accounts receivables and moved to the indicated cash account. When payment is received, a carrier liability is created for the carrier listed on the invoice. The information at the top of the form is retrieved from BIL Payments table.

The review payments menu item displays a historical list of payments for a given date range and/or specific client. The user can preview the payment, by clicking on the payment ID, or edit the payment. The business rules that apply include, if a payment is deleted, then the associated invoices are unmarked as paid, a payment cannot be deleted if the Payment Status=Inreconciliation or reconciled, a payment cannot be edited if the Payment Status=Reconciled.

A carrier remittance is generated at the time the invoice is posted or paid in accordance with a preferred embodiment. The remittance is calculated based on the carrier schedule which is setup for the policy. Once a carrier remittance is generated, the system allows the billing agent to review previous transactions. The billing agent can change a past payment or make adjustments to the payment, i.e. via a reverse journal entry.

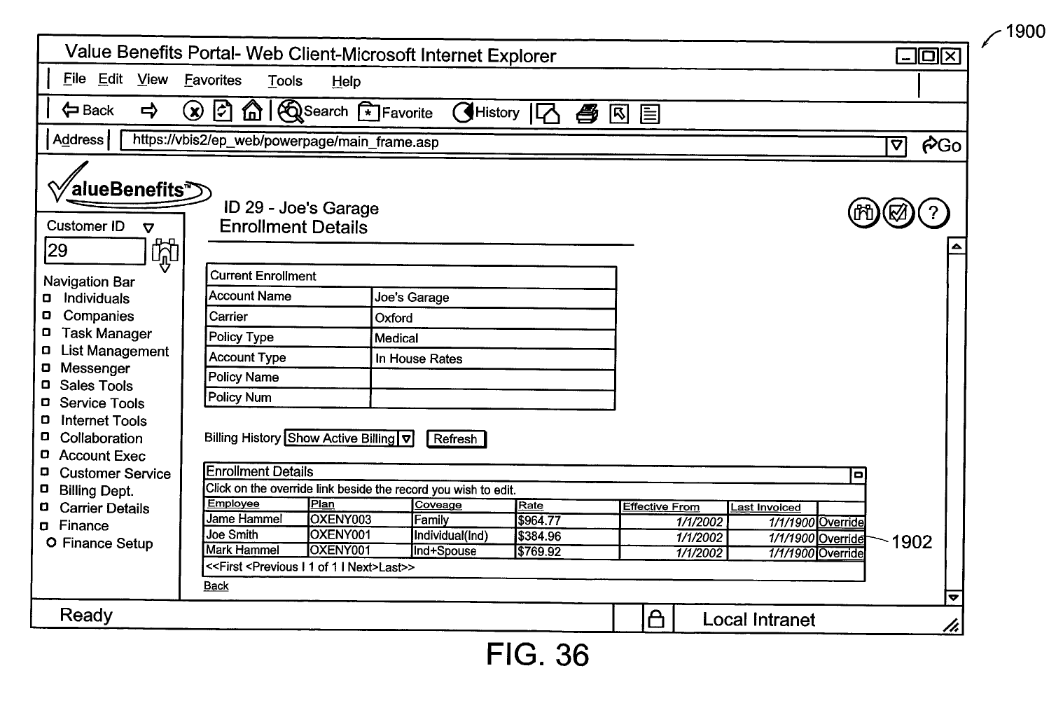

FIG. 36 illustrates a view of a display screen 1900 that a user interfaces with in order to display enrollment policy details in accordance with a preferred embodiment of the present invention. The enrollment details screen 1900 displays all of the employees who have been setup on the policy. These employees are setup via the new enrollment for broker of record (BOR) enrollment process. The tables in the screen reflect all of the items in the billing history table ENR_ProfileHistory in the integrated insurance system. The billing agent has the ability to override any plans or rates or to make billing adjustments using this screen 1900.

The adjustment link opens up the billing adjustment screen. This screen is used to change the billing profile in the event that a client has been incorrectly billed. Any billing adjustment which is made and which is used to calculate the next billing period rates is shown in the screen. It can contain a delete link because the profile history status is set to a default.

The override link 1902 opens up the override screen. This screen is used to setup a broker of record (BOR)-type account, i.e., an account which is billed for non-standard system plans.

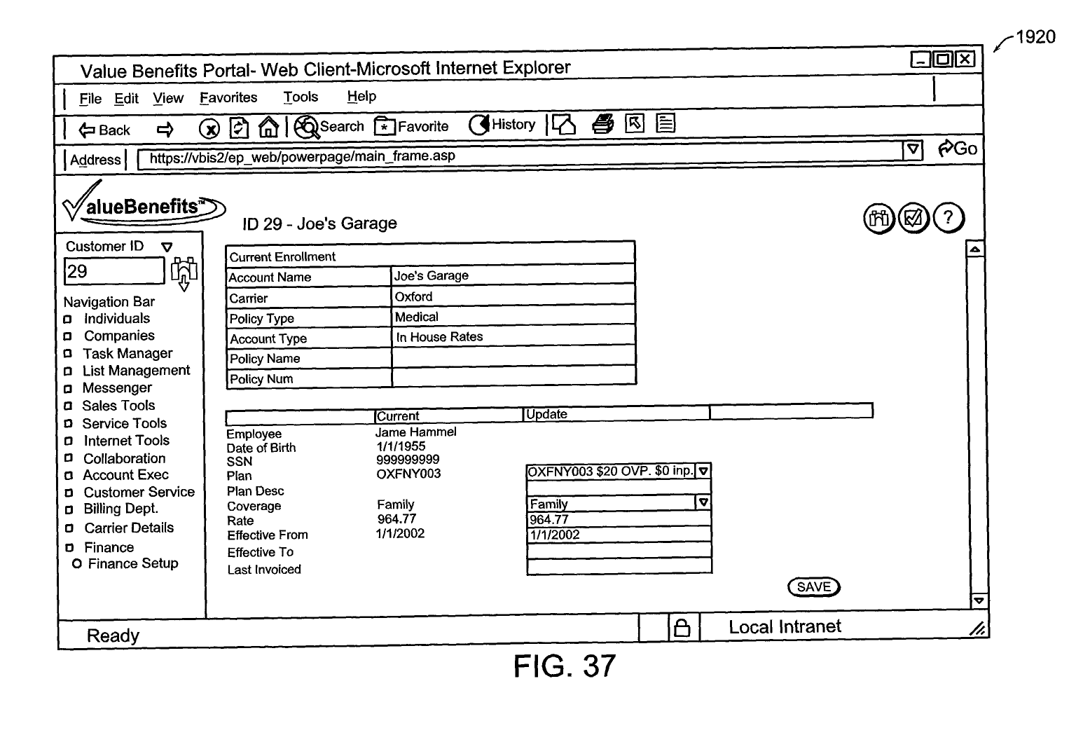

FIG. 37 illustrates a view of a display screen 1920 that a user interfaces with in order to display an override plan that is used to manually set a rate for a plan in accordance with a preferred embodiment of the present invention. The override plan screen allows the billing agent to manually set a rate for a plan.

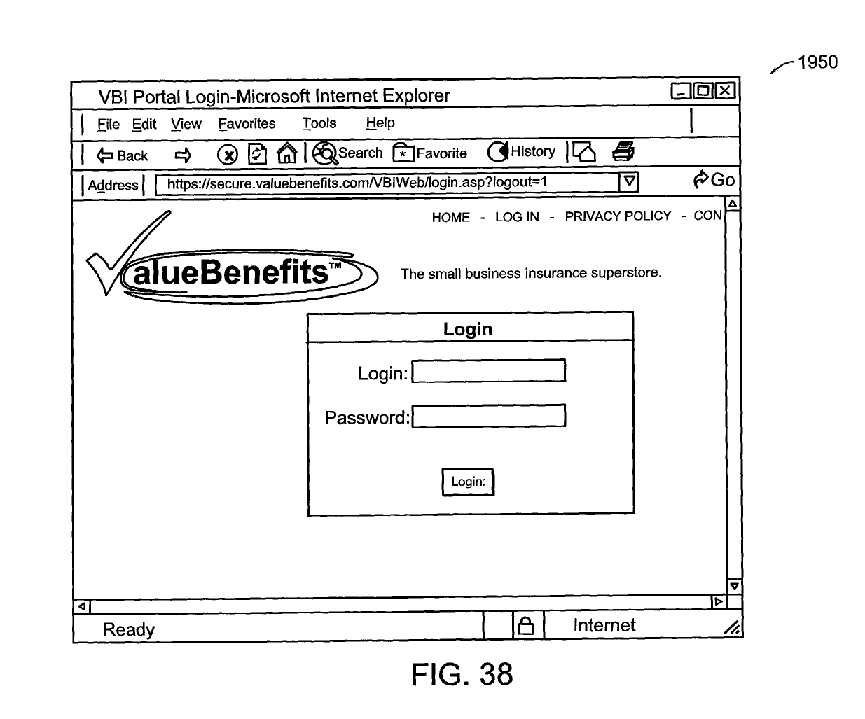

FIG. 38 illustrates a view of a display screen 1950 that a user interfaces with, in particular an employer or customer to log into the system in accordance with a preferred embodiment of the present invention. A password needs to be provided to proceed.

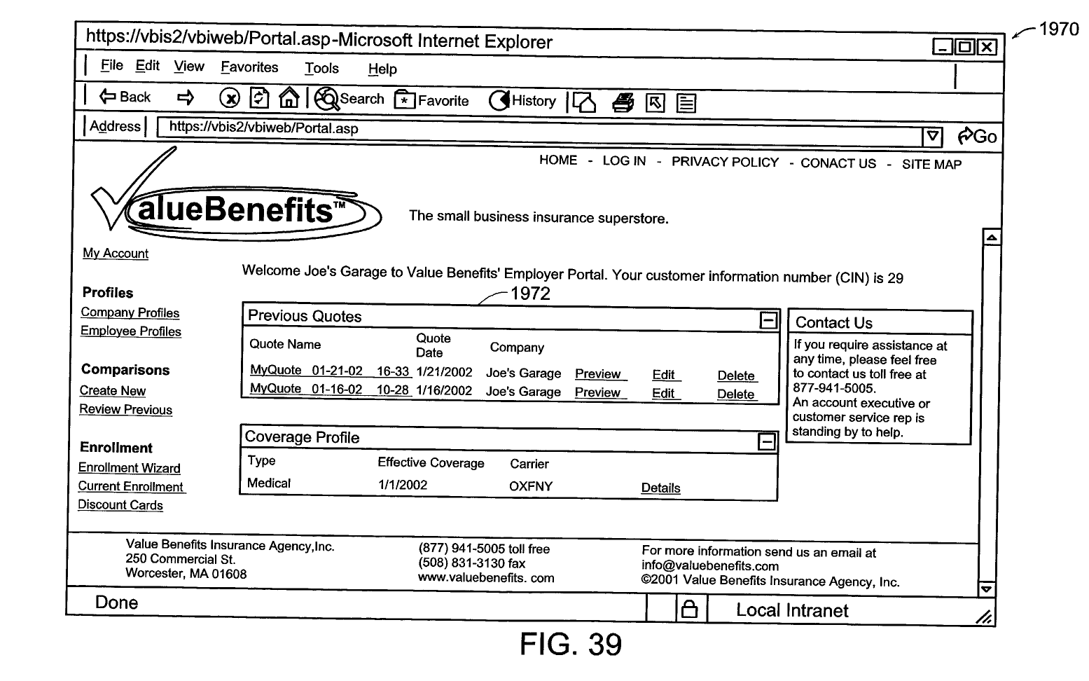

FIG. 39 illustrates a view of a display screen 1970 that a user interfaces with in order to display customer specific information such as, for example, previous quotes and coverage profile in accordance with a preferred embodiment of the present invention. This screen contains customer specific information, such as a list of previous quotes 1972 and current enrollment information. This page is accessible by clicking on a link, for example, my account link.

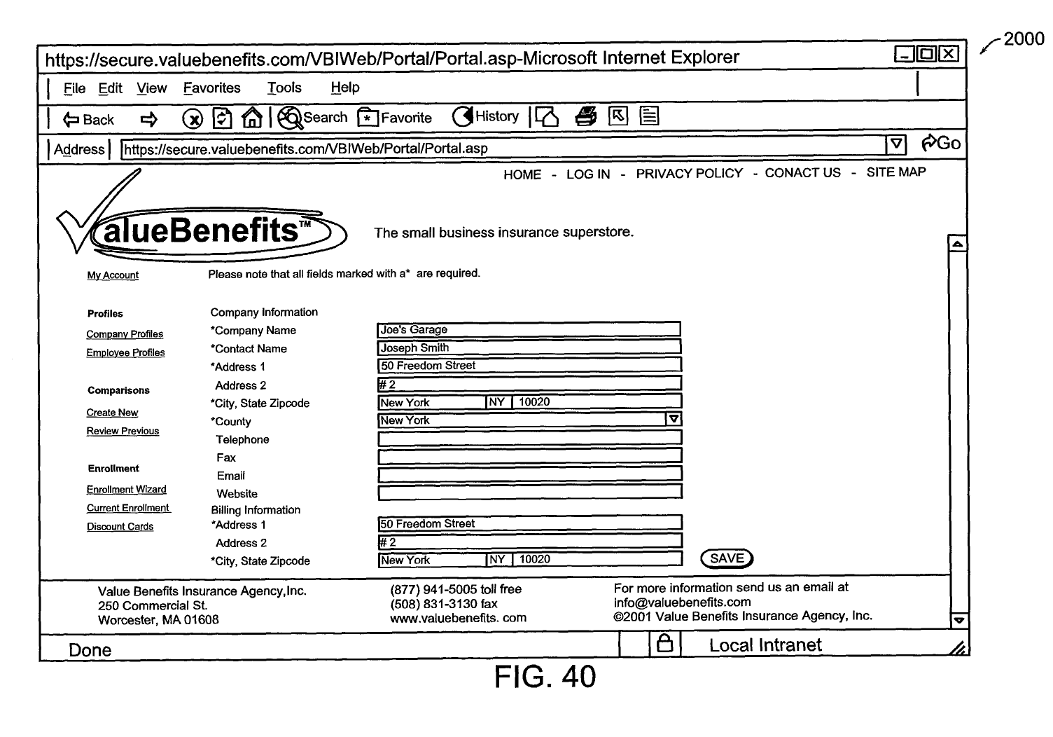

FIG. 40 illustrates a view of a display screen 2000 that a user interfaces with in order to display a client or company profile in accordance with a preferred embodiment of the present invention. This screen includes company specific information such as billing address, contact name and geographic information.

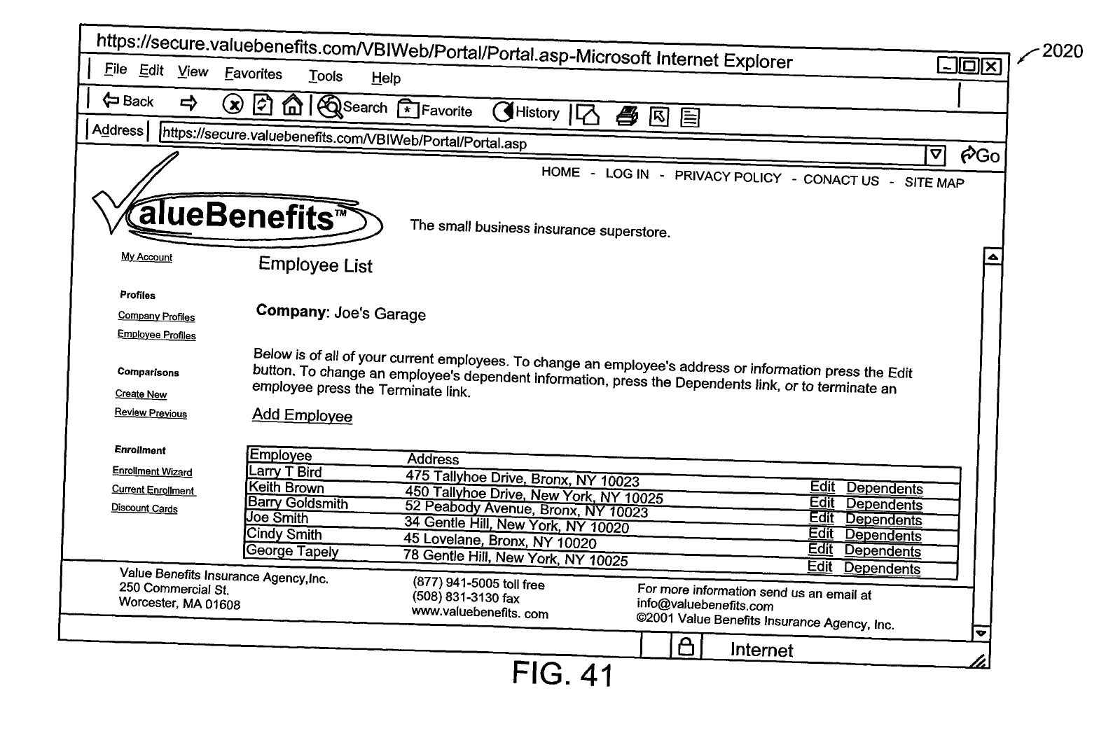

FIG. 41 illustrates a view of a display screen that a user interfaces with in order to display a list of employees or employee profile and corresponding employee information in accordance with a preferred embodiment of the present invention. Within the enrollment section all of the screens remain the same except for the enter employee information screen. This screen makes it easier for the account executives to enter employee information if no employee profile information exists.

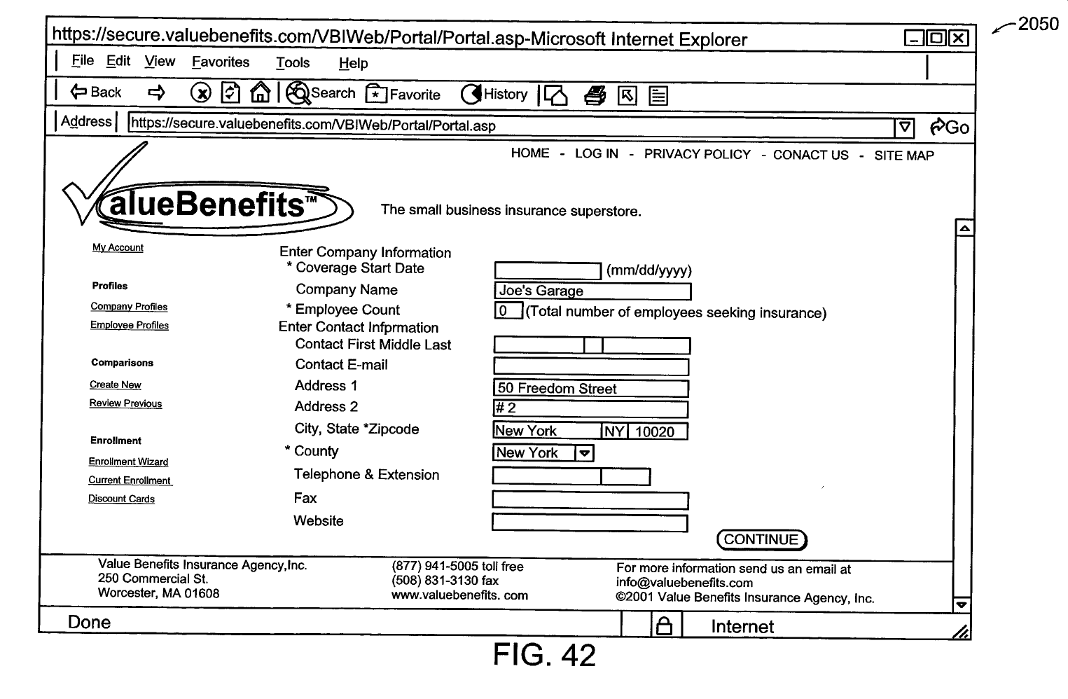

FIG. 42 illustrates a view of a display screen 2050 that a user interfaces with in order to perform a new rate comparison that includes entering of company information in accordance with a preferred embodiment of the present invention. Company name and address is entered in this screen. The pertinent business rules that apply to this screen include, without limitation, red asterisks representing required fields, generating a quote number automatically using a format, for example, xxx-counter and saving. In a preferred embodiment, the carrier files are stored in a carrier table. The rate comparison module of the system is geared towards providing small business groups with a localized rate comparison for group insurance products. A small business owner can go to the system's website and within 5 minutes generate a rate comparison of all of the carrier's which offer, for example, medical health plans in their area. The business owner need only enter several key pieces of information to generate a quote, including: a business zip code, total number of employees eligible for health insurance, each employee's demographic information and the employer's contribution. The business owner can customize the final quote to include only the carrier and/or plans which meet his/her needs. The quote is automatically saved in a preferred embodiment for later retrieval.

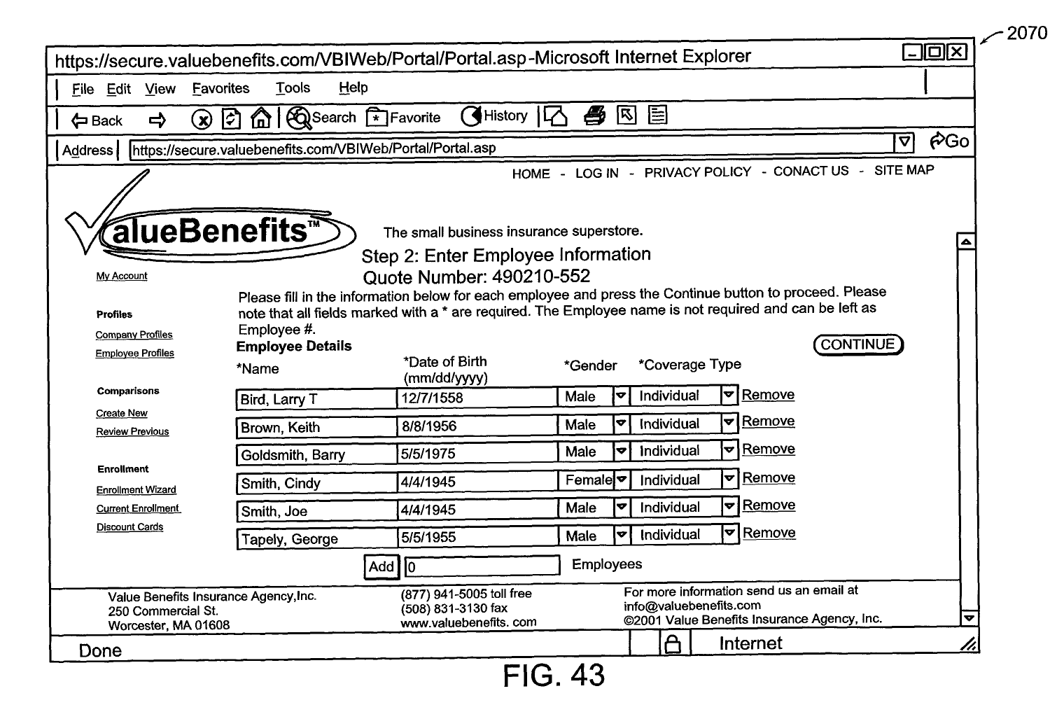

FIG. 43 illustrates a view of a display screen 2070 that a user interfaces with in order to enter employee information to perform a new rate comparison in accordance with a preferred embodiment of the present invention. When creating a quick quote an employer enters the employee's date of birth (DOB), sex and coverage type (individual policy, family policy, etc.). The employer can optionally enter the employee's name at this point. If the employer decides to set up more employees they can use the enter more employees list.

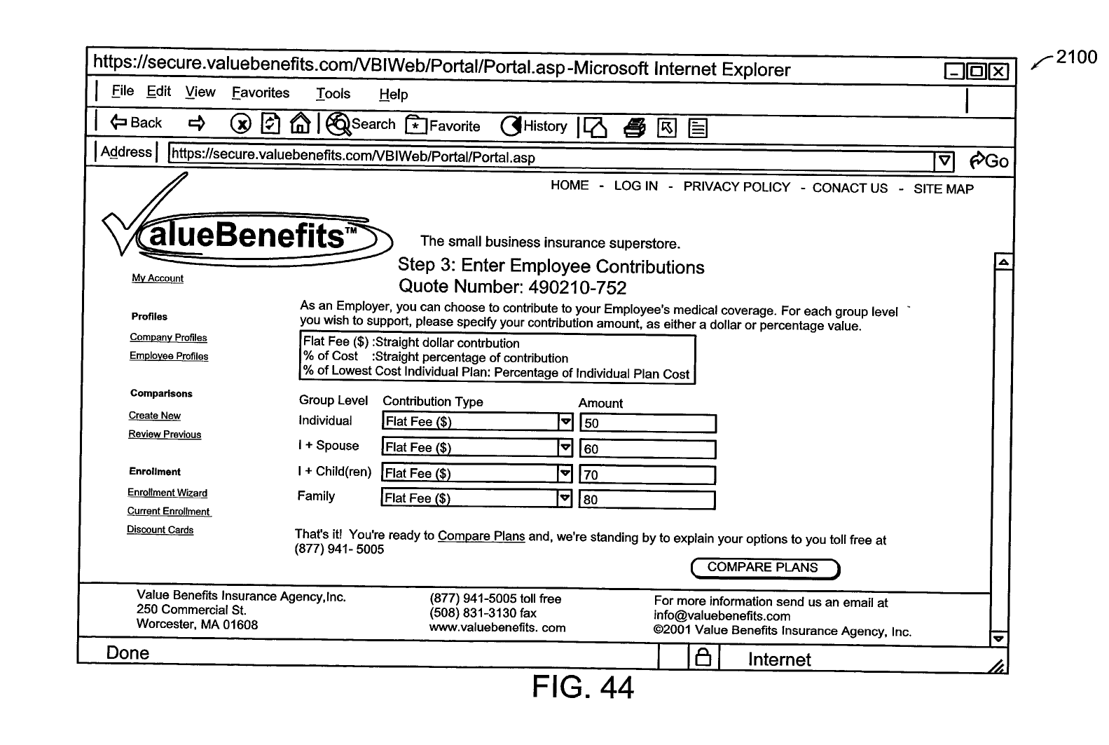

FIG. 44 illustrates a view of a display screen 2100 that a user interfaces with in order to enter an employer contribution to perform a new rate comparison in accordance with a preferred embodiment of the present invention. The employer contribution screen allows the employer to enter a fixed or percentage amount to contribute to their employee's health care costs. The business rules included with the employer contribution are fixing a group level to start or dynamically generating them, contribution type list containing at least three fixed values, for example, flat fee, percentage and percent lowest and the same to continue link proceed to the compare plans page.

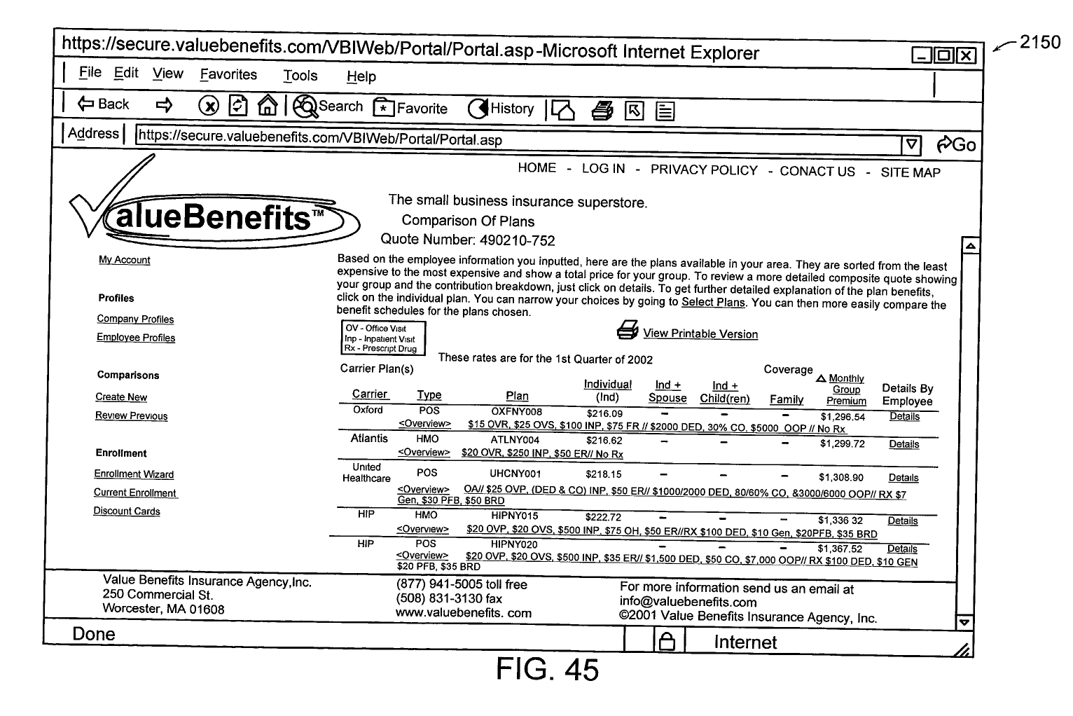

FIG. 45 illustrates a view of a display screen 2150 that a user interfaces with for displaying a comparison of all the plans offered in accordance with a preferred embodiment of the present invention. The screen displays all of the plans offered by the system in the employer's area zip code. The business rules pertinent to this screen include the select plans link opening the select plan page, determining coverage rates by the employee's demographic information and the employer's zip code, defining the coverage types at the market level, the details link displaying the details of the quote for each employee and a link on the plan opens the plan details page which is, for example, a file such as a PDF supplied by the carrier.

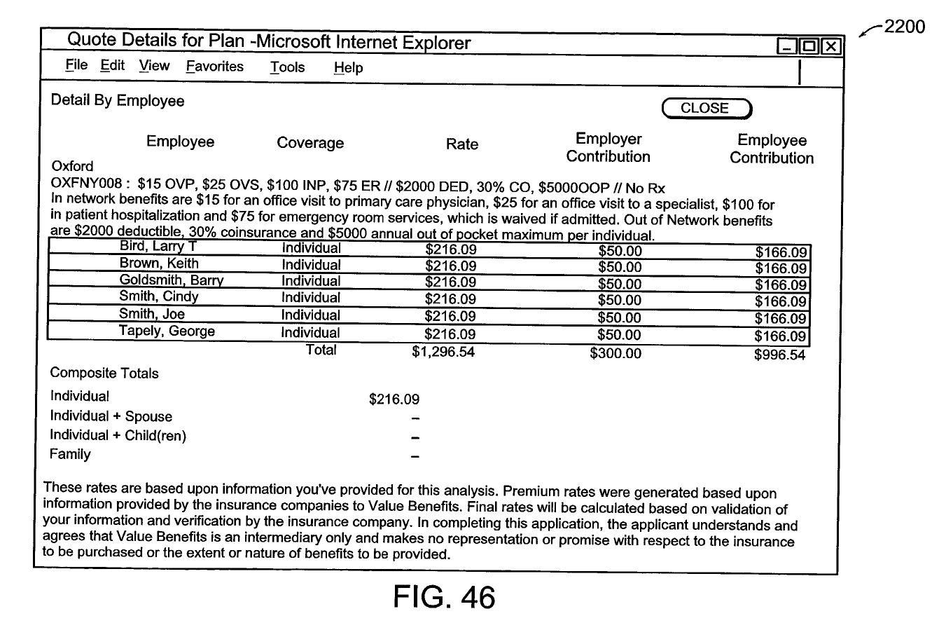

FIG. 46 illustrates a view 2200 of a display screen that a user interfaces with for displaying the comparison of the plan rate for each individual employee in the company in accordance with a preferred embodiment of the present invention. The detail by employee page is called from the compare plans page. This screen shows the actual plan rate for each individual employee in the company. As to the pertinent business rule, the composite totals are composed of the average rate for each coverage level.

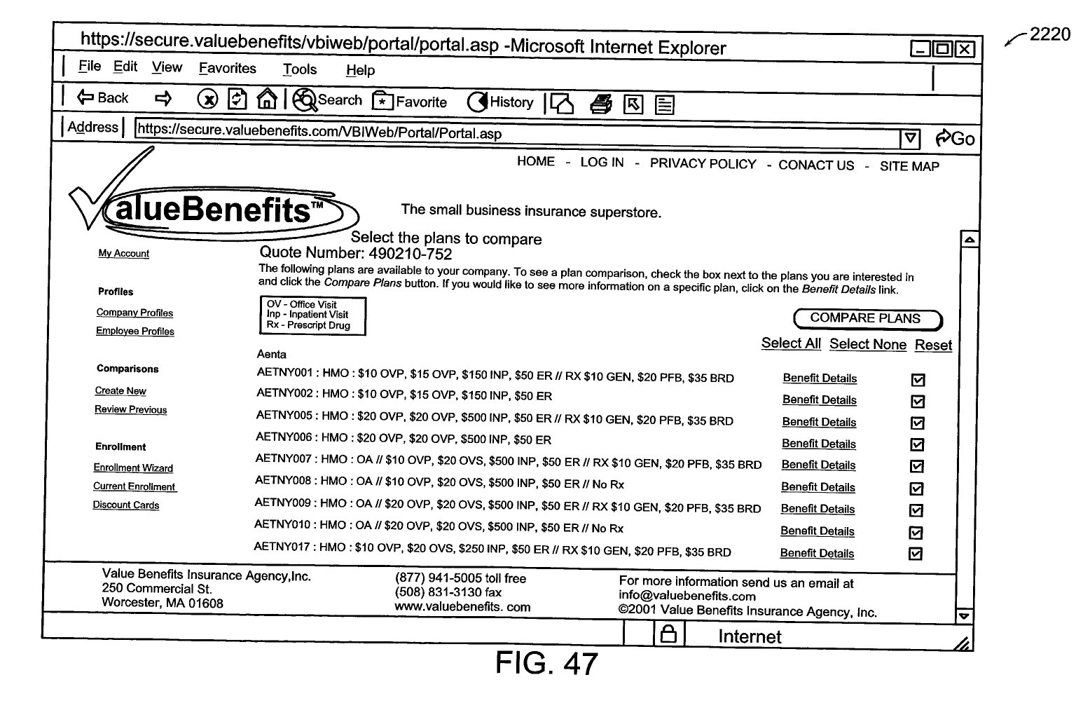

FIG. 47 illustrates a view of a display screen 2220 that a user interfaces with in order to selectively remove certain plans from a quote page in accordance with a preferred embodiment of the present invention. The screen displays all of the plans offered in the employer's zip code.

The enrollment process is managed and controlled by either a system sales representative or a customer representative. The general process flow for new enrollment includes the following steps. The enrollment process is initiated by the system sales representative who hands over a new case to a customer representative. The customer representative sets up a new username and password for the employer and his/her privilege level is set to “employer.” The customer representative creates new account in ENR_Accounts table. The account status is set to “new setup.” The customer representative also creates a new policy for the account (ENR_Policies). When the account is setup, the carrier is selected based on feedback from the employer. The carrier specific underwriting rules are applied to the employer enrollment. A “set” of enrollment steps is created to the ENR_EnrollWizard from the SYS_EnrollWizard template. Note more steps can be added on during the enrollment process for other product types. The user is directed to the new enrollment application or wizard. The user enters all of the information from the wizard. The user completes enrollment. The system checks that all necessary information has been entered. The account status is set to “employer complete.” In a particular embodiment, the customer representative ensures that all information is completed by the employer, including checking the employer information against carrier underwriting rules. In another embodiment, this verification process is done automatically. The underwriting rules are set up for each carrier and include testing such conditions as, for example, minimum participation. The customer representative sets up any remaining items, such as billing information. Account status is marked “completed.” The customer representative completes the enrollment which marks the account and the policy active for billing. All of the policy holder details are added and marked active.

The business rules for enrollment include determining if this is a new account, i.e. no account has yet been setup then only the enrollment application wizard is visible, the customer representative creates the account before the employer logs in, and all specific carrier rules are displayed to the employer (on a separate screen) when she/he logs in.

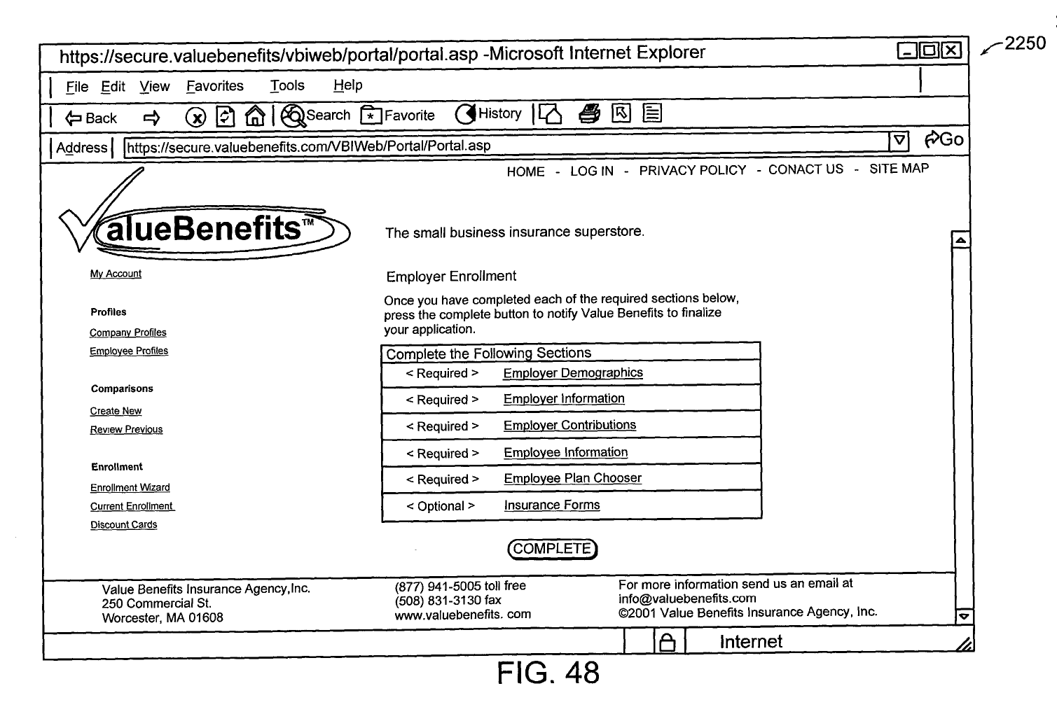

FIG. 48 illustrates a view of a display screen 2250 that a user interfaces with in order to enroll in the integrated insurance system in accordance with a preferred embodiment of the present invention. The employer needs to fill out several predefined segments such as, for example, company information, and contribution level. The screen 2250 lists all the steps needed to complete the enrollment process along with links to each step.

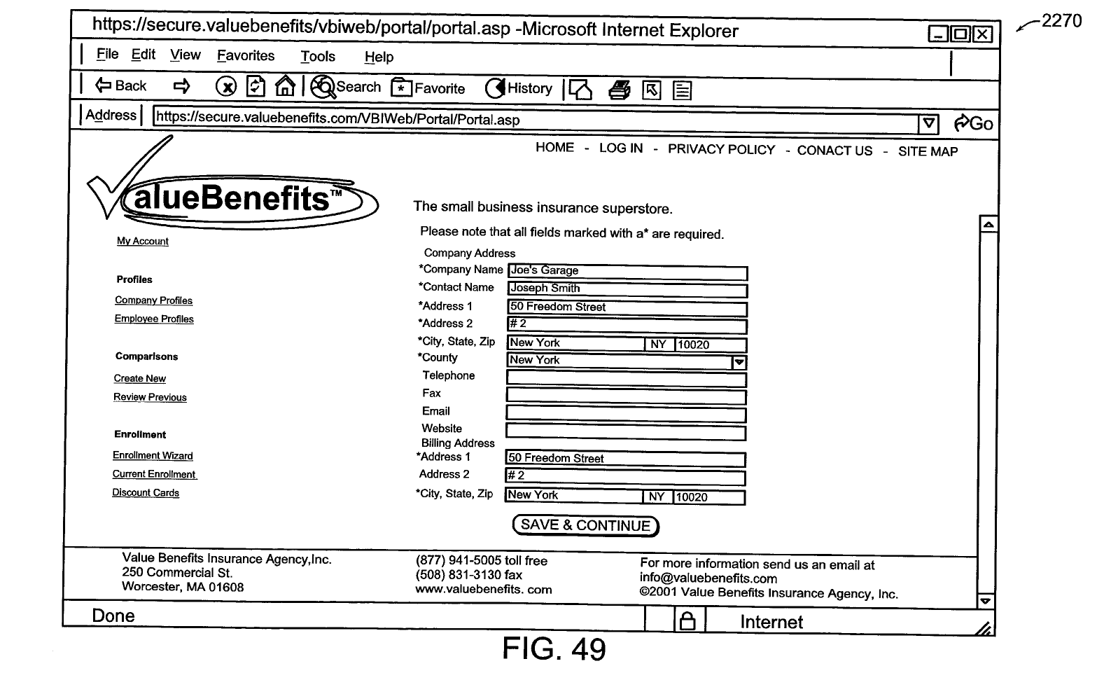

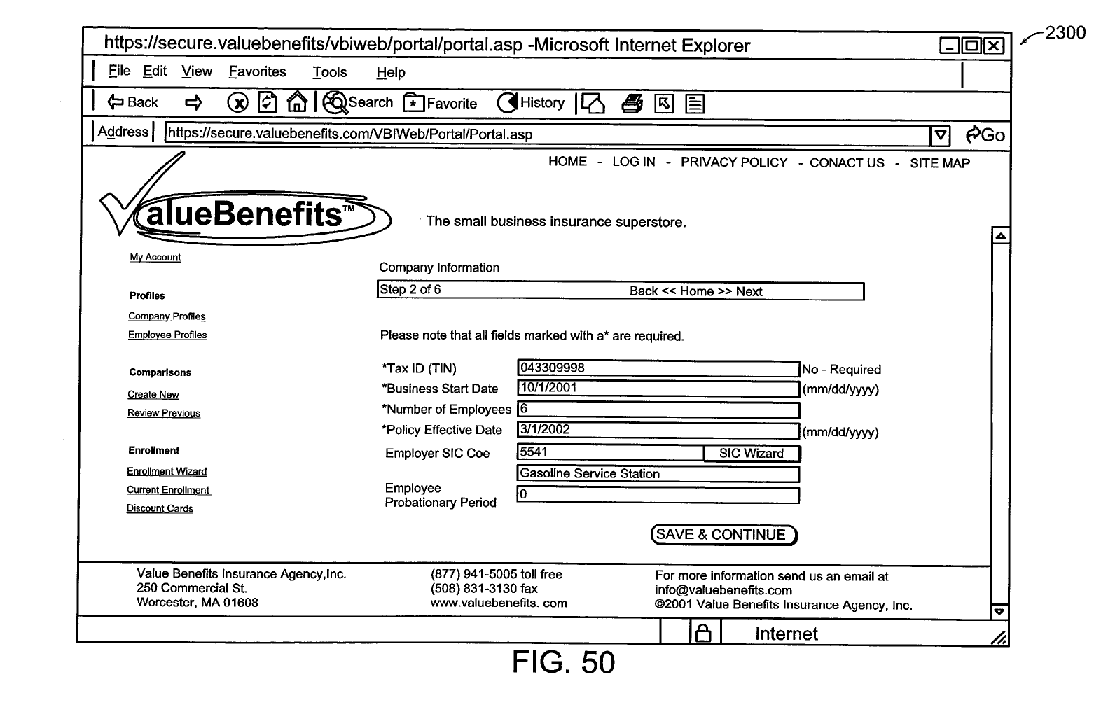

FIGS. 49 and 50 illustrate views of a display screen 2270, 2300 that a user interfaces with in order to enter all the pertinent information for an employer in accordance with a preferred embodiment of the present invention. The screen essentially collects the billing information for the employer. The business rules that are coupled to this screen include requiring all fields with a red asterisk, saving information to ENR Company, ENR_Person and ENR_Addresses and filling drop down menu lists from the SYS_Listitems table where the contact list category equals “ContactTypes” and the address list category equals “AddressTypes.”

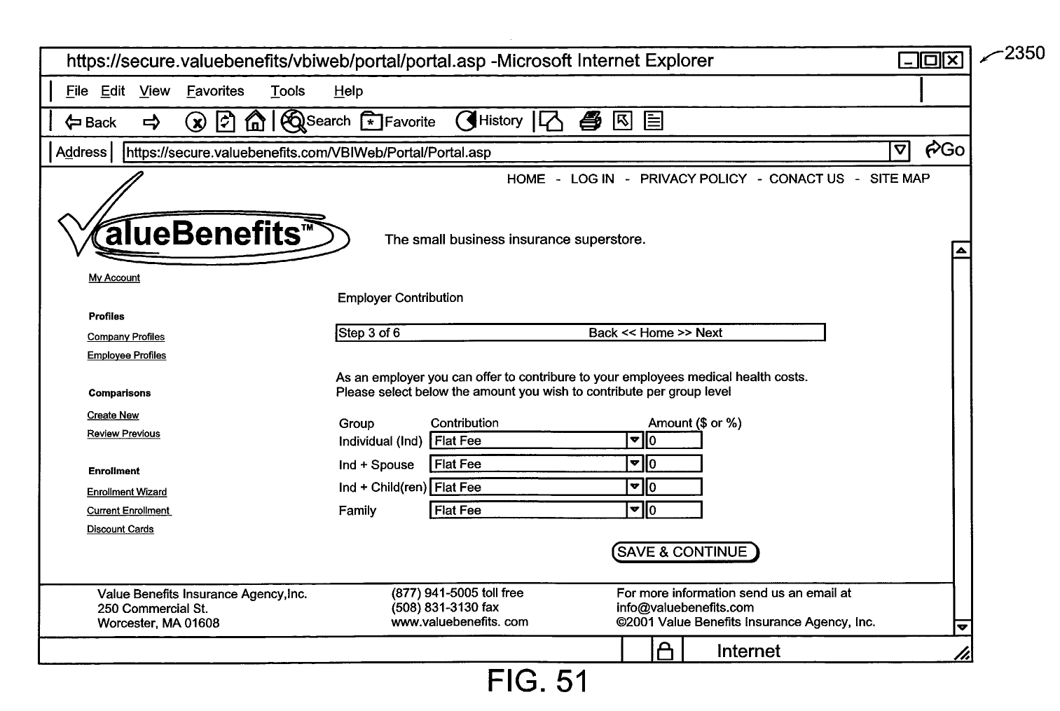

FIG. 51 illustrates a view of a display screen 2350 that a user interfaces with in order to enter a level of employer contribution in accordance with a preferred embodiment of the present invention. The screen asks the employer to enter a level of contribution for each plan coverage type. The pertinent business rules include the amount column being a percent or dollar amount, having three types of contribution levels, for example, fixed, percent of lowest and standard percent, loading contribution type form SYS_Listitems where the list category is “MedContributionTypes,” saving values to ENR_EmpContributions and marking the step “Contribution Level” complete in the ENR_Enroll wizard table.

As part of the underwriting requirements certain guidelines are followed. For example, a minimum participation rule requires that a minimum number of employees participate in the plan offering. The equation for this rule is:

Minimum participation=(Total Insured)/(Total Insured+Total Uninsured). The contribution policy requires that an employer contribute to the premium thereby reducing the employee premium. The rules can vary on one or more factors including, lowest plan offered or the tier level of the plan. Employer's contribution can be different for each coverage level (i.e., individual, spouse . . . ), percentage or flat fee, and a percentage of the individual plan or of the lowest plan.

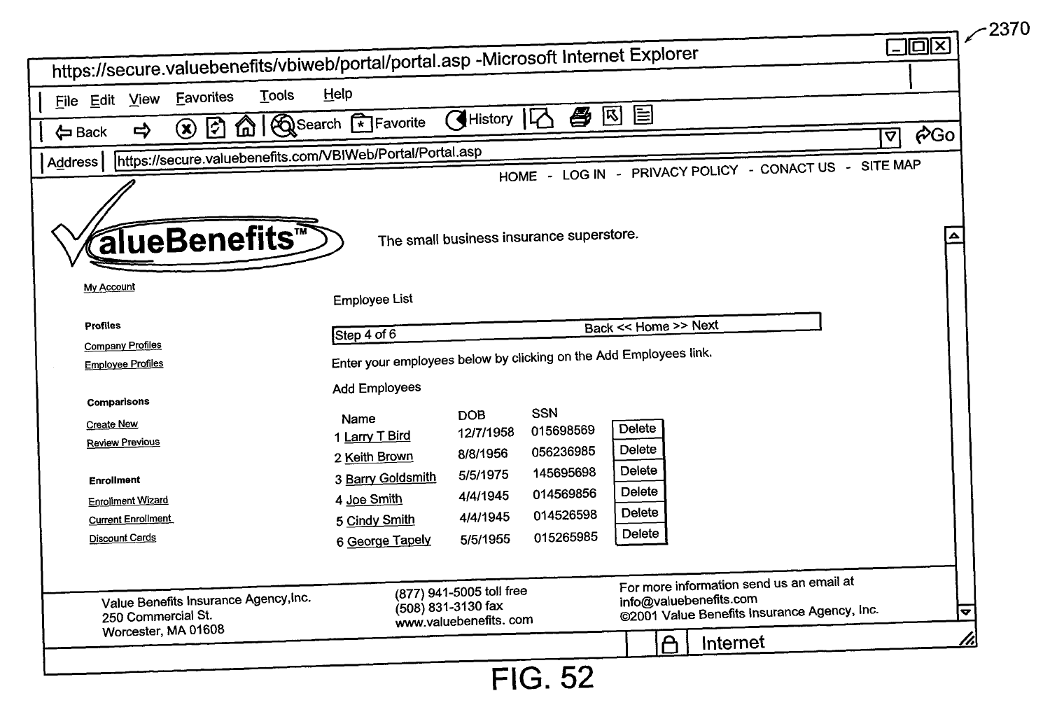

FIG. 52 illustrates a view of a display screen 2370 that a user interfaces with in order to enter employee information in accordance with a preferred embodiment of the present invention. Name, birthdate and SSN have to be entered for each employee. There is an option to add or delete employees.

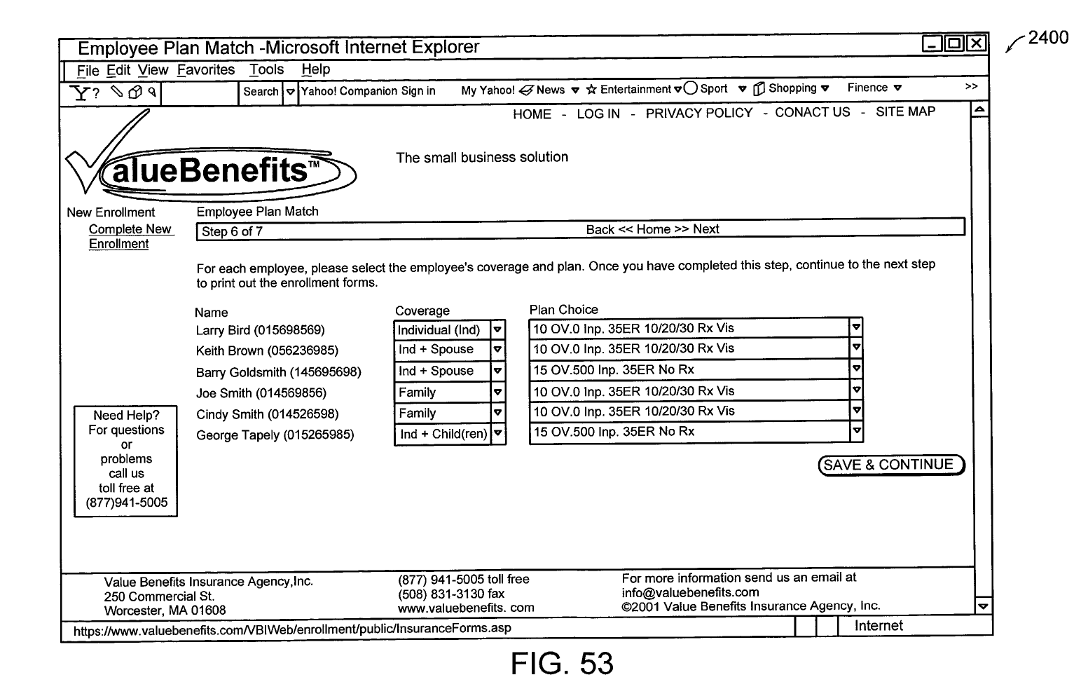

FIG. 53 illustrates a view of a display screen 2400 that a user interfaces with in order to input or map which employee selected which plan at which coverage level. The employee plan chooser screen contains a list of all employees in the company and selection fields for the plan names and coverage levels. After saving this information, the customer can proceed to the next screen. By matching the employee to specific carrier plans, the preferred embodiment of the system can accurately determine which enrollment forms need to be filled in to complete the enrollment process.

The applicable business rules that pertain to employee plan matching include the information being saved to ENR_PolicyHolder, which can require the copying over of other information from the ENR_Employee or CON_Person table, such as DOB, gender and SSN. Further, the plan rate can be looked up for each employee from the CAR_Plan table. This rate is based on the enrollment start date. The step of match employees to plans is marked complete in the ENR_EnrollWizard table.

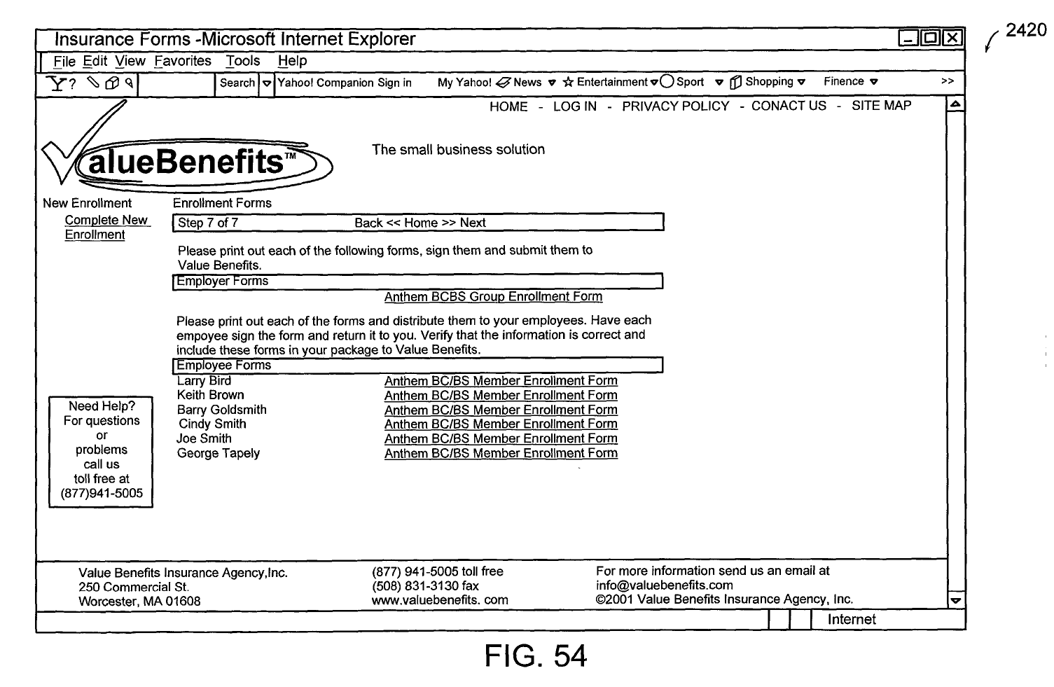

FIG. 54 illustrates a view of a display screen 2420 that a user interfaces with to display a list of the employees with the corresponding forms needed to be filled in to complete the enrollment process. In a preferred embodiment this is the final screen in the enrollment application. The system application automatically matches up which enrollment forms are necessary for the selected plans. After reviewing and printing the forms, the customer completes the enrollment process.

After selecting which carrier the employer chooses, each employee is then mapped to the individual plan offering. The business rules that apply include information being saved to ENR_PolicyHolder, and duplicating other information from the ENR_Employee or CON_Person table, ie., DOB, gender and SSN, and providing a lookup for the plan rate (for each employee) from the CAR_Plan table. This rate is based on the enrollment start date and then marking the step “Match Employees to Plans” complete in the ENR_EnrollWizard table. A forms menu contains carrier specific forms including enrollment forms. The carrier forms are prepopulated with profile information to expedite the enrollment process. The account profile information includes company name, company address, employee names, employee addresses and dependent names and addresses. The employee enrollment forms contain the universal enrollment form for the system. A single form exists for each employee. Each form contains all of the information from the system already “pre-filled.” The group enrollment form contains a copy of the carrier's group enrollment form. This can be a PDF file which is not filled in.

Carrier forms include a carrier contract, benefit summary and summary plan document. The carrier contract contains a PDF of the carrier contract. This section may have information “pre-filled” based on the plans selected by the employer. The benefit summary document contains a PDF of the benefits summaries. This document is supplied by the carrier. The summary plan document contains a PDF of the benefit summaries. This document is also supplied by the carrier.

When displaying a list of employees, the system uses any employee information which exists under the employee profile. However, if no employee information exists, then the add button is used to add a new employee.

The corresponding business rules include all of the fields being required, the coverage types are defined by the market, the employer does not need to enter their actual employee's name, by default, the field contains “employee n”, where “n” represents the employee count, the date of births cannot be future dates, the gender drop down list is filled with two fixed items: male and female, and the coverage type drop down list is filled with four fixed items: individual, individual plus spouse, individual plus children and family. In a preferred embodiment this list is dynamically generated. The add more employees drop down list is fixed with three items.

Each carrier can use one or more of the underwriting guidelines described hereinbefore. When setting up a new carrier, it is imperative that their individual underwriting guidelines be determined and implemented in preferred embodiments of the system.

When the system personnel sign a contract with a carrier to offer a carrier's plan(s) in a particular area, the system collects certain information from the carrier. This information includes the plan name and number, what type of policy category it falls into (Medical, Life, etc.) the effective dates of the plan and links to the plan description and benefit summary description(s). Carrier's are only allowed to offer plans within the states they are licensed to sell insurance in. The system keeps track of which states the carrier is currently licensed. Furthermore, each plan has an associated start and end date which covers when the plan is effective. Each plan has associated with it a set of zip codes in which the plan is offered. Lastly, each plan has one or more rates. These rates may be affected by the Employee's age, coverage type or gender or the Employee's total number of eligible employees.

For example, each health carrier has approximately 5-10 plan schedules for each market. The schedules vary based on co-pay level, deductible, provision of prescription coverage, and out-of-network options. Each plan has a benefit description which is mapped to the Market segment where it is being offered.

TABLE 20

| A typical offering might be three | |
|---|---|
| schedules of benefits as follows: | |
| Plan Price Category | Type of Plan |
| High | HMO (in-network and out-of-network) |
| Medium | HMO without prescription coverage |
| Low | PPO (in-network) |

The contact management services are responsible for maintaining the system's link to the customer. A sales person may establish the first link to the client. In this embodiment, the sales person needs to enter the prospect's name and address. The sales person then records conversations with the client. A well-defined “action” service assists in keeping in contact with the prospect.

In a preferred embodiment a process flow for a typical contact scenario includes:

TABLE 21

| | |
|---|---|
| Initiate | A sales person calls up a new prospect. The call list may |
| Contact | be in the Contact system already with a status of “New Call” |
| | or the sales person could be working off a separate call sheet. |
| Complete | While the sales person is talking with the prospect, |
| Contact | she/he may wish to record notes on the conversation. |
| | The call notes are directly entered into the system. |
| Follow-up | The sales person may wish to schedule a future call with this |
| | prospect. She/he enters an action to “call the |
| | prospect next week.” |

In a preferred embodiment, security features provide for limited access and identifies items individual groups can and cannot access. The security features are provided at the group “role” level rather than individual level. This practice simplifies programming and expandability. Any electronic data shipped by the system or received by the system web site is sent using SSL security (HTTPS). The security system includes page-level security (each application service provider (ASP) page verifies username and password), a SQL Server 7.0 table level security (user groups are assigned table level access), for example, a secured web-access via SSL, a firewall protection to prevent unauthorized users from accessing internal computers, and system user security levels.

It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams. While various elements of the preferred embodiments have been described as being implemented in the software, in other embodiments hardware or firmware implementations may alternatively be used, and vice-versa.

It will be apparent to those of ordinary skill in the art that methods involved in the integrated system and method for insurance products may be embodied in a computer program product that includes a computer usable medium. For example, a computer usable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals.

The claims should not be read as limited to the described order or elements unless stated to that effect. Therefore, all embodiments that come within the scope and spirit of the following claims and equivalents thereto are claimed as the invention.

What is claimed:

1. A system for creating and administering insurance contracts, comprising:
a front-end subsystem in communication with a client;
a database subsystem accessing a plurality of stored databases; and
a back-end subsystem in communication with a plurality of subsystems to source information and monitor the creation, and administration of an insurance contract.

2. The system of claim 1, wherein the front-end subsystem communicates via a network and is further operative with a set of executable instructions to collect contract information from and deliver contract information to a plurality of clients.

3. The system of claim 1, wherein the front-end subsystem comprises at least one of a set of executable instructions for quoting a plurality of terms of the contract, an enrollment process, a billing process and contract maintenance.

4. The system of claim 1, wherein the back-end subsystem is in communication with a network and accesses the plurality of databases.

5. The system of claim 1, wherein the back-end subsystem comprises a system application having a quoting subsystem, an enrollment subsystem, a billing subsystem, and a customer resource management subsystem, and communicates with the front-end subsystem which in turn communicates with the client and an insurance vendor to communicate the creation, execution and management of the insurance contract.

6. The system of claim 1, wherein the back-end subsystem further comprises an underwriting and eligibility subsystem, a reporting subsystem, an archiving subsystem, and an electronic data interchange subsystem.

7. The system of claim 1, wherein the front-end subsystem communicates with an insurance vendor.

8. In a data processing system, a method of implementing insurance contracts between a client and an insurance provider comprising the steps of:
receiving a plurality of inputs for a quoting subsystem from the client;
processing the plurality of inputs and generating a quote in response to the plurality of inputs;
transmitting the quote to the client;
enrolling the client and executing the insurance contract in response to receiving an approval with respect to the quote;
generating invoices that correspond to the insurance contract using a billing subsystem; and
monitoring and managing the quoting subsystem process, a customer service process and the billing subsystem.

9. The method of claim 8, further comprising creating and storing in a database a plurality of contract templates having terms and conditions of the contract.

10. The method of claim 8, further comprising reviewing eligibility and underwriting requirements upon receiving the plurality of inputs from the client.

11. A computer program product for implementing an insurance contract between a client and a provider, the computer program product comprising:
a computer usable medium having computer readable code therein, including program code which:
receives a plurality of inputs from the client;
processes the plurality of inputs;
generates a quote for the insurance contract for the client;
enrolls the client and executes the insurance contract;
generates corresponding invoices; and
tracks and manages the plurality of inputs.

12. The computer program product of claim 11, further comprising a set of executable instructions which creates a contract form containing terms and conditions of the contract.

13. The computer program product of claim 11, further comprising a set of executable instructions to track commission and premium payments.

14. In a computer network formed of a communication channel and a plurality of digital data processors coupled to the communication channel for communication thereon and a computer apparatus for implementing insurance contracts between a client and an insurance vendor, comprising:
a front-end data processor to communicate with the client and the insurance vendor, the client and the insurance vendor communicating through a digital data processor;
a database data processor to access a plurality of stored databases; and
a back-end data processor connected to a plurality of subsystems on a plurality of digital data processors to create a rate comparison quote, enroll the client, generate invoices and track client interactions.

15. The computer apparatus of claim 14, wherein the front-end data processor communicates via a network and is further operative with a set of executable instructions to collect contract information from the client and the insurance vendor to subsequently deliver contract information to parties.

16. The computer apparatus of claim 14, wherein the front-end data processor further comprises a set of executable instructions for collecting a plurality of client inputs, providing form maintenance, vendor negotiations and contract maintenance.

17. The computer apparatus of claim 14, wherein the back-end data processor is connected to a network and accesses the databases.

18. The computer apparatus of claim 14, wherein the back-end processor comprises a quoting subsystem, an enrollment subsystem, a billing subsystem and a contact resource management subsystem.

19. An apparatus for implementing an insurance contract between a client and an insurance provider, the insurance contract having a plurality of parameters, comprising:
at least one data processor having a plurality of tables, each table having a record structure, the record structure including keys in a plurality of fields that are used to access stored data common to a quoting, enrollment, billing and tracking subsystem; and
at least one data processor to execute a provision of the contract in response to an acceptance by the client.

20. The apparatus of claim 19, further comprising a data processor to create and store a plurality of contract templates having terms and conditions for a plurality of insurance contracts.

21. In a data processing system, a method of implementing an insurance contract between a client and an insurance carrier comprising:
creating a new contract form which includes at least one provision of the insurance contract;
delivering the contract template to the client;
the client selecting the provisions of the contract and providing the preferences;
processing the preferences against eligibility and underwriting requirements;
enrolling the client in response to the processing of preferences;
generating invoices that correspond to the insurance contract; and
monitoring any client contact and information communicated during the creating and implementing of the insurance contract.

22. The method of claim 21, wherein creating a new contract form comprises copying existing contract forms to create a new contract form.

23. The method of claim 21, wherein creating a new contract form comprises reading in a contract form created in an external environment.

24. The method of claim 23, wherein selecting the provisions of the contract comprises creating fields which indicate the selection of a particular insurance product.

25. The method of claim 21, wherein selecting the provisions of the contract comprises copying existing preference fields from existing contract templates.

26. The method of claim 21, wherein selecting the provisions of the contract comprises reading in preference fields created in an external environment.

27. The method of claim 26, wherein the external environment comprises a vendor website, a third party website, a vendor database and a third party database.

28. The method of claim 21, further comprising creating a plurality of versions of the same contract template with differing selections.

29. The method of claim 21, wherein said contract template is in the form of a computer database record structure, wherein each field of the record structure denotes one of an input data term of the contract and a key that points to the data term.

30. The method of claim 21, further comprising tracking premium and commission payments.

31. A computer-readable data transmission medium between a plurality of computers having a data structure comprising:
a first subset of data for processing at a first computer, the first subset of data including terms and conditions for a contract; and
a second subset of data for processing at a second computer, the second subset of data including a template having the terms and conditions of the contract, the terms and conditions being modifiable at the second computer to accommodate a user preference.

32. A computer-readable data transmission medium between a plurality of computers having a data structure comprising:
a first subset of data for processing at a first computer, the first subset of data including information regarding monitoring and detection of a contract; and
a second subset of data for processing at a second computer, the second subset of data including notification information.
